(19) United States
(12) Patent Application Publication
(10) Pub. No.: US 2026/0307051 A1
(43) Pub. Date: Oct. 8, 2026

(54) Synthesis of bio-based catecholic acid- and derivatives-functionalized adsorbents for recovery of metals and metalloids from acidic solutions

(71) Applicant: The Penn State Research Foundation, University Park, PA (US)

(72) Inventors: Pushap Raj, University Park, PA (US); Athanasios K. Karamalidis, University Park, PA (US)

(73) Assignee: The Penn State Research Foundation, University Park, PA (US)

(21) Appl. No.: 19/481,983

(22) PCT Filed: May 8, 2024
(86) PCT No.: PCT/US2024/028324

§ 371 Date: Nov. 6, 2025

Related U.S. Application Data
(60) Provisional application No. 63/501,006, filed on May 9, 2023.

(51) Int. Cl. B01J 20/32; C22B 3/24; C22B 58/00

(52) U.S. Cl. CPC B01J 20/3253; B01J 20/3208; C22B 3/24; C22B 58/00

(57) ABSTRACT

Disclosed is an adsorbent including a support and a catecholic ligand derivative. The support can be a gel, a polymeric resin, a cellulose, and/or a carbon-based material. The catecholic ligand derivative can be one of a catecholic ligand. The catecholic ligand can be 3,4 dihydroxybenzoic acid, 3,4,5-trihydroxybenzoic acid, and/or 3,4-dihydroxyhydrocinnamic acid. The catecholic ligand derivative can include a carbonyl group for covalent bonding with the support, and an O-dihydroxyl group to provide an active adsorption site.

### CROSS-REFERENCE TO RELATED APPLICATIONS

This patent application is related to and claims the benefit of priority to U.S. provisional patent application No. 63/501,006, filed on May 9, 2023, the entire contents of which is incorporated herein by reference.

### FIELD OF THE INVENTION

Embodiments relate to compositions and methods for an adsorbent that include use of a support matrix and a catecholic ligand derivative.

### BACKGROUND OF THE INVENTION

Gallium (Ga) is considered a critical element, due to its role in key emerging technologies, especially those in green energy industries. Gallium minerals, such as GaN, GaAs, and GaP are important to semiconductors, which are also used in other technologies such as light-emitting diodes, thin film solar materials, DVDs, laser diodes in compact discs, and other electronics. The expected demand for Ga is predicted to increase 224% by 2050 compared to 2010 due to its excellent semiconducting properties and use in emerging and clean energy technologies. Although no primary Ga ores exist, the metal can be extracted as a byproduct of other processed minerals, ores, tailings, and co-products, such as zinc, fly ash, bauxite, and others. The selective extraction of gallium from zinc refineries, fly ash, red mud, bauxite, and recycling of waste semiconductors appears to be an attractive and viable approach to meet global demand.

Although metal recycling is advantageous in many ways, including increase of energy efficiency, reduction of extraction cost, and environmental impact of waste materials. Various recycling methods have been proposed for the separation of gallium from Ga-bearing waste materials, including fractional precipitation, electrochemical deposition, solvent extraction, and ion-exchange; however, very few of them have found industrial applications. Parallel to recycling efforts, the industrial recovery of Ga was attempted but with its own challenges. Chemical precipitation was first used in an industrial scale to separate Ga, but the purity of the metal produced was very poor. Solvent extraction has been widely used for the recovery of gallium, but it suffers from extensive use of organic solvents (some of which are carcinogens and flammable) and usually, the extractants (e.g., organic phosphates, 8-hydroxyquinoline and carboxylic acid) are washed with organic solvents (e.g., benzene, sulfonated kerosene) which create additional environmental problems.

Adsorption has been considered as one of the simple, economical, highly efficient, and sustainable approach for the recovery of Ga. Various adsorbent materials such as amidoxime resins, bentonite, carbon nanotubes, polyurethane foams, activated carbon, and metal organic frameworks have been used for the separation of Ga. Most of these adsorbents, however, have high cost, low selectivity, complex synthetic routes, and low stability in acidic solutions, which restricts their applicability to the separation of the metal in various media. Therefore, development of sustainable, low-cost, and highly efficient adsorbents for the recovery of Ga metals is necessary.

Cellulose has been an attractive material as an adsorbent owing to its high availability, low cost, eco-friendliness, and easiness of chemical modifications. The adsorption capacity of pure cellulose is extremely low, although chemical modification with certain functional groups (e.g., OH, COOH, CONH₂, NH₂) increases the adsorption capacity for metal ions. Additionally, the modification of cellulose can also improve the thermal stability, mechanical strength and provide a substantial number of functional groups for metal adsorption. Catechol, a well-known ligand, contains two adjacent hydroxyl functional groups available for chelation of the transition metal ions. Catechol has the ability to form monodentate, bidentate, and multidentate metal complexes, making its functionalized adsorbent derivatives useful for separating various metals ions (e.g., Fe (III), Ge, (IV), and U (VI)). For example, catecholamine functionalized cellulose nanofibrils (CNF) were developed for removal of arsenic and chromium in different water matrices at pH 3.34. Wang et al. have utilized catechol-based silica gel for germanium extraction in aqueous medium at pH 4.5. Recently, Zhao et al. have synthesized tannic acid based microcrystalline cellulose for the extraction of gallium and indium at pH 3 and Xiong et al. extensive work on hydroxyl-based functionalized adsorbents for the extraction and recovery of gallium in acidic medium showed high adsorption capacity. However, from synthetic cost perspective, there is still a need for the development of low-cost, sustainable adsorbent materials, which could effectively and selectively recover gallium from a complex system.

In addition, Bayer liquid, produced from aluminum refineries, is the most common resource of Ga. Various extraction methods such as solvent extraction, electrochemical deposition, fractional precipitation, and ion exchange have been developed for Ga extraction from Bayer liquids. However, most of these technologies suffer from drawbacks, which ended up constraining their application. For example, the electrochemical deposition method for Ga extraction was banned in most countries because of the high toxicity of mercury electrodes used. Solvent extraction has been widely used for the recovery of Ga from Bayer liquid with its limitations, and several efforts carried out to improve its performance. For example, duolite ES-346/345 (amidoxime moiety) and kelex-100 extract (8-hydroxyquinoline; 8-HQ) have been utilized for the industrial separation of gallium from Bayer liquid. However, the amidoxime moiety degrades in an acidic medium, and the metal adsorption capacity decreases in each regeneration step of the process. While, in 8-hydroxyquinoline impregnating resin, the extracts are lost due to weak interactions (physical interaction) between 8-HQ with the resin surface and its high synthetic cost also limits its industrial use. Past efforts showed that one of the potential challenges for gallium production is the synthesis of low-cost reusable adsorbents, which are selective and efficient for its recovery and highly stable in acidic stripping. Solid-phase extraction (SPE)-based technologies present an appealing opportunity for the development of more suitable separation technologies for Ga, due to high extraction metal yield, selectivity, and avoidance of use of organic solvents. Additionally, SPE, compared to its counterpart technologies, can be simple-step separation process, less energy-consuming, and a more sustainable approach. Ion exchange resins, for example, have been widely used for recycling of critical metals from secondary resources. These materials are made up of two components, e.g., a chelating group and a polymer matrix. The chelating group binds the target metal ions and the polymer matrix provides structural and chemical stability. The combination of these two components provides unique advantages for these materials to act as adsorbents, e.g., significant selectivity for target metal ions, wide range of structural and physiochemical features, high adsorption capacity and adsorption rate, and reusability. Wang et al. used amidoxime-guanidine containing chelating resins for recovery of silver ions in the aqueous medium. Kataoka et al. were the first who reported that chelating resins that hold═N—OH groups along with active groups such as ═NH, NH₂, SH, and OH have a high affinity for Ga extraction. However, these resins have some drawbacks, such as slow kinetics rate, and interferences from vanadium on Ga extraction which hinders their industrial application. Thus, there is still a need for the development of new adsorbent materials which could effectively and selectively recover gallium from a complex system.

### SUMMARY OF THE INVENTION

An exemplary embodiment can relate to an adsorbent. The adsorbent can include a support comprising a gel, a polymeric resin, a cellulose, and/or a carbon-based material. The adsorbent can include a catecholic ligand derivative of a catecholic ligand. The catecholic ligand can comprise 3,4 dihydroxybenzoic acid, 3,4,5-trihydroxybenzoic acid, and/or 3,4-dihydroxyhydrocinnamic acid. The catecholic ligand derivative can include a carbonyl group for covalent bonding with the support, and an O-dihydroxyl group to provide an active adsorption site.

In some embodiments, the support can form a matrix for the catecholic ligand derivative.

In some embodiments, the O-dihydroxyl group can facilitate metal complexation.

In some embodiments, the adsorbent can include plural supports comprising a first support and a second support. The first support can be the same as or different from the second support.

In some embodiments, the adsorbent can include plural catecholic ligand derivatives comprising a first catecholic ligand derivative and a second catecholic ligand derivative. The first catecholic ligand derivative can be the same as or different from the second catecholic ligand derivative.

In some embodiments, the adsorbent can include plural carbonyl groups comprising a first carbonyl group and a second carbonyl group. The first carbonyl group can be the same as or different from the second carbonyl group.

In some embodiments, the adsorbent can include plural O-dihydroxyl groups comprising a first O-dihydroxyl group and a second O-dihydroxyl group. The first O-dihydroxyl group can be the same as or different from the second O-dihydroxyl group.

In some embodiments, the support can be a cellulose. The catecholic ligand can comprise 3,4 dihydroxybenzoic acid, 3,4,5-trihydroxybenzoic acid, and/or 3,4-dihydroxyhydrocinnamic acid.

In some embodiments, the support can be a polymeric resin. The catecholic ligand can comprise 3,4 dihydroxybenzoic acid and/or 3,4,5-trihydroxybenzoic acid.

In some embodiments, the polymeric resin can comprise A110 resin bead or A143 resin bead.

An exemplary embodiment can relate to a method of synthesizing an adsorbent. The method can involve dissolving an acid in thionyl chloride to form a catecholic ligand derivative. The acid can comprise 3,4 dihydroxybenzoic acid, 3,4,5-trihydroxybenzoic acid, and/or 3,4-dihydroxyhydrocinnamic acid. The method can involve grafting the catecholic ligand derivative onto a support. The support can comprise a gel, a polymeric resin, a cellulose, and/or a carbon-based material.

In some embodiments, the support can be a cellulose, and the grafting occurs via an esterification reaction.

In some embodiments, the support can be a polymeric resin, and the grafting occurs via an amide formation reaction.

In some embodiments, the grafting can functionalize the support by a carbonyl group covalently bonding the catecholic ligand derivative to the support.

In some embodiments, the catecholic ligand derivative can include an O-dihydroxyl group to provide an active adsorption site.

In some embodiments, the O-dihydroxyl group can facilitate metal complexation.

An exemplary embodiment can relate to a method of extracting a metal from a solution. The method can involve introducing or exposing an adsorbent to a solution. The solution can comprise a metal. The adsorbent can comprise a support comprising a gel, a polymeric resin, a cellulose, and/or a carbon-based material. The adsorbent can comprise a catecholic ligand derivative of a catecholic ligand, the catecholic ligand comprising 3,4 dihydroxybenzoic acid, 3,4,5-trihydroxybenzoic acid, and/or 3,4-dihydroxyhydrocinnamic acid. The catecholic ligand derivative can include a carbonyl group for covalent bonding with the support, and an O-dihydroxyl group to provide an active adsorption site.

In some embodiments, the method can involve allowing the metal to adsorb to the adsorbent via metal complexation.

In some embodiments, the method can involve adjusting pH of the solution to influence adsorption capacity of the adsorbent.

In some embodiments, the metal is gallium.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1A shows exemplary method steps for synthesizing an adsorbent.

FIG. 1B shows exemplary method steps for extracting metal from a solution.

FIG. 1C is an illustration of an exemplary method for extracting metal from a solution.

FIG. 2 shows an exemplary synthesis scheme for grafting of catechol derivative on cellulose surface: Step 1: conversion of acid to acyl chloride (crude product I); Step 2: esterification reaction.

FIG. 3 shows exemplary catechol derivatives functionalized cellulose adsorbents: P1) 3,4 dihydroxybenzoic acid; P2) 3,4,5-trihydroxybenzoic acid; P3) 3,4 dihydroxyhydrocinnamic acid.

FIGS. 4A and 4B show FT-IR spectra of cellulose, catecholic acid, and adsorbents: FIG. 4A) P1 functionalized with 3,4 dihydroxybenzoic acid; and FIG. 4B P3 functionalized with 3,4 dihydroxyhydrocinnamic acid.

FIG. 5 shows zeta potential of adsorbent P1 as a function of pH.

FIG. 6 shows SEM images (3 kV, 50 pA) of microcrystalline cellulose and catecholic functionalized adsorbents of different particle sizes at low and high magnification power: Image A and image B) microcrystalline cellulose at (A) 50 mm, 1,500× and (B) 5 mm, 20,000×; image C and image D) 3,4 dihydroxybenzoic acid functionalized microcrystalline cellulose P1 at (C) 20 mm, 5,000× and (D) 3 mm, 35,000×; image E and image F) 3,4,5-trihydroxybenzoic acid functionalized microcrystalline cellulose P2 at (E) 50 mm, 2,500× and (F) 10 mm 10,000×; image G and image H) 3,4-dihydroxyhydrocinnamic acid functionalized microcrystalline cellulose P3 (G) 50 mm, 2,000× and (H) 1 mm 79,976×. EDS pattern of: image I) microcrystalline cellulose; image J) Adsorbent P1; image K) Adsorbent P2; image L) Adsorbent P3.

FIG. 7 shows effect of equilibrium pH on the adsorption of Ga for adsorbents P1 and P3 (experimental conditions: 10 mg adsorbent, 10 mL acidic solution, concentration of Ga (III): 100 mg L⁻¹, contact time: 24 hrs).

FIG. 8A shows adsorption isotherm of adsorbent P1 (experimental conditions: 10 mg adsorbent, 10 mL acidic solution, concentration of Ga: 5-100 mg L−1, contact time: 24 hrs).

FIG. 8B shows adsorption isotherm of adsorbent P3 (experimental conditions: 10 mg adsorbent, 10 mL acidic solution, concentration of Ga: 5-100 mg L−1, contact time: 24 hrs).

FIGS. 9A, 9B, 9C, and 9D show effects of time on adsorption of gallium at pH 3: FIG. 9A Pseudo-first order and Pseudo-second order model kinetics of P1; FIG. 9B Pseudo-first order and Pseudo-second order model kinetics of P3; FIG. C Weber-Morris plots for intraparticle diffusion model of P1; FIG. D Weber-Morris plots for intraparticle diffusion model of P3.

FIGS. 10A and 10B show percent (%) efficiency of Ga adsorption and desorption over 4 cycles using: FIG. 10A P1, (experimental condition; mass of adsorbent; 10 mg, volume of solution: 10 mL, contact time: 24 hrs); and FIG. 10B P3 (experimental condition; mass of adsorbent; 10 mg, volume of solution: 10 mL, contact time: 24 hrs).

FIG. 11 shows distribution coefficients (K_{d} mL g⁻¹ adsorbent) of Ga adsorption on P1 and P3 in presence of competitive ions at pH 3, (10 mg adsorbent in 10 mL mixed solution of 20 mg L⁻¹ per competing ion for 24 hrs contact time).

FIG. 12: Images (A-E) SEM images (3 kV, 50 pA) of surface complexation of Ga with different particle size adsorbent P1 at low and high magnification power; Image A) 20 mm at 5000×, Image B) 5 mm at 15000×. Images (C-D): SEM images (3 kV, 50 pA) of surface complexation of Ga with different particle size adsorbent P3 at low and high magnification power; Image C) 10 mm at 9991×; Image D); 2 mm at 50,000×. SEM-EDS images of: Image E) surface complexation of Ga with 3,4-dihydroxybenzoic acid functionalized cellulose P1; Image F) surface complexation of Ga with 3,4-dihydroxyhydrocinnamic acid functionalized cellulose P3.

FIG. 13 shows an exemplary functionalization scheme for grafting the catechol ligand on Purolite A110 resin surface: Step 1: conversion of 3,4 dihydroxybenzoic acid to 3,4 dihydroxy benzoyl ethyl ester (product I); Step 2: Amide formation.

FIG. 14 shows catechol grafted A110 polymeric resin beads: J1) 3,4 dihydroxybenzoic acid; J2) 3,4,5-trihydroxybenzoic acid. Catechol grafted A143 Plus polymeric resin beads: J3) 3,4 dihydroxybenzoic acid; J4) 3,4,5-trihydroxybenzoic acid. Photographic images of non-functionalized resin beads and functionalized resin beads J1-J4.

FIGS. 15A and 15B show FT-IR spectra of A110 resin, and adsorbents: FIG. 15A J1 functionalized with 3,4 dihydroxybenzoic acid; and FIG. 15B J2 functionalized with 3,4,5-trihydroxybenzoic acid.

FIG. 16 shows SEM images (low vacuum mode) of resin beads and catechol functionalized adsorbents at low and high magnification power: Images A-B) Purolite A110 resin bead at 100× (A) and 10000× (B). Images C-D) 3,4 dihydroxybenzoic acid functionalized adsorbents J1 at 100× (C) and 10000× (D). Images E-F) 3,4,5-trihydroxybenzoic acid functionalized adsorbents J2 at 100× (E) and 10000× (F). Images G-H) Purolite A143 Plus resin bead at 100× (G) and 10000× (H). Images I-J) 3,4 dihydroxybenzoic acid functionalized adsorbents J3 at 100× (C) and 10000× (D). Images K-L) 3,4,5-trihydroxybenzoic acid functionalized adsorbents J4 at 100× (K) and 10000× (L).

FIG. 17 shows the effect of equilibrium pH on the adsorption of Ga on adsorbents (10 mg adsorbent/10 mL acidic solution; 60 mg Ga L⁻¹, contact time: 24 hrs).

FIGS. 18A, 18B, 18C, 18D show adsorption isotherms of adsorbent: FIG. 18A) J1; FIG. 18B) J2; FIG. 18C) J3; and FIG. 18D) J4. All experiments were conducted 10 mg adsorbent in 10 mL acidic solution, with the concentration of Ga between 5-60 mg L⁻¹, and contact time of 24 hrs.

FIGS. 19A, 19B, 19C, 19D show the effect of time on adsorption of gallium at pH 3: FIG. 19A Pseudo-first order and Pseudo-second order model kinetics of J1; FIG. 19B Pseudo-first order and Pseudo-second order model kinetics of J2; FIG. 19C Pseudo-first order and Pseudo-second order model kinetics of J3; FIG. 19D Pseudo-first order and Pseudo-second order model kinetics of J4.

FIGS. 20A, 20B, 20C, 20D show percent (%) efficiency of Ga adsorption and desorption over 4 cycles using: FIG. 20A J1, (experimental conditions: solid/liquid (S/L) 10 mg/10 mL, contact time: 24 hrs); FIG. 20B J2 (10 mg/10 mL (S/L), contact for 24 hrs); FIG. 20C J3, (10 mg/10 mL (S/L), contact for 24 hrs); and FIG. 20D J4 (10 mg/10 mL (S/L), contact for 24 hrs).

FIGS. 21A, 21B, 21C, 21D show distribution coefficients (K_{d} mL g⁻¹ adsorbent) of Ga adsorption in presence of competitive ions at pH 3: FIG. 21A J1, (experimental condition: 10 mg adsorbent in 10 mL mixed solution of 20 mg L⁻¹ per competing ion for 24 hrs contact time); FIG. 21B J2, (10 mg adsorbent 10 mL mixed solution of 20 mg L⁻¹ per competing ion for 24 hrs contact time); FIG. 21C J3, (10 mg adsorbent in 10 mL mixed solution of 20 mg L⁻¹ per competing ion for 24 hrs contact time); FIG. 21D J4, (10 mg adsorbent in 10 mL mixed solution of 20 mg L⁻¹ per competing ion for 24 hrs contact time).

FIGS. 22A, 22B show XPS spectra of adsorbents FIG. 22A J1 and FIG. 22B J2, before and after Ga-adsorption (full survey).

FIG. 23 shows a binding mechanism of Ga with catechol functionalized adsorbent.

FIG. 24 shows Fourier Transform Infrared (FT-IR) spectra of Cellulose and adsorbent P2.

FIG. 25 shows Zeta potential of adsorbent P2 at pH 2; Zeta potential of adsorbent P2 at pH 3; Zeta potential of adsorbent P3 at pH 2.

FIG. 26 shows X-ray photoelectron spectroscopy (XPS) spectra of cellulose.

FIG. 27 shows X-ray photoelectron spectroscopy (XPS) spectra of adsorbents P1, P2, and P3.

FIG. 28 shows Elovich kinetics model calculations of adsorbents P1 and P3 for gallium ion.

FIG. 29 (images A, B, C, D, E, F) shows selectivity factors of Ga using adsorbent P1 in binary element solutions at pH 3: (A) Ga:Zn binary solution (1:10, 1:50, 1:100); (B) Ga:Ge binary solution (1:10, 1:50, 1:100); (C) Ga:As binary solution (1:10, 1:50, 1:100). Selectivity factor of Ga using adsorbent P3 in binary element solution at pH 3: (A) Ga:Zn binary solution (1:10, 1:50, 1:100); (B) Ga:Ge binary solution (1:10, 1:50, 1:100); (C) Ga:As binary solution (1:10, 1:50, 1:100). Concentration used for 1:10 binary solution was Ga=20 mgL⁻¹ and Mⁿ⁺ (e.g., Zn, Ge, As)=200 mgL⁻¹; 1:50 binary solution was Ga=5 mgL⁻¹ and Mⁿ⁺ (e.g., Zn, Ge, As)=250 mgL⁻¹; and 1:100 binary solution was Ga=5 mgL⁻¹ and Mⁿ⁺ (e.g., Zn, Ge, As)=500 mgL⁻¹.

FIG. 30 shows Fourier Transform-Infrared (FT-IR) spectra of adsorbent P1 without and with complexed Ga.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of various aspects of the present invention. The scope of the present invention is not limited by this description.

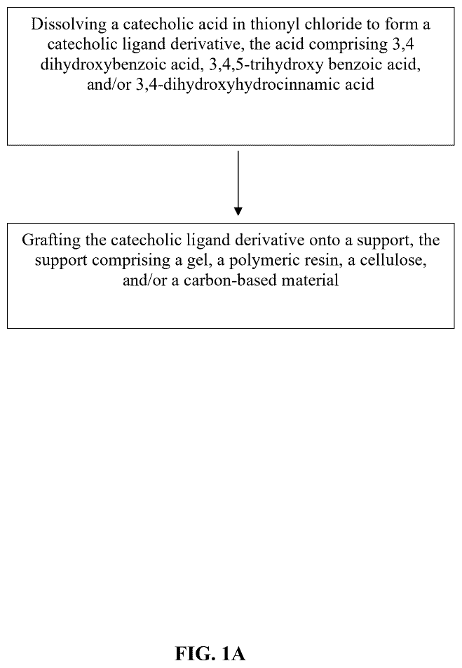

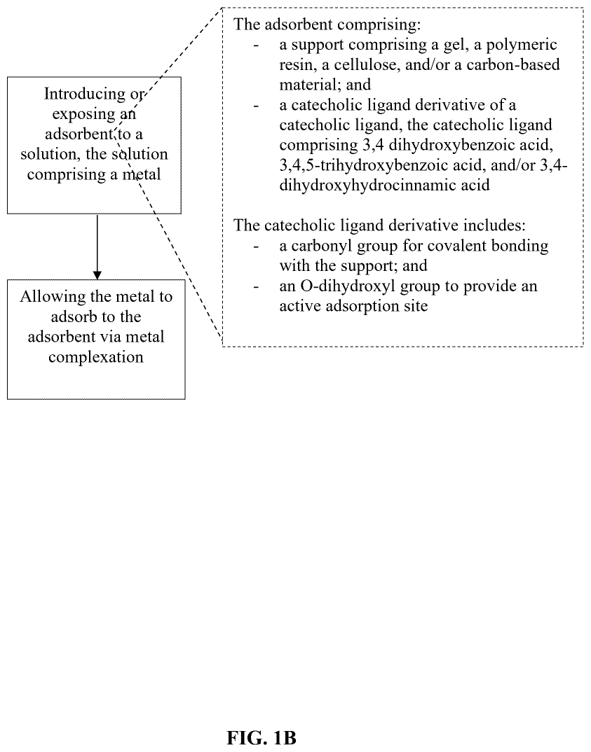

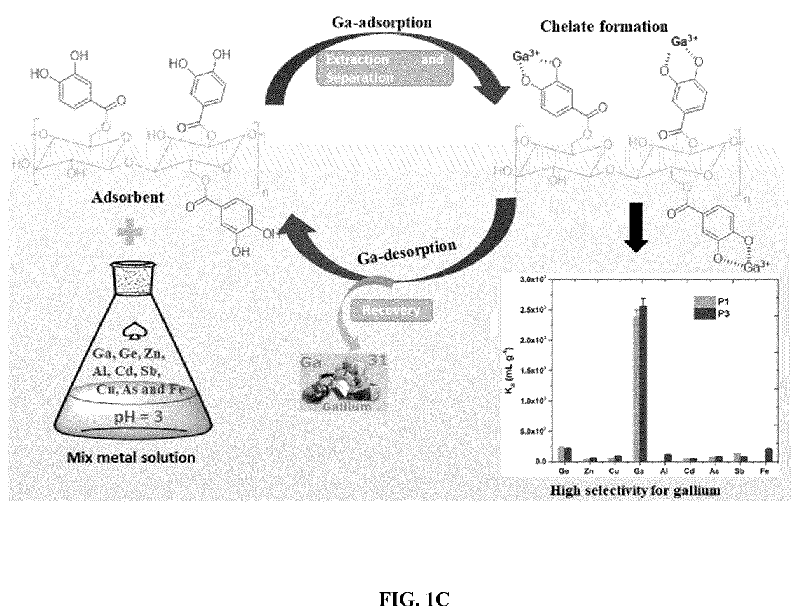

Referring to FIGS. 1A, 1B, and 1C an exemplary embodiment can relate to an adsorbent. The adsorbent can include a support. The support can be a solid support configured to form a matrix to which a ligand can attach. For instance, the support can be a gel (e.g., N isopropylacrylamide (PNIPAM microgel), oligo (ethylene glycol methacrylamide), (POEGMA microgel), etc.), a polymeric resin (e.g., polystyrene crosslinked divinylbenzene, epoxy, polypropylene, polyvinyl chloride, etc.), a cellulose (cellulose I, cellulose II, cellulose II, cellulose IV, etc.), a Silica (e.g., Amino propyl-functionalized silica gel) and/or a carbon-based material (e.g., amorphous carbon, graphite, etc.).

The adsorbent can include a ligand. The ligand can be an organic compound. The ligand can be catecholic ligand, for example. In an exemplary embodiment, the adsorbent can include a catecholic ligand derivative of a catecholic ligand. Preparation of the derivative will be explained later. The catecholic ligand can be 3,4 dihydroxybenzoic acid, 3,4,5-trihydroxybenzoic acid, 3,4-dihydroxyhydrocinnamic acid, etc.

As will be explained herein, the innovative method of preparation can form an adsorbent having a support with a catecholic ligand derivative attached thereto, wherein the catecholic ligand derivative has a carbonyl group for covalent bonding with the support and an O-dihydroxyl group to provide an active adsorption site. The covalent bonding with the support can provide chemical stability for the adsorbent when placed in an acidic media. Presence of multiple O-dihydroxyl groups on the adsorbent surface provides active adsorption sites for binding of trivalent or high valance metal ions through chelation. These sites also have poor affinity for monovalent metal ions, especially those with larger ionic radius. This facilitates excellent selectivity. It is contemplated for the adsorbent to be introduced or exposed to a solution that is or contains an acidic media—e.g., it can be placed in a bath of the solution. The solution will also contain a target metal (e.g., gallium) or target metal ions, the extraction therefrom is desired. Due to the active adsorption sites, Ga can adsorb onto a surface of the adsorbent. This can be via chelation between hydroxyl groups of catechol and target metal ions. The adsorption process can involve of intraparticle diffusion and/or chemosorption, wherein the O-dihydroxyl group can facilitate metal complexation for the target metal ions.

There can be one or more adsorbents used in the extraction process. Any one or combination of adsorbents can be the same or different (e.g., same or different in structure, in chemistry, etc.). Amounts or concentrations of one adsorbent can be the same or different from the amount or concentration of another adsorbent. Any one or combination of adsorbents can be homogenous or heterogenous in structure.

An adsorbent can have one or more supports. For instance, an adsorbent can include plural supports comprising a first support and a second support. The first support can be the same as or different from the second support. For example, an adsorbent can have a first support that is a gel and a second support that is a cellulose. As another example, an adsorbent can have a first support that is a first type of cellulose and a second support that is a second type of cellulose.

An adsorbent can have one or more catecholic ligand derivatives. For instance, an adsorbent can include plural catecholic ligand derivatives comprising a first catecholic ligand derivative and a second catecholic ligand derivative. The first catecholic ligand derivative can be the same as or different from the second catecholic ligand derivative. For example, an adsorbent can have a first catecholic ligand derivative that is a derivative of 3,4 dihydroxybenzoic acid and a second catecholic ligand derivative that is a derivative of 3,4,5-trihydroxybenzoic acid. As another example, an adsorbent can have a first catecholic ligand derivative that is a first type of derivative of 3,4,5-trihydroxybenzoic acid and a second catecholic ligand derivative that is a second type of derivative of 3,4,5-trihydroxybenzoic acid.

An adsorbent or a catecholic ligand derivative of an adsorbent can have one or more carbonyl groups. For instance, an adsorbent or a catecholic ligand derivative of an adsorbent can include plural carbonyl groups comprising a first carbonyl group and a second carbonyl group. The first carbonyl group can be the same as or different from the second carbonyl group—e.g., the same or different in chemistry, structure, type, number of groups, etc.

An adsorbent or a catecholic ligand derivative of an adsorbent can have one or more O-dihydroxyl groups. For instance, an adsorbent or a catecholic ligand derivative of an adsorbent can include plural O-dihydroxyl groups comprising a first O-dihydroxyl group and a second O-dihydroxyl group. The first O-dihydroxyl group can be the same as or different from the second O-dihydroxyl group—e.g., the same or different in chemistry, structure, type, number of groups, etc.

In an exemplary embodiment, the support is a cellulose. The catecholic ligand is 3,4 dihydroxybenzoic acid, 3,4,5-trihydroxybenzoic acid, and/or 3,4-dihydroxyhydrocinnamic acid. This can be achieved by dissolving an acid (e.g., 3,4 dihydroxybenzoic acid, 3,4,5-trihydroxybenzoic acid, and/or 3,4-dihydroxyhydrocinnamic acid) in thionyl chloride to form a catecholic ligand derivative. The catecholic ligand derivative can then be grafted onto the cellulose support. The grafting can be achieved via an esterification reaction. The grafting can functionalize the cellulose support by one or more carbonyl groups covalently bonding the catecholic ligand derivative to the support.

An exemplary process for synthesizing an adsorbent using a cellulose support can involve:
Dissolving a cellulose in dimethyl formamide (DMF) to form a solution.
Adding triethylamine to the solution.
Adding 3,4 dihydroxybenzoic acid, 3,4,5-trihydroxybenzoic acid, and/or 3,4-dihydroxyhydrocinnamic acid to the solution.
Adding the solution to thionyl chloride to dissolve the 3,4 dihydroxybenzoic acid, 3,4,5-trihydroxybenzoic acid, and/or 3,4-dihydroxyhydrocinnamic acid, which is then refluxed, and distillation is used to remove excess thionyl chloride. This forms the derivative(s) of ligands.
The ligand derivative(s) are then washed with DI water to dissolve impurities, which are then filtered.

In another exemplary embodiment, the support is a polymeric resin (e.g., A110 resin bead or A143 resin bead). The catecholic ligand is 3,4 dihydroxybenzoic acid and/or 3,4,5-trihydroxybenzoic acid. This can be achieved by dissolving an acid (e.g., 3,4 dihydroxybenzoic acid and/or 3,4,5-trihydroxybenzoic acid) in thionyl chloride to form a catecholic ligand derivative. The catecholic ligand derivative can then be grafted onto the polymeric resin support. The grafting can be achieved via an amide formation reaction. The grafting can functionalize the polymeric resin support by one or more carbonyl groups covalently bonding the catecholic ligand derivative to the support.

An exemplary process for synthesizing an adsorbent using a polymeric resin support can involve:
Dehydrating a resin bead(s) (A110 bead or A143 bead).
Mixing the resin bead(s) with methanol in presence of triethylamine.
Adding 3,4 dihydroxybenzoic acid and/or 3,4,5-trihydroxybenzoic acid to the mixture.
Adding the mixture to thionyl chloride to dissolve the 3,4-dihydroxybenzoic acid and/or 3,4,5-trihydroxybenzoic acid, which is then refluxed, and distillation is used to remove excess thionyl chloride. This forms the derivative(s) of ligands.
The ligand derivative(s) are then washed with DI water to dissolve impurities, which are then filtered.

As noted herein, the absorbent (the functionalized support with catecholic ligand derivatives) can be used to extract metal or metal ions from a solution. The solution can be an acidic solution (e.g., an aqueous solution with a pH (1-4) maintained by adding 0.1 M HCl). This, embodiments can relate to methods of extracting a metal or metal ion from a solution. The method can involve introducing or exposing an embodiment of the adsorbent to the solution, followed by allowing the metal or metal ion to adsorb to the adsorbent via metal complexation. The pH of the solution can influence adsorption capacity of the adsorbent. Thus, the method can involve adjusting pH of the solution to influence adsorption capacity of the adsorbent. For an adsorbent having a cellulose support, the pH can be adjusted between 1≤pH≥5 pH. A pH from 1 to 3 may be preferred, as adsorption capacity is shown to increase from pH 1 to 3 due to decrease in competition between H′ and the metal ions for same adsorption sites with the increase of pH in this range. For an adsorbent having a polymeric resin support, the pH can be adjusted between 1≤pH≥4 pH. A pH from 3 to 4 may be preferred, as adsorption capacity is shown to be maximized within the pH 3-4 range due to decrease in competition between H⁺ and the metal ions for same adsorption sites.

After adsorption, the target metal or metal ion can be extracted via desorption. Desorption can be achieved by introduction the adsorbent (with the metal ions adsorbed thereto) to a mineral acids such as HNO₃, H₂SO₄, HCl, etc.

### EXAMPLES

The following discussion includes exemplars of making and using embodiments of the composition and methods disclosed herein. The examples include exemplary compositions, formulations, and test results.

### Example 1

Herein, we developed new catechol-derivative functionalized cellulose-based adsorbents for the selective separation of gallium in acidic solutions. Catechol and its derivative ligands consist of O-dihydroxyl groups for surface metal complexation and carbonyl groups for covalent bonding with cellulose supporting materials. The prepared adsorbents have many advantages, such as low-cost, eco-friendliness, mature synthetic route, abundant raw materials reserves, and good biocompatibility. Additionally, the presence of multiple O-dihydroxyl groups on the adsorbent surface provides active adsorption sites for binding of trivalent or high valance metal ions through chelation, and have poor affinity for monovalent metal ions, especially those with larger ionic radius, providing excellent selectivity. The unique combination of catechol derivatives with cellulose matrix offers chemical stability to the adsorbents in acidic media. From metals economy perspective, the designing of low-cost and eco-friendly adsorbents for the extraction and separation of critical metals is beneficial for environmentally and sustainable future developments. Three catechol derivatives, including 3,4 dihydroxybenzoic acid, 3,4,5-trihydroxybenzoic acid, and 3,4-dihydroxyhydrocinnamic acid, were grafted on the cellulose surface through an esterification reaction. The synthesized adsorbents were characterized with various spectroscopic methods to confirm the ester linkage and were tested for Ga separation and recovery in presence of competitive ions in acidic conditions. Various adsorption parameters such as pH, temperature, initial concentration, and contact time, which affect the Ga adsorption efficiency, were investigated, and analyzed by adsorption isotherm, kinetics, and thermodynamic modeling. Selectivity experiments were conducted in the presence of various competing metal ions. Recyclability of adsorbents were investigated with various mineral acids. The metal binding mechanism was studied with Scanning electron microscopy (SEM), and Energy dispersive X-ray spectroscopy (EDS) and Fourier-transform infrared spectroscopy (FTIR).

The selective extraction, separation, and recovery of gallium (Ga), one of the critical elements, is essential due to its role in clean energy technologies and its low reserves. Herein, different catechol derivatives (Pn)-functionalized cellulose substrates were developed using 3,4 dihydroxybenzoic acid (P1), 3,4,5-trihydroxybenzoic acid (P2), and 3,4-dihydroxyhydrocinnamic acid (P3) through esterification reaction and used for selective extraction of gallium from dilute acidic solutions. Adsorption experiments at pH 3 displayed a maximum Ga adsorption capacity of 31.50, 14.22, and 29.50 mg g⁻¹ for P1, P2, and P3, respectively. Langmuir isotherm was illustrated as the best-fitting model to explain the equilibrium adsorption. Kinetic data were best fitted with pseudo-second order and intraparticle diffusion model, indicating that the adsorption process involves chemisorption as well as intraparticle diffusion. The newly synthesized adsorbents P1 and P3 are 10-300 times more selective for Ga than As, Fe, Al, Cd, and Ge in mixed solutions (pH 3.0) of 1:1 metal ratio. Moreover, high selectivity for gallium was achieved from binary solutions of Ga:Zn, Ga:Ge, and Ga:As in 1:10 (Sel_{Ga/M}>5), 1:50 (Sel_{Ga/M}>2), and 1:100 (Sel_{Ga/M}>2) metal ratio, suggesting that the adsorbent can separate Ga (III) from Zn (II), Ge (IV) and As (III) at the optimal conditions. The adsorbents (P1-P3) were characterized with various spectroscopic and microscopic techniques showing that the surface morphology of cellulose was greatly changed after functionalization. The Fourier-transform infrared spectroscopy (FT-IR), Scanning electron microscopy (SEM) and energy dispersive X-ray spectroscopy (EDS) analysis demonstrated that the adsorption of Ga onto the developed adsorbers was attributed to chelation between hydroxyl groups of catechol and gallium ions. This study shows the synthesis of low-cost, sustainable adsorbents for the selective recovery of gallium in dilute acidic solutions.

### Experimental Section

### Chemicals and Reagents

All chemicals and reagents were purchased from Sigma Aldrich Co., Thermo Fischer, AlfaAesar, and Tokyo Chemical Industry (TCI), and used without further purification. Cellulose microcrystalline powder, 3,4-dihydroxycinnamic acid (98%), thionyl chloride (≥99%), triethylamine (TEA), Hydrochloric acid (37%), sodium hydroxide (NaOH) were purchased from Sigma Aldrich Co. 3,4-dihydroxybenzoic acid (98%) was purchased from TCI. 3,4,5-trihydroxybenzoic acid (98%), dimethylformamide (99.7%) High-performance liquid chromatography (HPLC) grade, methanol and ethanol were purchased from AlfaAesar. Gallium nitrate hydrate (99.9% metal basis) was purchased from Thermo Fischer. Solutions for Germanium (Ge), Aluminum (Al), Zinc (Zn), Copper (Cu), Cadmium (Cd), Arsenic (As), Antimony (Sb), and Iron (Fe), ions commonly found in Ga sources, at 1,000 mg/L in 7% HNO₃ v/v were purchased from Inorganic Ventures (USA). HNO₃ and HCl (trace metal grade, BAH aristar plus; VWR International) were used for inductive couple plasma-mass spectrometry (ICP-MS) sample preparation and analysis.

### Synthesis of Catechol Derivative Functionalized Cellulose-Based Adsorbents

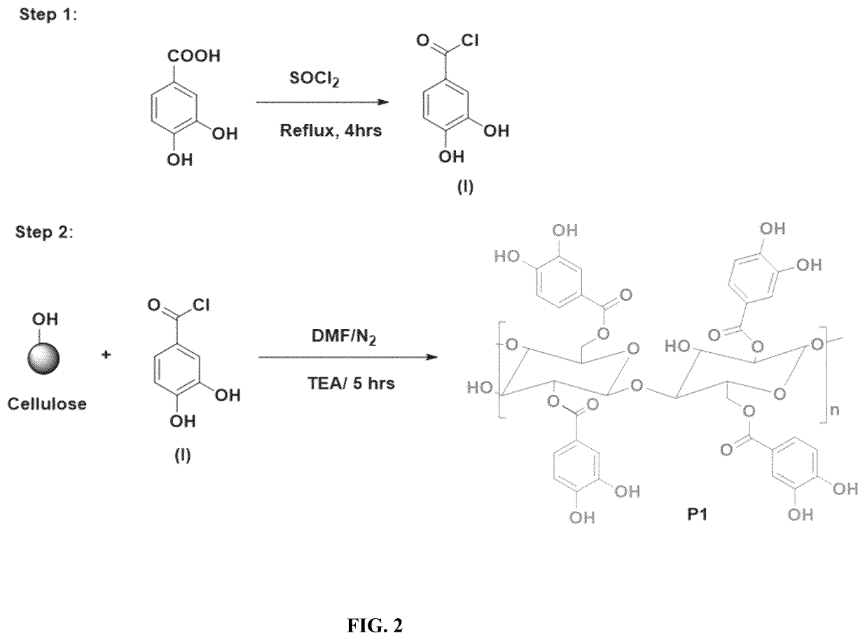

Catechol derivative functionalized cellulose was synthesized by two-step reactions; Step 1) conversion of acid to acyl chloride, and Step 2) esterification reaction (FIG. 2). Briefly, 1.54 g of 3,4-dihydroxybenzoic acid (0.01 mol) was dissolved in 11.89 g of thionyl chloride (0.1 mol), and the reaction mixture was refluxed for 4 hours. After completion of the reaction, excess thionyl chloride was distilled off in a rotary evaporator under reduced pressure at 60° C. The crude product (I) (FIG. 2) (white powder) was used for the further reaction without purification.

### Grafting of Catechol Derivative Product (I) on Cellulose

1 g of cellulose was dissolved in 10 mL of dimethyl formamide (DMF), and 0.965 g of triethylamine (0.009 mol) was added to it. Next, 1.64 g of product (I) was added to the above solution dropwise in ice bath under nitrogen environment. The reaction mixture was stirred for 5 hours at room temperature (20-22° C.). After, 5 hours, stirring stopped and DI water was poured in it, for dissolving the impurities and filtered in vacuum. The final product (P1) was washed 3-4 times with DI water, ethanol and dried in vacuum at 60° C. Adsorbents P2 and P3 were synthesized following the same scheme used for adsorbent P1.

### Characterization

Fourier transform infrared spectra (FTIR) of the adsorbents were recorded and collected on a Bruker vertex-70 equipped with solid state diamond assembly. The spectra were collected from 500 to 4000 cm⁻¹ with 4 cm⁻¹ resolution and 400 scans per sample. Scanning electron microscopy (SEM) images were collected on Verios G4 SEM (Thermo-Scientific). The cellulose and adsorbent samples were coated with 5 nm iridium before SEM analysis to prevent electrical charging. Energy-dispersive spectroscopy (EDS) analysis was performed using an X-MaxN detector (Oxford instruments, Concord, MA). X-ray photoelectron spectroscopy (XPS) analysis was performed using physical electronics Versa Probe III equipped with a monochromatic Al kα x-ray source (hv=1,486.6 eV) and a concentric hemispherical analyzer. The Zeta potential of the adsorbents was determined using a Nano ZS Malvern. The pH of prepared solutions was measured on a Mettler Toledo S220 SevenCompact™ Benchtop pH/Ion selective electrode (ISE) Meter. The concentration of adsorbate solutions before and after adsorption experiments was determined using an Agilent 7800 inductive coupled plasma-mass spectrometer (ICP-MS). The estimation of active functional groups on the adsorbents' surface was determined by the Boehm titration method.

### Adsorption Experiments

Batch adsorption experiments were performed in 15 mL polystyrene screw cap test tubes with solid: liquid (S/L) ratio of 1:1 (10 mg adsorbent/10 mL of Ga (III) solution), mixed in end-over-end fashion (rotation at 30 rpm) at room temperature for 24 hrs. After the completion of mixing, the supernatant solution was sampled, acidified, and analyzed for Ga (III) with ICP-MS. The effect of pH on Ga adsorption was carried out at controlled pH (1, 2, 3, 4, 5, 10) at room temperature (20° C. to 22° C.). The equilibrium adsorption capacity (qₑ) was calculated by equation (1) as

$${q}_{e} ( \frac{mg}{g} ) = ( {C}_{o} - {C}_{e} ) * \frac{V}{m} \qquad ( 1 )$$

Cₒ and Cₑ are the initial and equilibrium concentration of the Ga (III) in the batch adsorption experiment, V is the total volume of solution (L), and m is the mass of the adsorbent used (g). The solid-liquid distribution (partitioning) coefficient (K_{d}) was calculated by equation (2)

$$Kd ( \frac{L}{g} ) = \frac{{C}_{o} - {C}_{e}}{{C}_{e}} * \frac{V}{m} = \frac{{q}_{e}}{{C}_{e}} \qquad ( 2 )$$

qₑ is the adsorption capacity and Cₑ is the equilibrium concentration of the gallium ion in the adsorption batch experiment. The maximum adsorption was observed at pH 3, and further pH 3 was chosen for consequent tests and study. The adsorption isotherm experiments were conducted at pH 3 with Ga concentration varying from 5 mg L⁻¹ to 100 mg L⁻¹ to attain the adsorption at equilibrium. The effect of contact time on adsorption was carried out from 30 min to 48 hrs at pH 3, analyzing samples every 2 hrs. The effect of temperature on adsorption of Ga to the functionalized cellulose were carried out at 40° C. and 55° C., using an orbital shaker incubator by fixing the test tube horizontally and shaking it at 100 rpm. Selectivity experiments of Ga adsorption against other ions were carried out at pH 3 in the presence of a mixture of competitive metal ions (at 20 mg/L each), e.g., Ge (IV), Zn (II), Cu (II), Al (III), Cd (II), As (III), Sb (V), and Fe (III). Further, the binary solution of Ga:M in 1:10 (Ga (III)=20 mgL⁻¹ and M=Zn, Ge, As=200 mgL⁻¹), 1:50 (Ga (III)=5 mgL⁻¹ and M=Zn, Ge, As=250 mgL⁻¹), and 1:100 (Ga (III)=5 mgL⁻¹ and M=Zn, Ge, As=500 mgL⁻¹), metal ratio was selected for Ga-adsorption studies with adsorbents P1 and P3. The separation factor (SF) for gallium over other metal ions in the competing adsorption experiments was calculated by equation (3)

$$SF ( \frac{Ga}{M} ) = \frac{KdGa}{KdM} \qquad ( 3 )$$

(K_{d} Ga) and (K_{d} M) is the distribution (partitioning) coefficient for gallium and other metals ions.

Elution and desorption schemes were studied and performed using different concentrations of the mineral's acids (e.g., HCl, HNO₃ and H₂SO₄).

### Result and Discussion

### Synthesis and Characterization of Adsorbents P1-P3

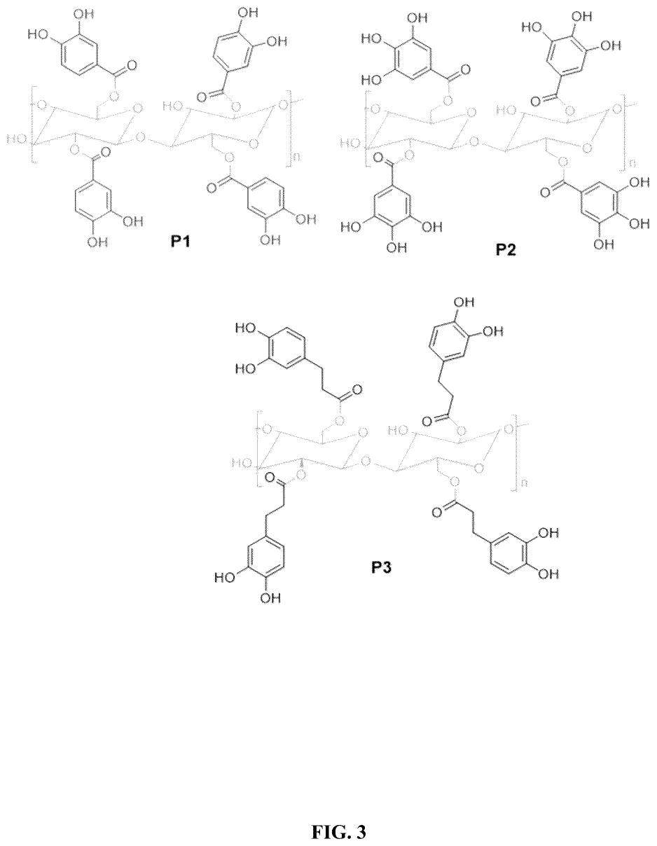

Catechol derivative functionalized adsorbents (P1-P3) were synthesized by nucleophilic addition reaction. The adsorbents P1-P3 (FIG. 3) were characterized with FT-IR, Zeta potential, back titration, SEM imaging, EDS, and XPS analysis.

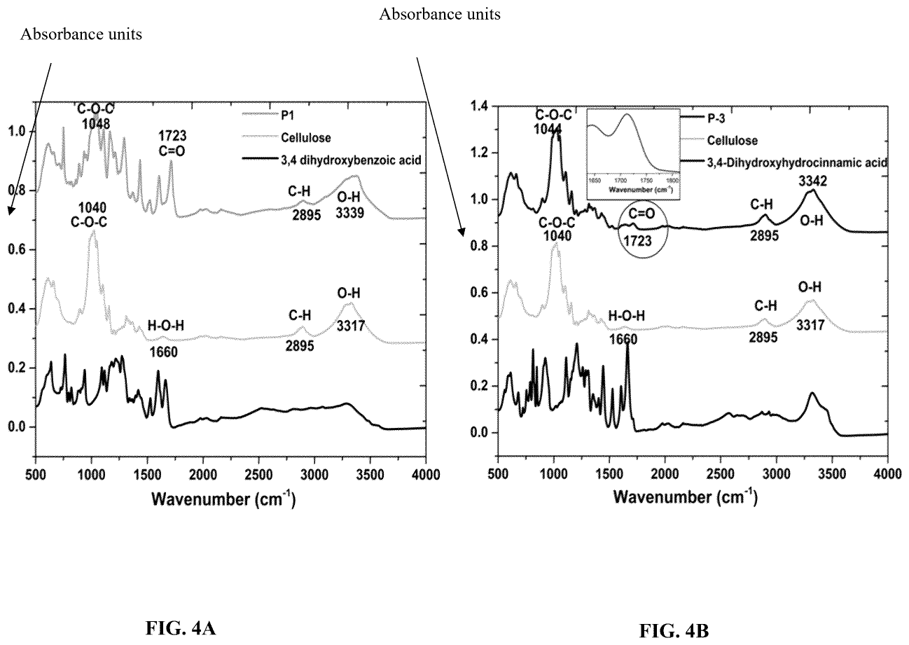

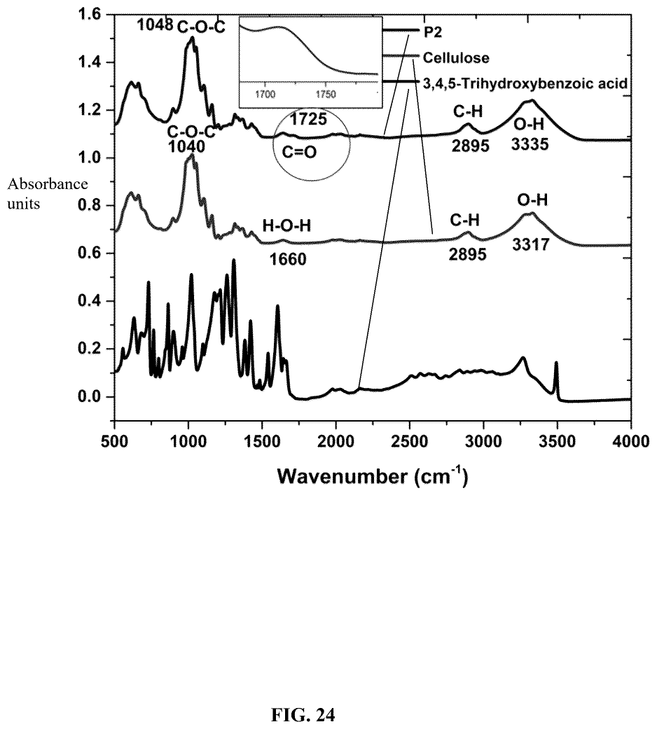

The Fourier transform infrared spectra (green spectra highlight in FIG. 4A and FIG. 4B) of cellulose shows absorption peaks at 3350 and 2895 cm⁻¹, corresponding to stretching vibration of OH and C—H group. At 1660 cm⁻¹, a deformation vibration of O—H of water molecules attached to cellulose was observed. The absorption peak at 1000-1200 cm⁻¹ was attributed to C—O—C and C—O vibration (FIG. 4A). Catechol derivative functionalized cellulose (P1-P3) exhibited strong absorption peak at 1720-1730 cm⁻¹ and 1650-1400 cm⁻¹ corresponding to stretching vibration of the C═O of the ester linkage and C═C stretching vibration of aromatic ring. Moreover, the deformation vibration of H—O—H at 1660 cm⁻¹ disappeared in adsorbents' spectrum, which indicated that the functionalization occurred at the hydroxyl groups of C₂, C₃ and C₆ position. Additional spectra can be found in FIG. 24.

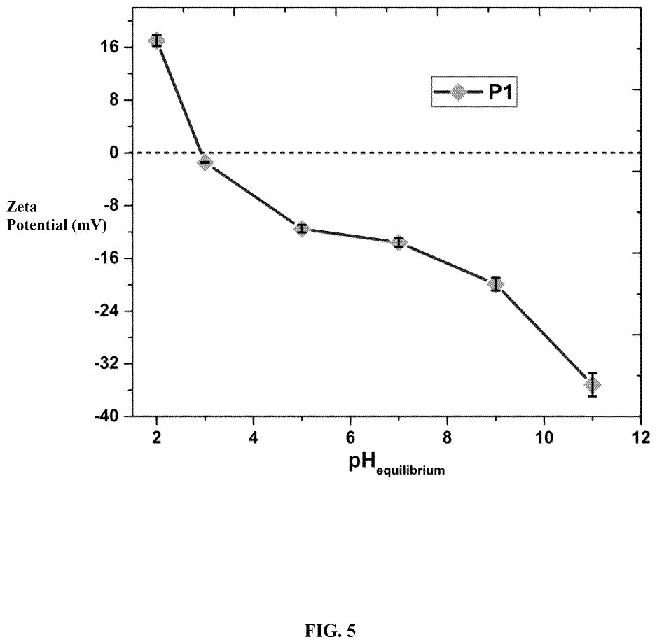

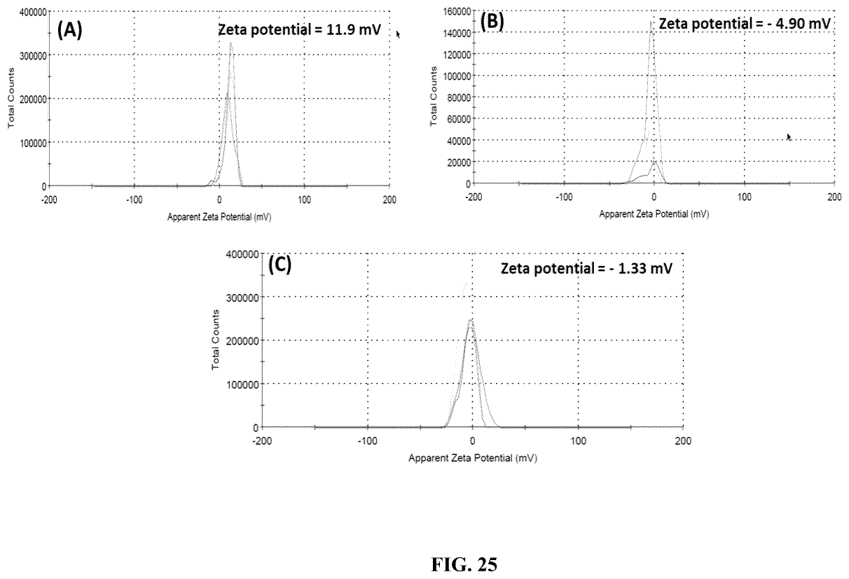

The point of zero charge (PZC) of adsorbent P1 was found to be 2.91 (FIG. 5 and FIG. 25), while the PZC of pure cellulose is 2.34. This small change (Δ=0.57 mV) in the pzc value confirms that the surface was functionalized with catecholic acid, which modulated the electrokinetic properties of cellulose. The increase in pzc of adsorbent P1 compared to cellulose was because functionalization of catechol derivatives on surface hydroxyl groups, leads to decrease in number of hydroxyl groups at the cellulose surface and decreases the surface charge. At pH<pzc the adsorbent surface is positively charged as indicated by +ve zeta potential (FIG. 5). At higher pH (e.g., >3), the zeta potential of adsorbent P1 becomes negative due to deprotonation of hydroxyl groups of both catechol and cellulose, and overall, the surface becomes more negative.

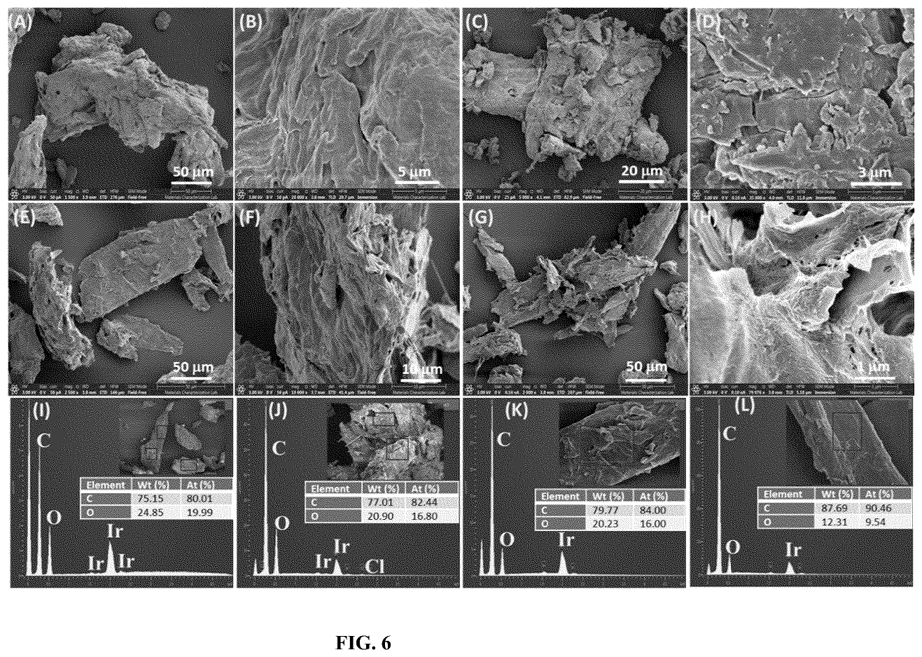

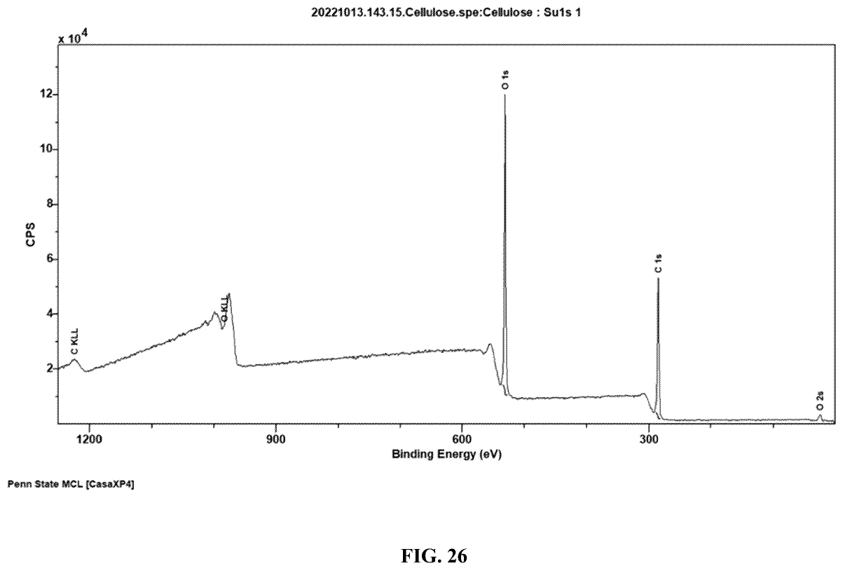

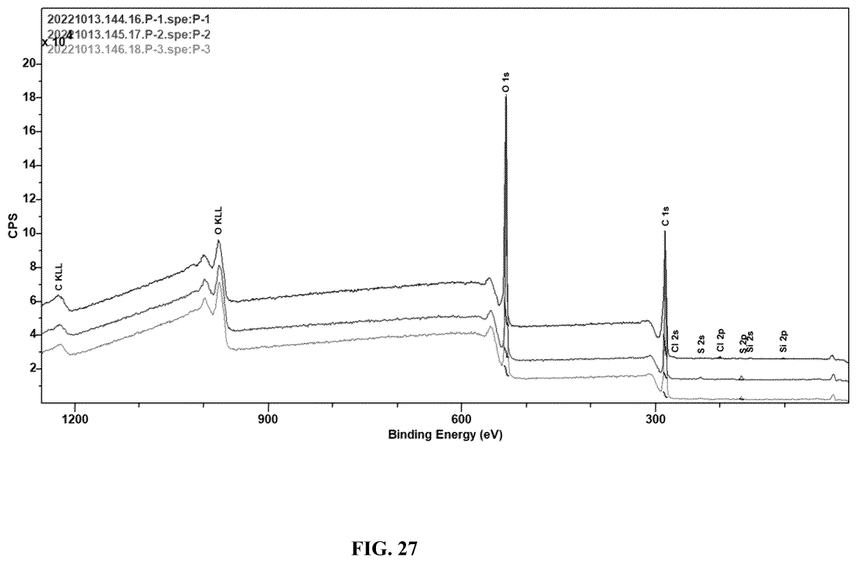

The number of hydroxyl groups on the adsorbents surface was determined with back titration and found to be 3.07 (P1), 2.0 (P2), and 2.0 mmol/g (P3). Moreover, the elemental composition of cellulose and adsorbent P1 were determined through XPS survey scan (FIG. 26 and FIG. 27). The investigation showed 54.9% C (atomic) and 45.1% O content in cellulose, and 63.7% C and 35.4% O in P1 adsorbent. The catechol derivative grafting yield for the P1 adsorbent calculated from the elemental composition was 80%, thus resulting in 2.60 mmol g⁻¹ of catechol density on the cellulose surface. The catecholic acid grafting yield is consistent with the back titration results. The functionalization of cellulose changed its surface morphology from a wrinkled surface for cellulose (FIG. 6, image A and image B) to ultrathin wrinkled surface after functionalized (FIG. 6, images C, D, E, F, G, H). The wrinkled surfaces are beneficial to maintaining high surface area for the adsorption of metals. The surface morphology of P1 adsorbent exhibits more roughness and particles are more scattered, whereas P2 and P3 showed fibrous structure with ultrathin wrinkled surface. It is well documented that high specific surface area provides more surface reactive sites, which leads to an increase in adsorption performance. In this case, the cellulose and its functionalized derivatives were analyzed by SEM-EDS showing 75.15% wt C and 24.85% wt O for cellulose (FIG. 6, image I); 77.01% wt C and 20.90% wt O for P1 (FIG. 6, image J); 79.77% wt C and 20.23% wt O for P2 (FIG. 6, image K); and 87.69% wt C and 12.31% wt O for P3 (FIG. 6, image L). The increase in C/O ratio in all adsorbents with respect to cellulose further confirmed the functionalization of catechol derivatives on the cellulose surface.

### Effect of pH on Adsorption

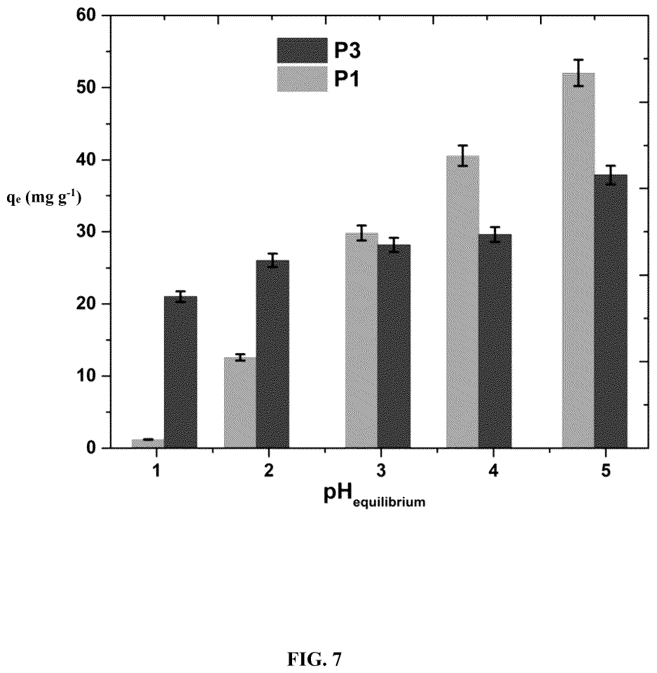

The effect of pH was studied due to its importance in adsorption since it affects the metal ion species in solution (e.g., hydrolysis, precipitation, and complexation) and the surface charge of the adsorbents (e.g., protonation and deprotonation). In the acidic solution (1<pH<5), gallium exists as Ga³⁺, Ga(OH)²⁺; and Ga(OH)₂⁺, which are its dominant species. Ga³⁺ is the dominant species at pH<2, while at 2<pH<3, gallium hydrolyzed into Ga(OH)²⁺, and at 3<pH<5 Ga(OH)₂⁺ became dominant. Adsorption experiments with Ga in the range 1<pH<5 using catechol-functionalized cellulose revealed that the adsorption capacity increased from pH 1 to pH 3, owing to decrease in competition between H⁺ and the metal ions for same adsorption sites with increase in pH (FIG. 7). Precipitation of gallium hydroxide (e.g., Ga(OH)₃) has been previously observed at pH 3-9 and remains as major gallium species. The anionic species Ga (OH) 4 is formed at pH range of 4-14 and becomes predominant (100%) in alkaline solution (pH 9-14) which coincides with the decreased adsorption above pH 9 (17.75 mg/g and 18 mg/g for P1 and P3, at pH 10, respectively) observed in this study. A potential explanation to this is that the hydroxyl groups of catechol are negatively charged at pH 9 as evident from the zeta potential. The negative charged surface causes electrostatic repulsion between hydroxyl groups of catechol and Ga(OH)₄⁻ as well as Ga(OH)₅²⁻. The subsequent adsorption experiments were done at pH 3 to avoid precipitation of Ga as Ga(OH)₃.

### Adsorption Isotherm

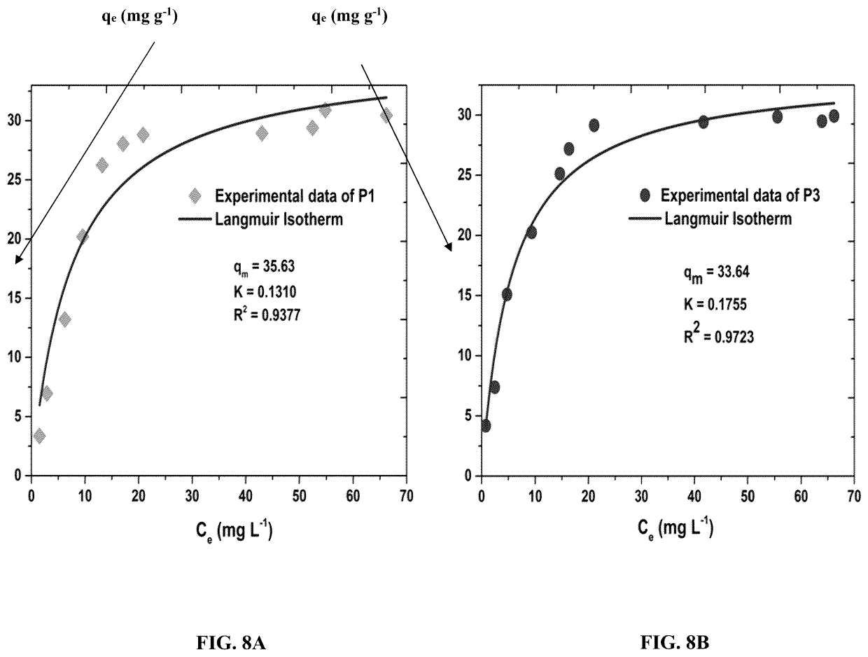

The adsorption isotherm experiments using adsorbents P1 and P3 were conducted by varying the initial concentration of Ga from 5 to 100 mg L⁻¹ at pH 3. The adsorption increased with increase in the concentration of Ga ion (FIGS. 8A and 8B). The maximum adsorption capacities of 31.50 mg/g (P1), and 29.50 mg/g (P3) were measured for the newly developed adsorbents in this study, which are higher than the adsorption capacities for Ga reported in the commercialized amidoxime resin LSC 700 (Table S2). The commercial resin LSC 700 was chosen as a benchmark due to its capacity, 29 mg g⁻¹. The adsorption behavior (homogeneous or heterogeneous surface) was studied by applying Langmuir (eqs. 4) and Freundlich (eqs. 5) adsorption isotherms on the collected experimental data. The Langmuir isotherm articulates monolayer adsorption on a homogeneous surface with fixed number of adsorption sites, while Freundlich isotherm considers multilayer adsorption on heterogenous surfaces with indefinite number of adsorption surface sites.

$$\frac{{C}_{e}}{{q}_{e}} = \frac{1}{{K}_{L} {Q}_{m}} + \frac{{C}_{e}}{{Q}_{m}} \qquad ( 4 )$$

$$ln {q}_{e} = ln {K}_{f} + \frac{1}{n} + ln Ce \qquad ( 5 )$$

Where, Qₘ(mg/g) is the Langmuir adsorption capacity, K_{L}(L/mg) the Langmuir isotherm constant, K_{f}(L/mg)^{1/n} the Freundlich isotherm constant, and n the heterogeneity factor.

TABLE 1
Langmuir and Freundlich Isotherm parameters for
gallium adsorption through adsorbents P1 and P3.

| | Experimental | Langmuir Isotherm | | | Freundlich Isotherm | | |
|---|---|---|---|---|---|---|---|
| | Max qₑ | Qₘ | K_{L} | | K_{f} | | |
| Adsorbents | (mg/g) | (mg/g) | (L/g) | R² | (L/g)^{1/n} | n | R² |
| P1 | 31.50 | 35.63 | 0.1310 | 0.9377 | 4.357 | 1.86 | 0.8316 |
| P3 | 29.50 | 33.64 | 0.1755 | 0.9723 | 6.168 | 2.30 | 0.8756 |

Adsorption parameters (Table 1) showed that the Langmuir model better describes the data compared to Freundlich isotherm based on the R². The Langmuir adsorption capacity, Qₘ, was close to the experimental maximum adsorption. The agreement between experimental data and Langmuir isotherm indicates that the adsorption was monolayer and adsorption sites are homogeneous and are limited.

### Adsorption Kinetics

Adsorption kinetics were investigated to determine the adsorption rate and equilibrium time. The adsorption quantity increased with increase in contact time till 24 hours and thereafter remained constant. The adsorption kinetics were fitted with pseudo first order (PFO; eqs. 6), pseudo second order (PSO; eqs. 7), and Weber and Morris interparticle diffusion model (eqs. 8) expressed below:

$$\frac{{dq}_{e}}{dt} = {k}_{1} ( {q}_{e} - {q}_{t} ) {⇀}_{⇁} {q}_{t} = {q}_{e} [ 1 - exp ( - {k}_{1} t ) ] \qquad ( 6 )$$

$$\frac{{dq}_{e}}{dt} = {{k}_{2} ( {q}_{e} - {q}_{t} )}^{2} {⇀}_{⇁} {q}_{t} = \frac{{{q}^{2}}_{e} * {k}_{2} t}{( 1 + {q}_{e} * {k}_{2} t )} \qquad ( 7 )$$

$${q}_{t} = {k}_{i} {t}^{0.5} + C \qquad ( 8 )$$

qₜ and qₑ are representing adsorption capacity at time (t) and equilibrium, k₁ (h⁻¹), k₂ (g mg⁻¹ h⁻¹), and kᵢ (mg g⁻¹ h^{-0.5}) are rate constants for first order (PFO), pseudo-second order (PSO) and interparticle diffusion, respectively. C (the intercept) is a constant (mg g⁻¹).

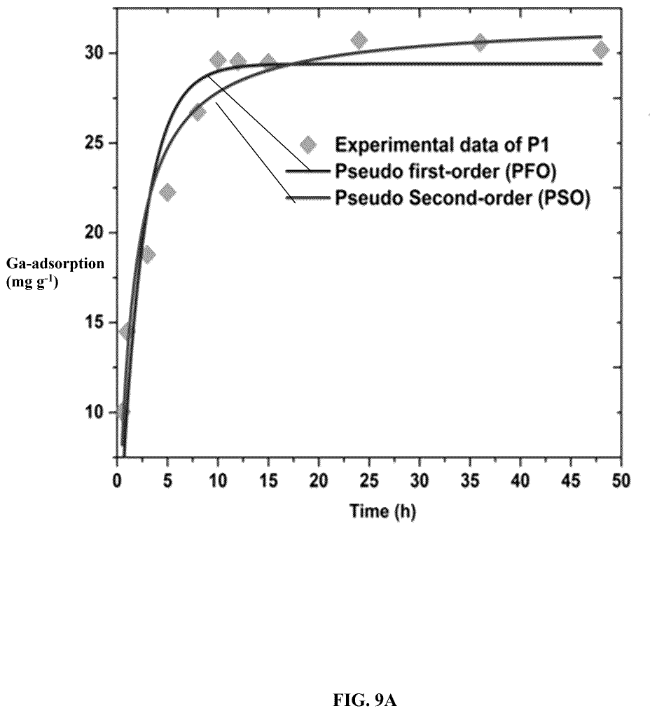

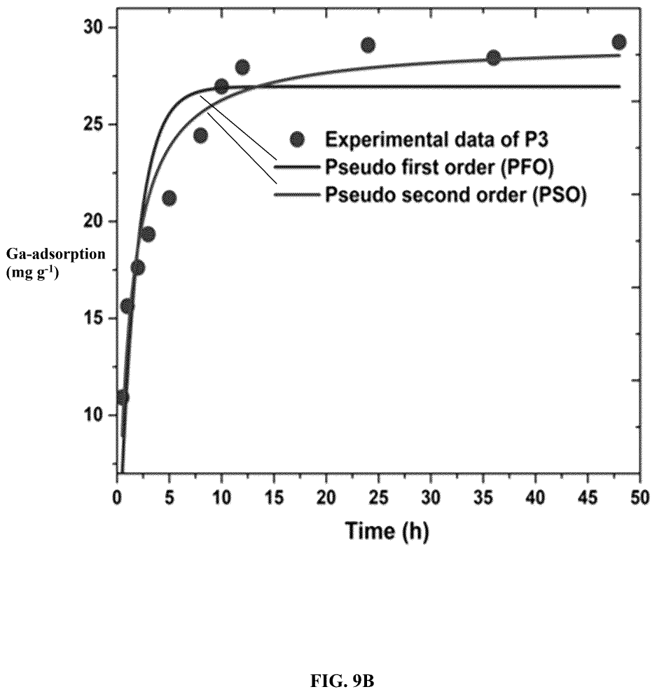

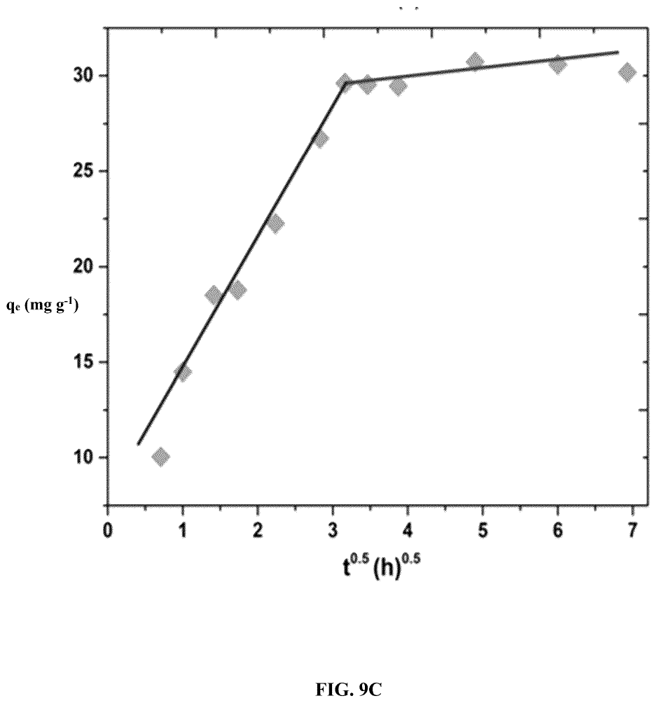

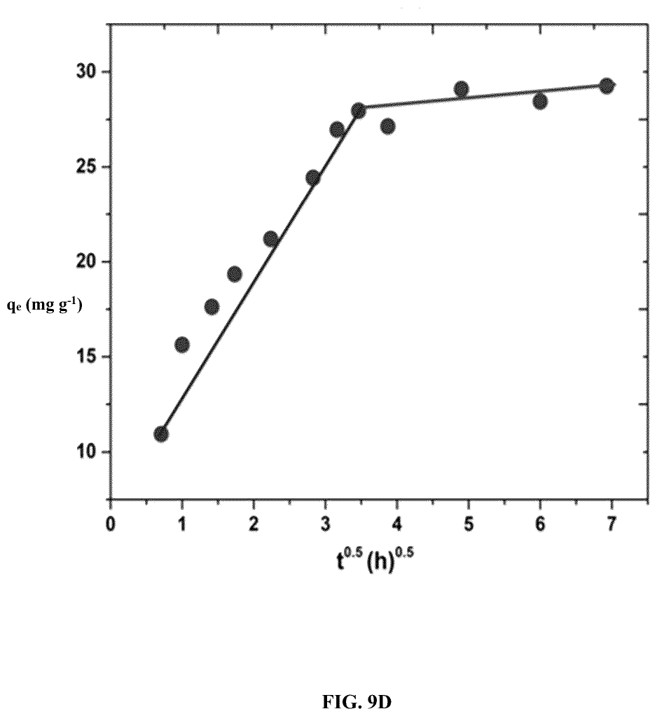

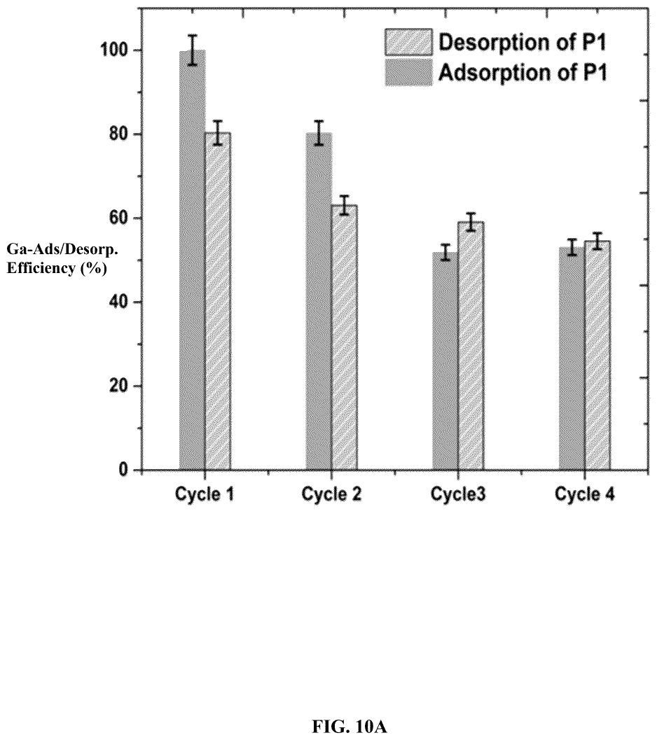

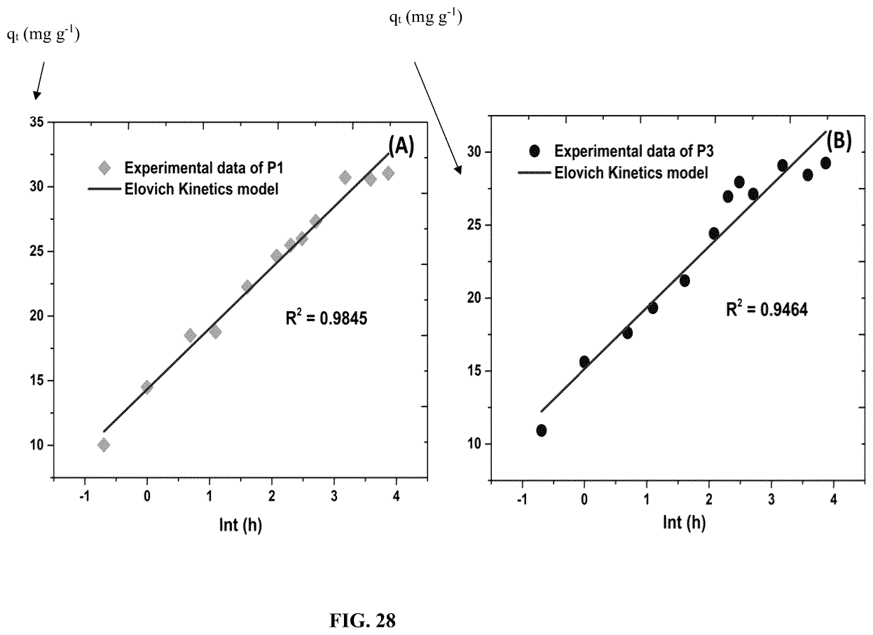

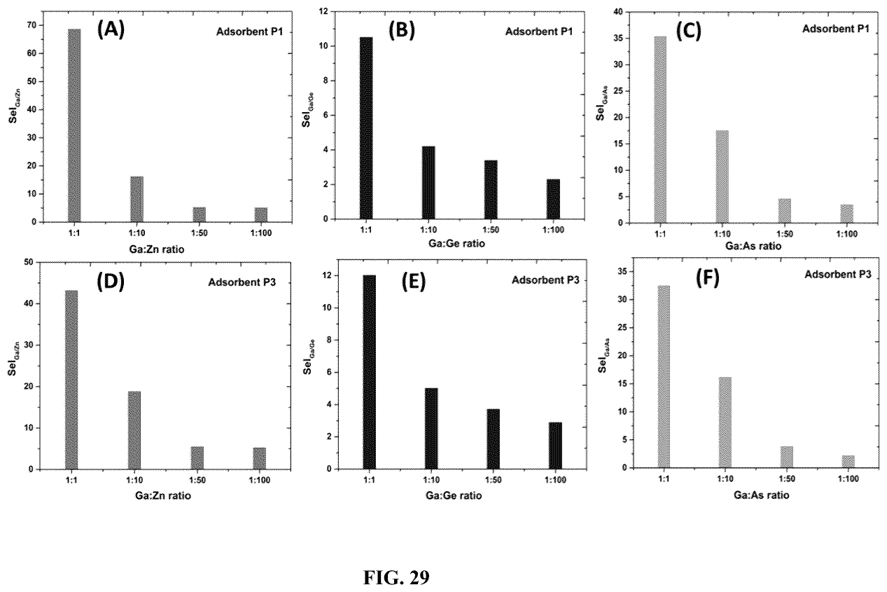

Pseudo-first order model depends on the mass transfer from bulk to adsorption sites and assume that the driving force is the concentration gradient. In pseudo-second order model, the chemosorption (chemical reaction) is assumed to be the rate-limiting step. Pseudo-first order and pseudo-second order model were applied to adsorption data of P1 and P3 (FIGS. 9A and 9B). The pseudo-second order model had a better correlation coefficient than that of pseudo first order kinetics for P1 and P3 (Table 2), indicating that the pseudo second order model can better explain the adsorption kinetics. Consequently, our results indicate that chemosorption was the main process for adsorption of gallium. The Elovich kinetics model is mostly used for chemosorption, where the chemical reaction controls the adsorption rate. Elovich kinetics model for adsorbents P1 and P3 for gallium ions (FIG. 28) was applied using the following equation (9):

$${q}_{t} = 1 / β ln ( αβ ) + 1 / β ln t \qquad ( 9 )$$

where, qₜ (mg g⁻¹) is Ga-adsorption capacity of adsorbent at time (t), α is initial adsorption rate (mg g⁻¹ h⁻¹) and β is the desorption constant (g mg⁻¹).

The high value of initial adsorption rate (α) indicates that larger number of adsorption sites are available for immediate adsorption of gallium ions. However, the smaller value of desorption constant (β) indicates that this model was unable to describe the heterogenous surface of the catechol functionalized adsorbents. Further, to check the effect of intraparticle diffusion on Ga-adsorption the Weber and Morris model was applied (FIGS. 9C and 9D). It is suggested that the adsorption occurred in two step process. The first linear region represents the film diffusion, and second region is contributed to intraparticle diffusion. The film diffusion region is more prominent than intraparticle region in both adsorbents and is represented by large slope (K_{id}) (Table 2). Film diffusion affected the Ga-adsorption at initial stage before obtaining the steady-state external mass transfer. The lower slope of intraparticle diffusion indicates a more gradual adsorption process. The intercept of fitted linear line does not pass through origin, suggesting that intraparticle diffusion is not the rate controlling step and multiple processes control adsorption. The intercept (Cᵢ) represents the extent of boundary layer thickness, and larger value of intercept indicates the greater boundary layer effect. Thus, P3 adsorbents (C_{id}=8.84 mg g⁻¹) have slightly more boundary layer effect than P1 adsorbent (C_{id}=7.05 mg g−1). Based on above parameters, it is assumed that the Ga-adsorption mechanism is complex, and that the adsorption process consists of intraparticle diffusion as well chemosorption.

TABLE 2
Kinetic parameters of pseudo-first order, pseudo-second order, and intraparticle
diffusion model for gallium adsorption on adsorbents P1 and P3.

| | Pseudo-first order | | | | Pseudo-second order | | | Intraparticle | |
|---|---|---|---|---|---|---|---|---|---|
| | kinetics (PFO) | | | | kinetics (PSO) | | | diffusion | |
| | Exp. | Model | | | Model | | | K_{id} 1 | K_{id} 2 |
| | qₑ | qₑ | K₁ | | qₑ | K₂ (g | | (mg g⁻¹ | (mg g⁻¹ |
| Adsorbents | (mg/g) | (mg/g) | (h⁻¹) | R² | (mg g⁻¹) | mg⁻¹h⁻¹) | R² | h^{-0.5}) | h^{-0.5}) |
| P1 | 31.50 | 29.39 | 0.42 | 0.88 | 31.83 | 0.021 | 0.95 | 6.98 | 1.93 |
| P3 | 29.50 | 26.95 | 0.55 | 0.80 | 29.23 | 0.030 | 0.93 | 5.63 | 0.35 |

### Thermodynamics of Adsorption

The adsorption at increased temperature, showed maximum adsorption capacity at pH 3 following the order of 298K<313K<328K. Thermodynamic parameters such as ΔG^{o}, ΔH^{o} and ΔS^{o} were determined and shown in Table 3. The equations used (10-12) for calculating thermodynamic parameters are shown below:

$${K}_{d} ( \frac{L}{g} ) = \frac{{q}_{e}}{{C}_{e}} \qquad ( 10 )$$

$$Ln {K}_{d} = \frac{Δ {S}^{0}}{R} - \frac{Δ {H}^{0}}{RT} \qquad ( 11 )$$

$$Δ {G}^{0} = Δ {H}^{0} - T Δ {S}^{0} \qquad ( 12 )$$

K_{d} is thermodynamic equilibrium constant, R is universal gas constant (8.314 J/mol/K), T is temperature (K). ΔG^{o} is standard Gibbs free energy (KJ/mol), ΔH^{o} is standard enthalpy (KJ/mol) and ΔS^{o} is standard entropy (J/mol/K).

The value of ΔG^{o} is negative and thus, the Ga (III) adsorption process is spontaneous (Table 3). Moreover, the ΔG^{o} became more negative with increasing temperature indicating more favorable conditions for adsorption of Ga (III) ion at higher temperatures. The ΔH^{o} has a positive value indicating that the Ga adsorption is an endothermic process. The positive value of the standard entropy confirms that the adsorption of Ga is entropy-controlled process (Table 3).

TABLE 3
Thermodynamic parameters of gallium adsorption on adsorbent P1 and P3.

| Adsorbent P1 | | | | Adsorbent P3 | | | |
|---|---|---|---|---|---|---|---|
| T | ΔG^{o} | ΔH^{o} | DS^{o} | T | ΔG^{o} | ΔH^{o} | ΔS^{o} |
| (K) | (KJ/mol) | (KJ/mol) | (J/mol/K) | (K) | (KJ/mol) | (KJ/mol) | (J/mol/K) |
| 298 | −16.93 | 19.70 | 55.80 | 298 | −14.35 | 17.82 | 48.24 |
| 313 | −17.47 | | | 313 | −15.08 | | |
| 328 | −18.30 | | | 328 | −15.80 | | |

### Desorption Studies

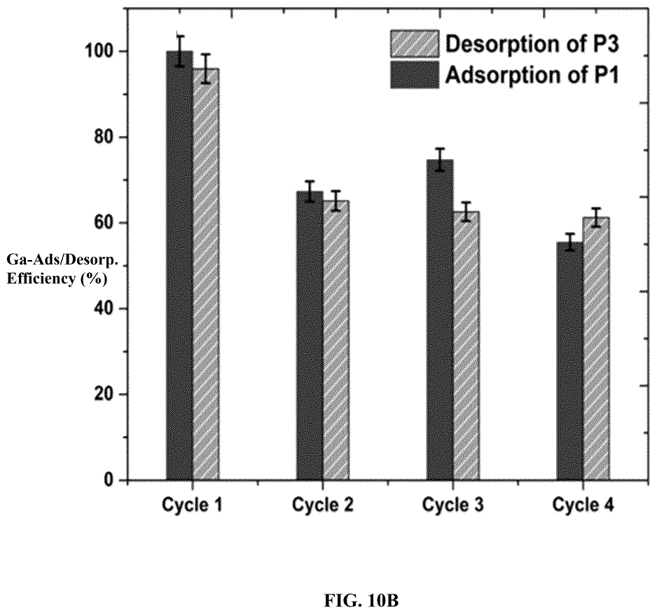

The ability to desorb the adsorbed metals and reuse the adsorbent materials are essential to determining economic and technical viability of the separation methods. Various chemical reagents have been reported previously for metal desorption and regeneration of adsorbents, such as acids, alkalis, chelating agents, and buffer solutions. However, the desorption of metals in acidic solution is much faster than basic and neutral medium. The acid protons (H⁺) demonstrate strong competition with metal ions for same adsorption sites of the adsorbents, causing displacement of chelated cation in the acidic solution. The desorption of Ga was carried out with different mineral acids, HNO₃, and H₂SO₄ at 1M, 2M, and 3M concentrations. The maximum desorption (78% for P1 and 95% for P3) was achieved with 3M of HCl (FIGS. 10A and 10B). Further, the 3M of HCl was used for multiple adsorption-desorption cycles due to the highest desorption observed among the acid concentrations tested. In two adsorption-desorption cycles, the adsorption % is more than desorption %, suggesting that the adsorbed gallium was not completely desorbed (FIGS. 10A and 10B). The adsorption/desorption % is consistent (>55% for P1; >62% for P3) after the 3^{rd} cycle due to regeneration equilibrium. The decrease in adsorption efficiency in each cycle attributed to non-renewable adsorption sites (e.g., irreversible binding of Ga on the catechol surface) and adsorbent mass loss in each adsorption-desorption cycle.

### Selectivity Studies

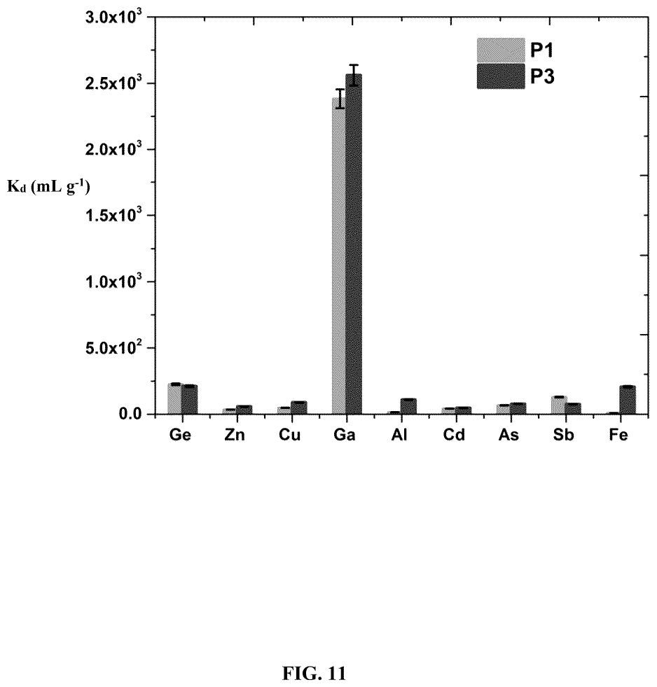

The effect of competing and/or coexisting ions for the adsorption of Ga on the new catechol-functionalized cellulose was evaluated. Competitive adsorption experiments were performed with the ions commonly present in zinc refinery residues (e.g., Ga (III), Zn (II), Cu (II), Fe (III), and Ge (IV)), coal fly ash (e.g., Ga (III), Ge (IV), Al (III), Fe (III)), Ga/As semiconductor production (As (V)), and in nuclear reactors (Ga coexists with Cu (II), Ni (II), and Zn (II)). The primary goal of this study was to investigate the separation of Ga (III) from these waste products. The competitive ion adsorption experiments were carried out at pH 3, to avoid the precipitation of ions such as Al (III) and Fe (III). The equilibrium pH was 2.96. High selectivity was achieved and observed for both P1 and P3 against the ions above (FIG. 11 and Table 4). The high Ga selectivity for adsorbents P1 and P3 was based on hard acid/base and soft acid/base (HSAB) concept. The catechol ligand contains two hydroxyl groups and behave as hard donor atoms (hard base), whereas metal ions such as Ga (III), Ge (IV), Al (III), As (III), Fe (III) and Sb (V) are hard Lewis acids, Zn (II) and Cu (II) are borderline acids and Cd (II) is considered a soft acid. The alkali and alkaline metals, such as Na (I), K (I), Mg (II) and Ca (II) are hard acids and prefer to bind with hard donor atoms. The order of acid strength of metal ions are as Al (III)>Ga (III)>Ge (IV), >As (III). Therefore, the order of metal binding for adsorbents in competitive ions solution are Al (III)>Ga (III)>Ge (IV), >As (III). However, adsorbents did not follow this trend in the adsorption studies showing higher affinity for Ga (III) than the expected Al (III) when the two metals were tested in competitive adsorption experiments. The most probable reason is that Ga (III) forms inner sphere complexes, by changing its coordination number by extending its d-subshell. Whereas Al (III) has a 2s², 2p¹ configuration and thus low possibility of varying its coordination number in ligand substitution reaction. Similarly, Na (I), K (I), Mg (II) and Ca (II) form ionic bonds and have very low possibility of forming of coordination complexes.

The calculated distribution coefficients (K_{d}) for Ga show adsorbent P1 (2382 mL g⁻¹) and P3 (2559 mL g⁻¹) preference to Ga compared to those (K_{d}<100 mLg⁻¹) of Zn, Cu, Al, Cd, As, Sd. Interestingly, both P1 and P3 exhibited a weak attraction for Ge, with K_{d,Ge} values of about 250 mL g⁻¹. The catechol derivative-grafted adsorbents can selectively separate Ga from a mix metals solution (Table 4). The low adsorption towards Ge and As compared to Ga could be attributed to repulsion between the electron rich Ge(OH)₄ and H₂AsO₄⁻/H₃AsO₃ species and negatively charged adsorbent surfaces at pH 3. Further, the binary solution of Ga:M in 1:10 (Ga (III)=20 mgL⁻¹ and M=Zn, Ge, As=200 mgL⁻¹), 1:50 (Ga (III)=5 mgL⁻¹ and M=Zn, Ge, As=250 mgL⁻¹), and 1:100 (Ga (III)=5 mgL⁻¹ and M=Zn, Ge, As=500 mgL⁻¹), metal ratio was selected for Ga-adsorption studies with adsorbents P1 and P3. The adsorbents showed selectivity for gallium even at high Ga: metal ratio (1:100, FIG. 29 (images A, B, C, D, E, F)) despite partially decreased adsorption capacity. The selectivity factor observed for Ga was more than 2 at 1:100 metal ratio (e.g., Sel_{Ga/Zn}>5, Sel_{Ga/Ge}>2, and Sel_{Ga/As}>2) suggesting the adsorbents can separate Ga (III) from Zn (II), Ge (IV) and As (III) at optimal conditions. The adsorbents may have practical application for the recovery of Ga from zinc refinery residue leachates and Ga—As end-user product wastes.

TABLE 4
Selectivity factors for adsorbent P1
and P3 for Ga against competing ions.

Selectivity factor (K_{d} Ga/K_{d} Mⁿ⁺)
for adsorbents

| Ions | P1 | P3 |
|---|---|---|
| Zn (II) | 68.63 | 43.20 |
| Al (III) | 163.60 | 23.04 |
| Sb (V) | 18.33 | 33.67 |
| Cd (II) | 56.57 | 52.96 |
| As (III) | 35.37 | 32.50 |
| Fe (III) | 285.43 | 12.30 |
| Ge (IV) | 10.51 | 12.02 |
| Cu (II) | 49.61 | 28.25 |

### Adsorbent Surface Characteristics

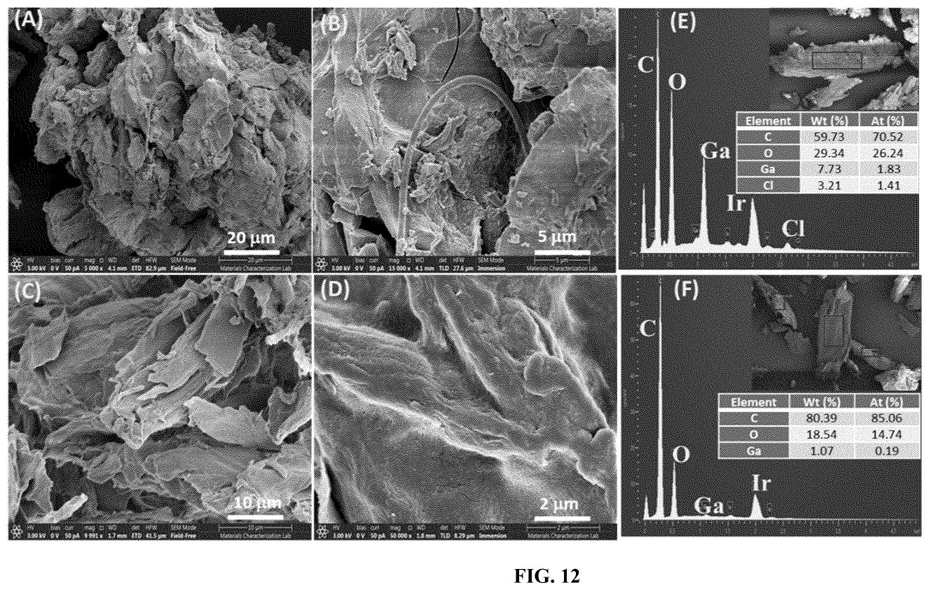

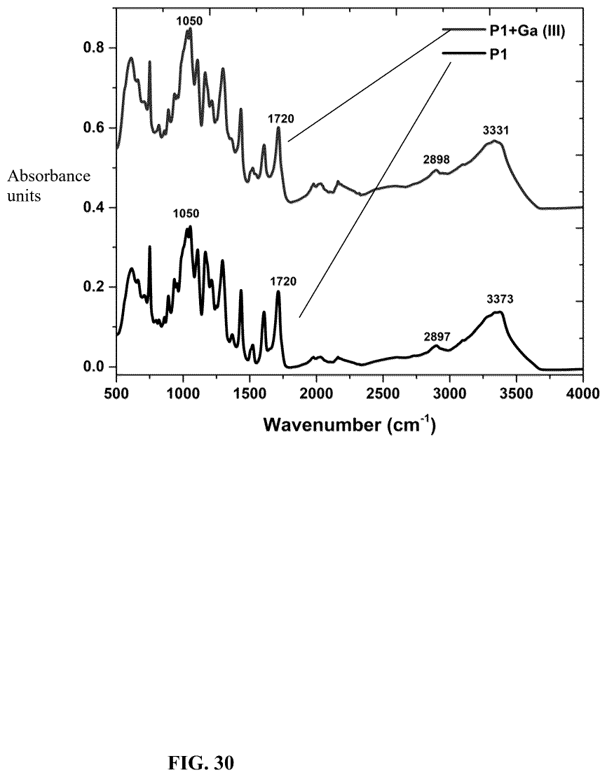

The surface morphology of adsorbents (P1 and P3) become smoother after adsorption of Ga (FIG. 12, images A, B, C, D). SEM-EDS analysis suggests that the adsorbent surface is uniformly wrapped by Ga ions, also evidenced by the elemental distributions' images (FIG. 12 images E, F). As expected, the EDS elemental composition analysis shows the main elements of C, O, and Ga of the Ga-ligand complex (FIG. 12, images E, F). The variation in C and O content of adsorbents before adsorption (77.01% wt C and 20.90% wt O for P1 and 87.69% wt C and 12.31% wt O for P3) and after Ga-adsorption (59.73% wt C and 29.34% wt 0, 7.73% wt Ga for P1 and 80.39% wt C and 18.54% wt O, 1.07% wt Ga for P3) confirmed the involvement of catechol hydroxyl groups for binding of Ga (III) ion. Also, the oxygen content increased from 20.90 wt % to 29.34 wt % for P1 and 12.31 wt % to 18.54 wt % for P3. This indicates that Ga(OH)₂⁺ and Ga(OH)²⁺ species are involved in binding in addition to Ga³⁺ ions. Moreover, FTIR spectra of adsorbent P1 and their Ga-ligand complex (FIG. 30) revealed that the Ar—OH absorption peak of catechol ligand is shifted from 3373 cm⁻¹ to 3331 cm⁻¹, which further confirms the Ga-ligand chelate complex formation.

### Adsorption Mechanism Discussion

The adsorption mechanism was interpreted from isotherm, and kinetic modeling (Table 1 and Table 2). Langmuir model was best fitted to the isotherms experimentally collected and indicates that the Ga adsorption is limited to a monolayer with homogeneous adsorption sites. Adsorption kinetics were best elucidated by pseudo-second order model and suggest that the rate limiting step is chemosorption. The chemosorption mechanism was further corroborated by a shift in FTIR peak of hydroxyl group (—OH) of the adsorbent. The gallium complexation with catechol functionalized adsorbents was further elucidated from pH studies. The Ga³⁺ are Lewis's acids and form [Ga(H₂O)₆]³⁺ in aqueous solution. Ga³⁺ is always presented with six water molecules and converted to octahedral complex in hydrolysis. The first hydrolysis step is given below (eqn. 13):

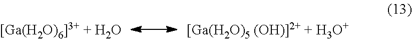

The aqueous complex of gallium becomes acidic by releasing the proton. This can be explained by the inductive effect of positively charged gallium, which weakens the O—H bond of water molecules and ends up acidifying the solution. The gallium adsorption by the catechol adsorbent is dependent on pH. At lower pH (<2) the ligand binding with Ga³⁺ is very slow due to competition with H⁺ ions, which hinders Ga approaching the adsorption sites. At higher pH (>2), Ga³⁺ is converted to Ga(OH)₂⁺ (eqn. 13), which favors fast exchange of catechol ligand with [Ga(H₂O)₅(OH)]²⁺ through coordination complex formation. This can be further analyzed from the high Ga adsorption capacity of adsorbents at pH 3-4 compared to pH 1-2. Previously, gallium complex formation with nitrocatechol at pH 2-3 was proposed by Mcdonald, which occurred through dissociation interchange mechanism, involving the reaction of [Ga(H₂O)₅(OH)]²⁺ with nitrocatechol and forming bidentate 1:1 chelates of Ga (III). This was further confirmed by the reaction of Ga³⁺ with oxalatopentamminecobalt (III) in another study. Based on this evidence, it is assumed that the adsorption of Ga (III) onto adsorbers was occurred through chelate formation.

### Conclusion

In this study, new adsorbents developed by grafting of catechol derivatives on cellulose and studied for the Ga separation and recovery from dilute acidic solution. It was experimentally and spectroscopically confirmed that the O-dihydroxyl functional groups of the catechol ligand formed chelate complex with Ga (III) ions. The synthesized adsorbents were 10-300 times more selective for Ga than As, Al, Fe, Cd, and Ge in acidic solution in 1:1 mixed metal solution. The Ga-adsorption was better fitted with Langmuir isotherm and the Ga-adsorption kinetics were better explained with pseudo-second order and intraparticle model, suggesting that the adsorption mechanism is complex and governed via chemosorption and intraparticle diffusion. Thermodynamic parameters revealed that the Ga adsorption is spontaneous, and it increases with increase in temperature. Multiple adsorption-desorption cycles were carried out with 3M HCl, and the adsorption/desorption efficiency was >95% at the beginning but >60% when system reached equilibrium. One of the important aspects of modern separation technologies is the use of highly selective methods or adsorbers in order to lower the total operation cost of processing, use of chemicals and downstream purification. The current study shows the development of catechol derivatives functionalized adsorbents, and the highly selective recovery of Ga (III) from acidic solutions. The proposed adsorbents can be potentially used for the selective recovery of Ga (III) from zinc refinery residue/coal fly ash leachates, as they are considered secondary sources for Ga and critical minerals in general.

### Example 2

In this study, we have developed four catechol-functionalized polymeric resins for the selective extraction of gallium in acidic media. The architecture of functionalized polymeric resins was designed in such a way that the O-dihydroxyl groups of catechol ligands offer binding sites for the metal ions and the polymer matrix provides ligand grafting sites and chemical stability in acidic media. These chelating adsorbents can have potentially many advantages in industrial scale for the separation of Ga, such as low-cost synthesis, commonly commercially available and produced raw materials, stability in acidic media, and high mechanical strength. Two catechol ligands: 3,4 dihydroxybenzoic acid, and 3,4,5-trihydroxybenzoic acid were functionalized on Purolite A110 and Purolite A143 Plus polymeric resins through an amide linkage. Functionalized adsorbents were characterized with various spectroscopic methods such as FTIR, XPS, SEM, and acid base titration and studied for selective extraction, separation, and recovery of Ga from mix metal solutions. Moreover, various adsorption parameters such as pH effect, adsorption isotherm, adsorption kinetics, thermodynamic parameters, selectivity, and recyclability were explored.

Ion-exchange has been extensively explored for the extraction, separation, and recovery of metal ions. The use of eco-friendly, low-cost, selective, and reusable resins are important for the development of separation technologies for critical elements. Herein, novel chelating adsorbents were synthesized and studied for the selective extraction, separation and recovery of gallium from acidic solutions. Four chelating adsorbents (J1-J4) were prepared using 3,4 dihydroxybenzoic acid, and 3,4,5-trihydroxybenzoic acid to functionalize Purolite's A110 and A143Plus resins through amide linkage and characterized with various spectroscopic and microscopic techniques. FTIR and XPS analysis confirmed the functionalization of the resins and revealed that their surface morphology was significantly improved after the chemical modification. Their adsorption performance was investigated and the maximum Ga-adsorption capacity at pH 3 was found to be 16.36, 28.71, 11.07, and 16.33 mg g⁻¹ for J1, J2, J3 and J4, respectively, which is higher than these reported in literature and are commercially available. Equilibrium Ga-adsorption isotherms were better demonstrated by the Langmuir isotherm model, and adsorption kinetics were better explained by Pseudo-second order (PSO) model. The proposed new adsorbents were 10 to 4800 times more selective for Ga than Zn, Al, Cd, Sb, Fe, As and Mn in acidic conditions. Desorption preliminary experiments showed >60% desorption of Ga over 4 adsorption/desorption cycles, without any optimization of the process. The adsorption mechanism was confirmed by XPS and FTIR studies to be chelation between the adsorbent ligandhydroxyl groups and Gallium. This study indicates that the synthesized adsorbents could be used for industrial applications, due to their low-cost, abundant raw materials, mature synthetic routes and lower environment impact.

### Experimental Section

### Chemicals and Reagents

The commercial amine-supported resins, Purolite A110 and A143 Plus were purchased from Purolite Corp., PA, USA. Both A110 and A143 Plus resin beads have polystyrene crosslinked with divinylbenzene in their backbone structure. Purolite A110 is a weak base anion exchange resin with a total capacity of 2.0 eq L⁻¹ and a size of 300-1200 mm. Purolite A143 Plus is also a weak base anion exchange resin with a total capacity of 1.2 eq L⁻¹. Purolite A110's surface contains primary amine whereas, Purolite A143 Plus have complex amine on their surface. The amount of amino groups on Purolite A110 and A143Plus surface was an estimation using a neutralization titration, which found to be 5.49 mmol g⁻¹ and 5.45 mmol g⁻¹ respectively. Thionyl chloride (≥99%), triethylamine, Hydrochloric acid (37% v/v), and sodium hydroxide (NaOH) were purchased from Sigma Aldrich Co. 3,4-dihydroxybenzoic acid (98% v/v) was purchased from TCI. Gallic acid (98% v/v), methanol, and ethanol were purchased from Alfa Aesar. Gallium nitrate hydrate (99.9% metal basis) was purchased from Thermo Fischer. The metals solution (1000 mg L⁻¹ in 7% HNO₃ v/v) such as manganese, aluminum, zinc, copper, cadmium, arsenic, antimony, and iron was purchased from Inorganic Ventures (USA). HNO₃ and HCl (trace metal grade, BDH aristar plus; VWR International), used for ICP-MS sample preparation, were purchased from VWR International. All chemicals, reagents, and solvents were of analytical grade and were used as received.

Functionalization of Resin Beads with Catechol

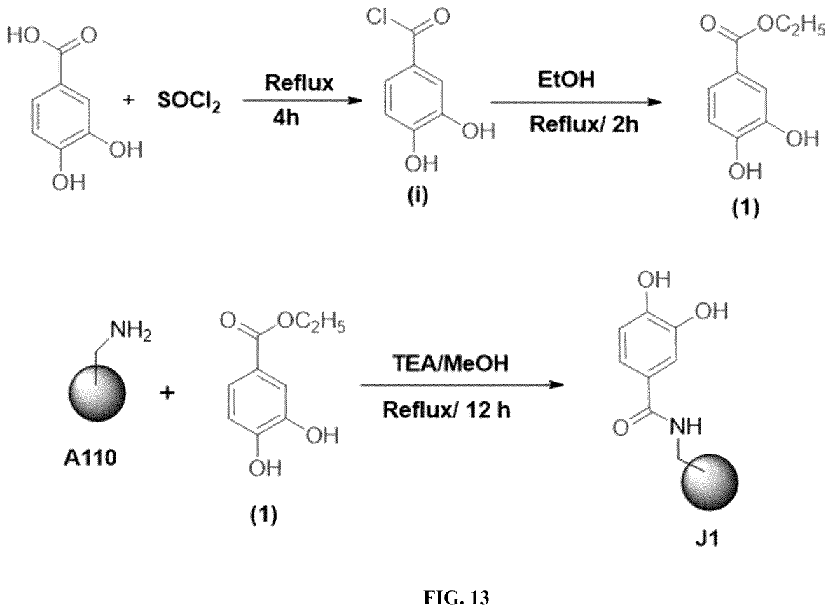

Catechol grafted polymeric resin beads were prepared by two step reactions: 1) conversion of acid to ester; and 2) its reaction with amine-based polymeric bead (FIG. 13; Scheme 1). Before functionalization, the Purolite A110 beads were dehydrated at 60° C. for 48 h (50% moisture content). 1 g of A110 beads (NH₂, 5.49 mmol g⁻¹) was mixed with three equivalent of compound (i, FIG. 13) (2.98 g, 16.4 mmol) in methanol in presence of three equivalent of triethylamine (1.66 g, 16.4 mmol) and reaction were refluxed for 12 h. After 12 h, resin beads were washed 3-4 times with methanol followed by DI water. Catechol grafted polymeric resin beads were dried at 60° C. for 48 h in vacuum. A similar reaction scheme was used for the synthesis of chelating resin beads J2, J3 and J4. The J3 and J4 adsorbents were prepared using A143 resins.

### Characterization

Fourier transform infrared spectra (FTIR) of Catechol-functionalized resin were collected on Bruker vertex-70 using a solid-state diamond assembly. The spectral range was from 4000-500 cm⁻¹ with 4 cm⁻¹ resolution and 400 scans per sample. XPS study was conducted using physical electronics Versa Probe III equipped with a monochromatic Al kα x-ray source (hv=1,486.6 eV) and a concentric hemispherical analyzer. The pH solutions were measured on Mettler Toledo S220 SevenCompact™ Benchtop pH/ISE Meter. The metal concentration of standard samples and after adsorption were measured on AGILENT 7800 ICP-MS instrument. SEM imaging was done on Thermo Fischer Q250 under low vacuum mode. Point zero charge (pH_{pzc}) of resins (A110 and A143 Plus) and their functionalized products (J1-J4) were determined through pH drift method. Briefly, the latter method entails a series of aqueous solutions being prepared (50 mL) with 0.1M NaCl in a conical flask and pH was adjusted from 1-10 with 0.1M NaOH and 0.1M HCl solution. The pH of prepared solutions was measured with pH-meter and marked it as initial pH. Next, 0.2 g of adsorbents were added on prepared solutions and were mixed on end-over-end fashion for 24 h, and the final pH was recorded.

### Adsorption Experiments

To investigate functionalized-resins for adsorption of gallium ions, batch adsorption experiments were conducted in 15 mL polystyrene screw cap test tubes by mixing 10 mg of adsorbent with 10 mL of gallium solution at room temperature and agitated at 30 rpm for 24 h. After 24 h, aliquot of supernatant solution was collected, acidified and analyzed for gallium with ICP-MS. The effect of pH on Ga-adsorption was determined at controlled pH (1-4 and 9-10) at room temperature. The effect of contact time on Ga-adsorption was determined at 0-48 h, by analyzing samples every 2h. To examine the effect of initial concentration of Ga-adsorption, the adsorption isotherm was conducted at pH 3 from 0 to 60 ppm of Ga concentration. The experiments on the effect of temperature on adsorption were carried out at 35° C. and 45° C. using an orbital shaker incubator by fixing the test tube horizontally and shaking it at 100 rpm. The equilibrium adsorption capacity (qₑ) was calculated by equation (13):

$${q}_{e} ( \frac{mg}{g} ) = ( {C}_{o} - {C}_{e} ) * \frac{V}{m} \qquad ( 13 )$$

Cₒ and Cₑ are the initial and equilibrium concentration of Ga in the batch adsorption experiment, V is the total volume of solution (L) and m is the mass of the adsorbent used (g). The Ga selectivity of the adsorption experiment were carried out at pH 3 in the presence of different competing metal ions (20 mg L⁻¹ each) e.g., Ga (III), Zn (II), Cu (II), Al (III), Cd (II), As (III), Sb (V), Mn (II) and Fe (III). Desorption experiments were performed with different concentration of acids such as HCl, HNO₃ and H₂SO₄.

### Result and Discussion

### Functionalization and Characterization of Catechol Grafted Adsorbents (J1-J4)

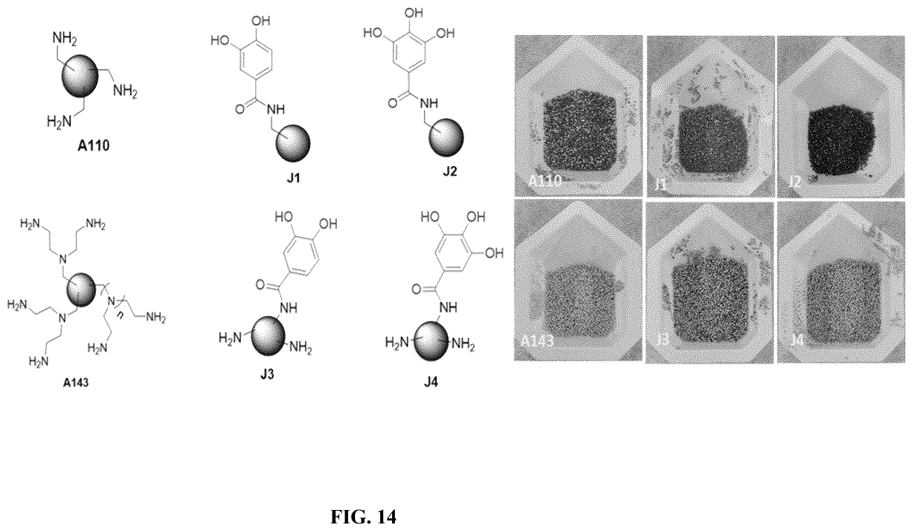

Catechol functionalized resin beads were prepared by nucleophilic addition reaction between benzyl ethyl ester and resin amine. The adsorbents J1-J4 (FIG. 14) were characterized by various spectroscopic (e.g., FTIR and XPS) and microscopic techniques (e.g., SEM imaging). Photographic images showed that the color of A110 and A143 was significantly changed after functionalization with catechol (FIG. 14).

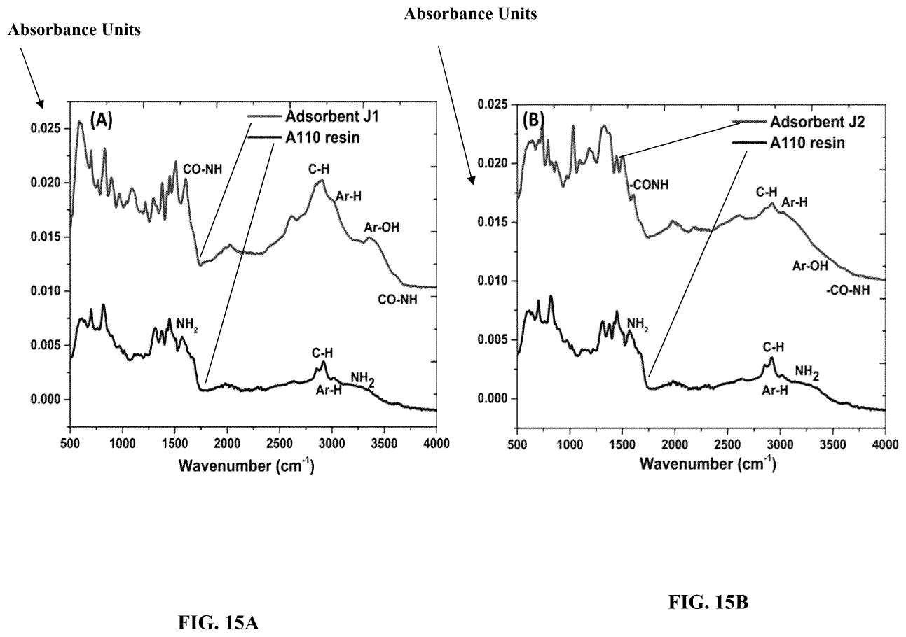

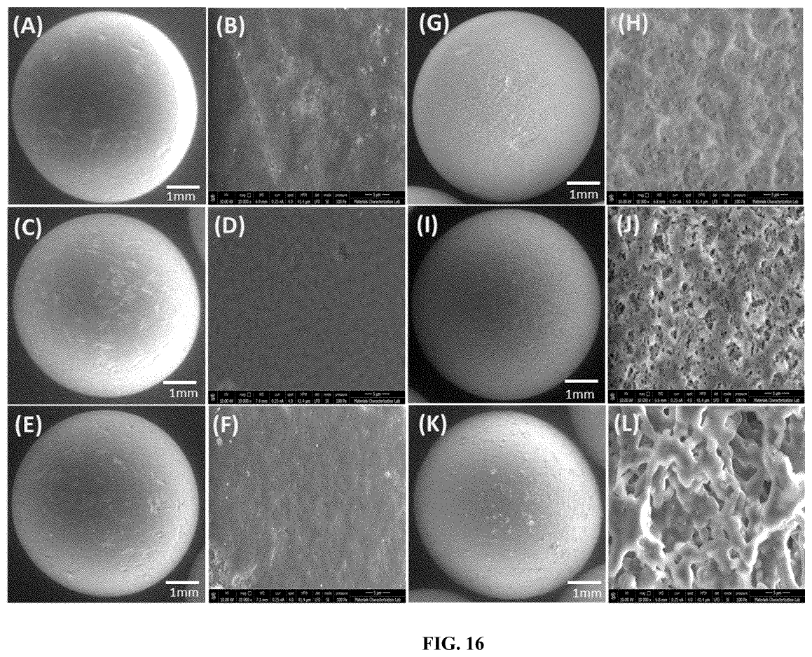

Purolite A110 and A143 Plus resins and their catechol functionalized adsorbents J1-J4 were characterized with FTIR spectroscopy as shown in FIGS. 15A and 15B. FTIR spectra of A110 resin showed characteristic absorption band at 3200-3350 cm⁻¹, and 1570-1600 cm⁻¹ corresponding to NH₂ stretching and bending vibration. The absorption band at 3050 and 2920 cm⁻¹ corresponds to Ar—H stretching vibration of the aromatic ring and the C—H stretching vibration of the benzylic CH₂ group, respectively. Whereas FTIR spectra of catechol functionalized adsorbent J1 and J2 exhibited the disappearance of NH₂ absorption band (1570-1600 and 3200-3350 cm⁻¹) and the appearance of a new characteristic absorption band at 1600-1640 cm⁻¹ corresponding to amide linkage (—CO—NH), confirming the functionalization of J1 and J2, respectively. Further, the broad absorption band at 3250-3500 cm⁻¹ corresponds to the catechol hydroxyl group. The similar amide linkage absorption band (1600-1640 cm⁻¹) and catechol hydroxyl absorption band (3250-3500 cm⁻¹) were present in the FTIR spectra of J3 and J4, which confirms the functionalization of catechol on Purolite A143 Plus resin surface.

The surface texture of Purolite A110 and A143 Plus resin beads were investigated through Scanning electron microscopy in low vacuum mode (FIG. 16). SEM imaging showed that the resin bead is spherical in shape but vary in size, indicating that Purolite beads are polydispersive. Upon functionalization with catechol ligands, the shape of Purolite A110 remained spherical but the surface morphology was greatly changed, e.g., surfaces became rougher and more porous (FIG. 16, images A-F). Similarly, the surface morphology of Purolite 143 Plus resin bead was changed from smooth surface to rough and porous after ligand functionalization (FIG. 16, images G-L). The rough and porous surfaces are important for maintaining a high surface area for adsorption of the metal ions. The surface roughness is more on J3 and J4 adsorbers compared to J1 and J2, probably due to complex nature of amine present, in addition to catechol ligand in their structure.

The elemental composition of resins and their functionalized products were investigated with XPS survey scan mode. A high percentage of organic content (C, N, and O elements) was found in the functionalized products compared to A110 and A143 Plus (C and N elements) resin supports, confirmed the successful grafting of catechol on the resin surface. The C/N ratio increase 19% in J1 and 46% in J2 compared to Purolite A110. Similarly, the C/N ratio increase 11% in J3 and 20% in J4 compared to Purolite A143 Plus resin. Further, the catechol ligand grafting yield was calculated from elemental composition and found to be 25% for J1 (e.g., 1.37 mmol of catechol), 60% for J2 (e.g., 3.30 mmol of catechol), 20% for J3 (e.g., 1.07 mmol of catechol), and 35% for J4 (e.g., 1.86 mmol of catechol). Moreover, the hydroxyl group concentration on the adsorbents surface was measured with the Boehm titration method and found to be 1.50, 3.58, 1.33, and 2.05 mmol g−1 for J1, J2, J3 and J4, respectively, indicating close agreement with XPS elemental analysis.

The zero-point charge (pH_{pzc}) of Purolite A110 and A143 Plus resin and their functionalized adsorbents (J1-J4) was determined through pH-drift method (FIGS. S9A and S9B). The pH_{pzc} for resins A110 and A143 found to be 9.01, indicating that the resin surfaces (—NH₃⁺ group) are positive in acidic medium and negative (—NH group) in alkaline medium. After ligand functionalization, the zero-point charge (pH_{pzc}) for the resin surfaces was shifted from 9.01 to 6.33 and 5.45 for J1 and J2 and 6.52 and 6.34 for J3 and J4. Moreover, the increase in negative surface charge of adsorbents in alkaline medium was due to deprotonation of OH groups in addition to NH₂ groups. This change in (pH_{pzc}) value confirms the functionalization of ligands on the resin surface.

### Optimization Condition of Adsorption

The adsorption experiments were performed with 60 mg L⁻¹ of Ga metal ions. Preliminary investigation indicated that the adsorption capacity of adsorbents increased by changing the adsorbents dosage from 2-10 mg. The maximum Ga-adsorption was found at 10 mg of adsorbent. Therefore, 10 mg of adsorbent was selected for subsequent experiments. By comparing the adsorption performance of all four synthesized catechol functionalized resin beads J1-J4, the adsorption capacities of Ga were studied in acidic medium (e.g., pH 3) (Table 5). Among all adsorbers, J2 has the highest adsorption capacity for Ga ions followed by J1>J4>J3. The reason for such behavior is the high ligand loading on J2, which provides more functional active sites for adsorption of Ga ions. The unfunctionalized resin beads A110 and A143 exhibited low adsorption (5.1 and 3.1 mg g⁻¹) of Ga ions in acidic medium which is attributed to precipitation. The precipitation of Ga occurred due to electrostatic repulsion between positively surface charge of A110 and positively charged gallium (Ga³⁺) ions, however, no precipitation found in the case of functionalized beads in the same acidic medium.

TABLE 5
Ligand functionalization of resins and their maximum
Ga-adsorption capacities at acidic medium.

| | Ligand | Adsorption | Equilibrium |
|---|---|---|---|
| Adsorbent | loading | capacity (mg g − ¹) | pH |
| Commercialized Purolite | — | 5.1 | 3 |
| A110 resin | | | |
| Commercialized Purolite | — | 3.1 | 3 |
| A143 Plus resin | | | |
| J1 | 1.37 mmol | 16.36 | 3 |
| J2 | 3.30 mmol | 28.71 | 3 |
| J3 | 1.07 mmol | 11.07 | 3 |
| J4 | 1.86 mmol | 16.33 | 3 |

### Effect of pH on Adsorption

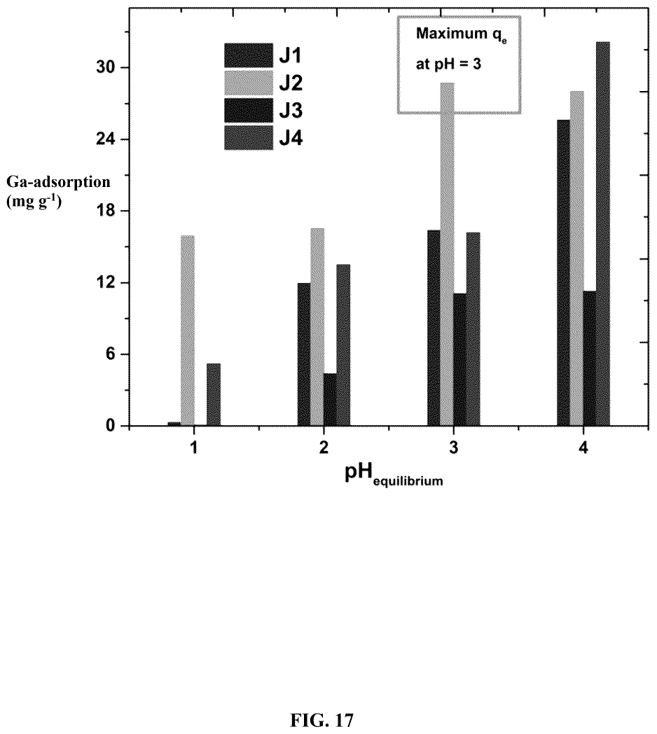

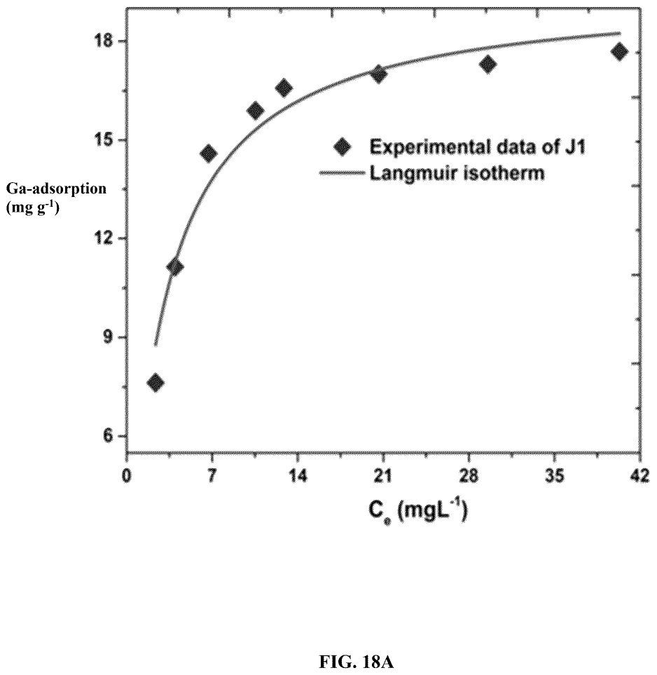

The pH of the solution is an important factor that affects the adsorption behavior of metal ions by changing the activity of the surface groups of the adsorbents as well as chemical forms of metal ion species. To examine the effect of pH on Ga-adsorption, the 10 mg of adsorbent was mixed with 10 mL of Ga solution and pH was controlled by addition of HCl or NaOH in the pH range of 1 to 4 and 10. Typically, the predominant species of gallium at acidic pH (pH<4) are Ga³⁺, Ga(OH)₂⁺ and Ga(OH)₂⁺, while precipitation occurs in pH range of 3 to 9 by formation of Ga(OH)₃, and above pH 9, Ga(OH)₄⁻ and Ga(OH)₅²⁻ are the predominant species. It is observed that the Ga-adsorption capacity of catechol functionalized resin beads increased from pH 1 to 4 (FIG. 17). The maximum Ga-adsorption capacity of adsorbents was found in the range of pH 3-4, which is due to the decreased in competition for proton and metal ions for same surface binding sites. This can also be described using the pH_{PZC} data, which indicating that the surface of the adsorbents becomes less positive at pH 3. Furthermore, the Ga-adsorption was also investigated at pH 10 and results showed that the adsorption capacity was significantly decreased. It can be attributed to the adsorption sites of catechol hydroxyl groups that are negatively charged at basic solution and cause electrostatic repulsion between the hydroxide anions and Ga(OH)₄⁻ as well as Ga(OH)₅²⁻. Thus, to prevent the Ga-precipitation all adsorption experiments were carried out at pH 3.

### Adsorption Isotherm

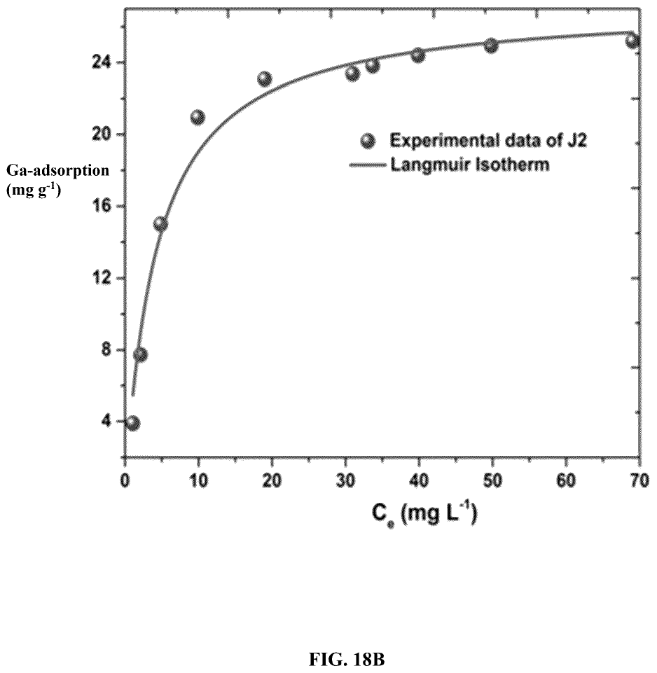

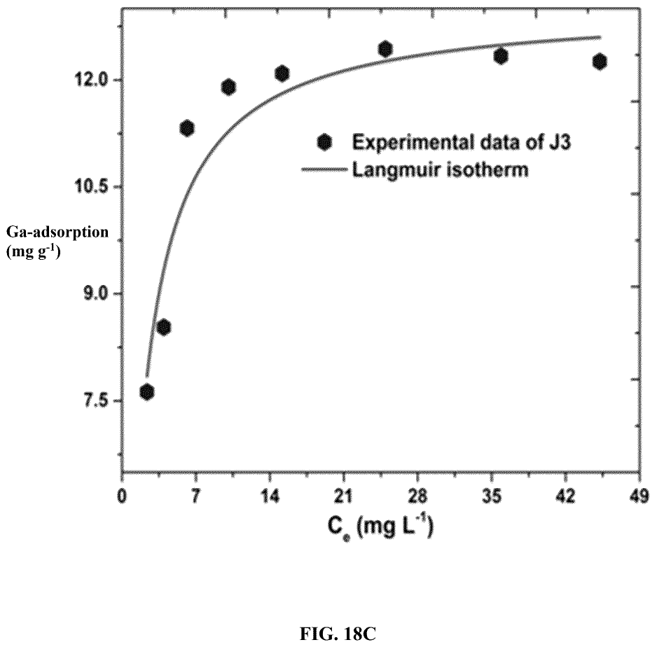

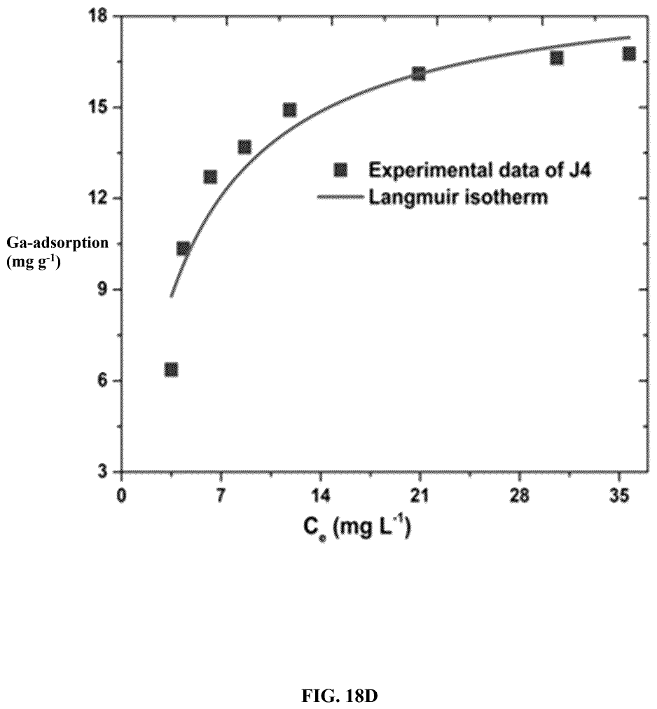

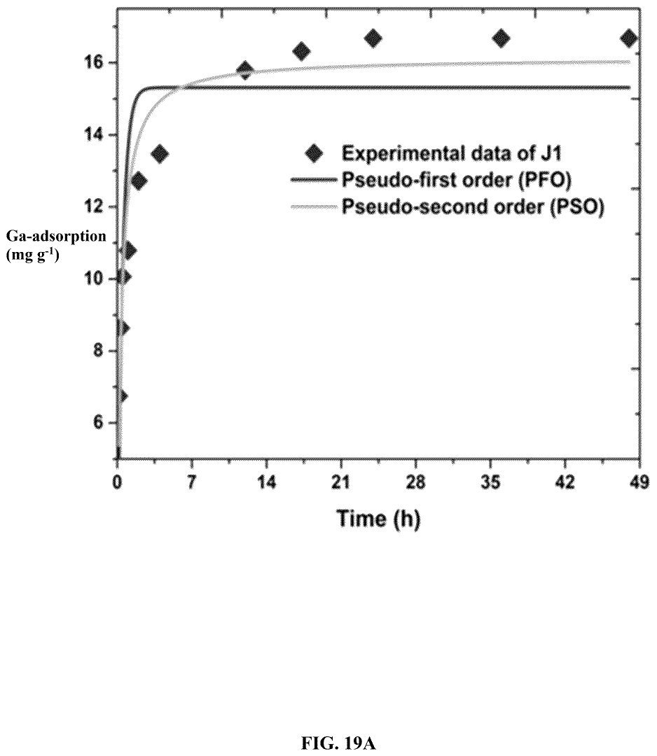

An adsorption isotherm model was used to determine the equilibrium between adsorbate on the solid phase and in the liquid phase. The adsorption isotherm experiments with adsorbents J1-J4 were performed by varying the initial concentration of Ga from 5 mg L⁻¹ to 60 mg L⁻¹ at pH 3. The adsorption of Ga increased with an increase of its concentration till it reached equilibrium (FIGS. 18A, 18B, 18C, 18D). The maximum adsorption capacities of 16.36 mg g⁻¹ (J1), 28.71 mg g⁻¹ (J2), 11.07 mg g⁻¹ (J3), and 16.33 mg g⁻¹ (J4) respectively, obtained by this study which is higher than literature reported studies. The homogeneous or heterogeneous nature of Ga adsorption was determined by applying the Langmuir (eqn 14) and Freundlich isotherm model (eqn 15), on experimental data collected in this study. The Langmuir model describes a monolayer adsorption on homogeneous surfaces with fixed number of adsorption sites, whereas the Freundlich model describes multilayer adsorption on heterogenous surfaces with infinite number of adsorption sites.

$$\frac{{C}_{e}}{{q}_{e}} = \frac{1}{{K}_{L} {Q}_{m}} + \frac{{C}_{e}}{{Q}_{m}} \qquad ( 14 )$$

$$ln {q}_{e} = ln {K}_{f} + \frac{1}{n} + ln Ce \qquad ( 15 )$$

Qₘ (mg g⁻¹) is the Langmuir adsorption capacity, K_{L} (L g⁻¹) the Langmuir isotherm constant, K_{f} (L g⁻¹)^{1/n} the Freundlich isotherm constant, and n the heterogeneity factor.

TABLE 6
Langmuir and Freundlich Isotherm parameters
for Ga-adsorption for adsorbents J1-J4.

| | Experimental | Langmuir Isotherm | | | Freundlich Isotherm | | |
|---|---|---|---|---|---|---|---|
| | Max qₑ | | K_{L} | | K_{f} | | |
| Adsorbent | (mg g⁻¹) | Qₘ | (L g⁻¹) | R² | (L g⁻¹)^{1/n} | n | R² |
| J1 | 16.36 | 19.55 | 0.342 | 0.95 | 0.267 | 0.87 | 0.80 |
| J2 | 28.71 | 27.29 | 0.230 | 0.98 | 0.410 | 0.75 | 0.85 |
| J3 | 11.07 | 13.0 | 0.636 | 0.88 | 0.155 | 0.87 | 0.74 |
| J4 | 16.33 | 19.34 | 0.236 | 0.90 | 0.320 | 0.77 | 0.73 |

The relevant adsorption parameters and correlation coefficients, summarized in Table 6, indicate that Ga adsorption by the adsorbents is better explained by the Langmuir model (R²>0.88) compared to Freundlich model (R²>0.73). The calculated adsorption capacity Qₘ (mg g⁻¹) was closed to experimentally determined adsorption qₑ (mg g⁻¹). The agreement between experimentally determined data and Langmuir isotherm model indicates that Ga adsorption was monolayer adsorption on homogeneous surfaces.

### Adsorption Kinetics

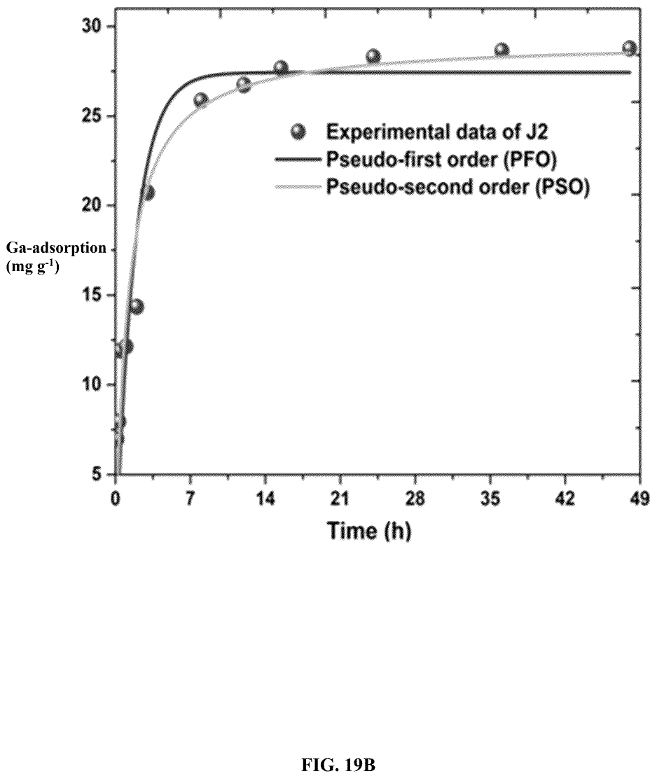

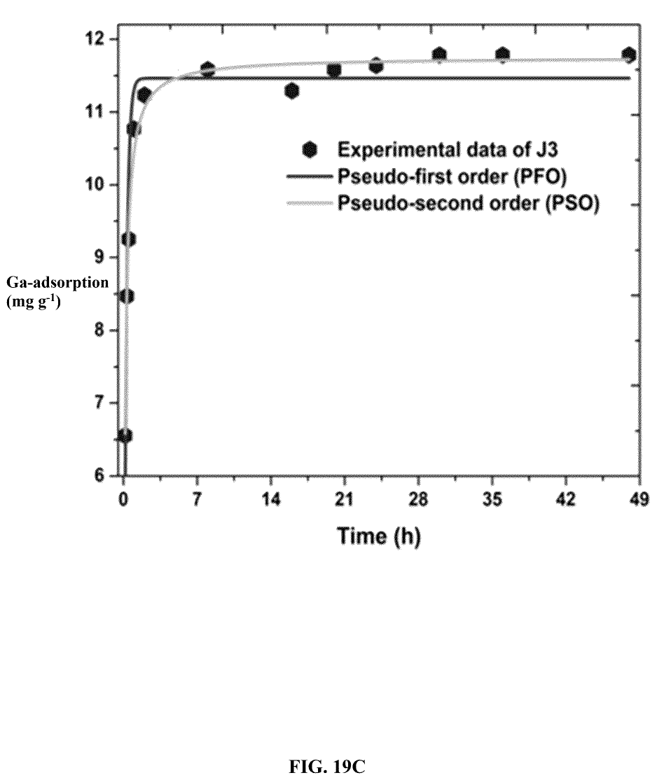

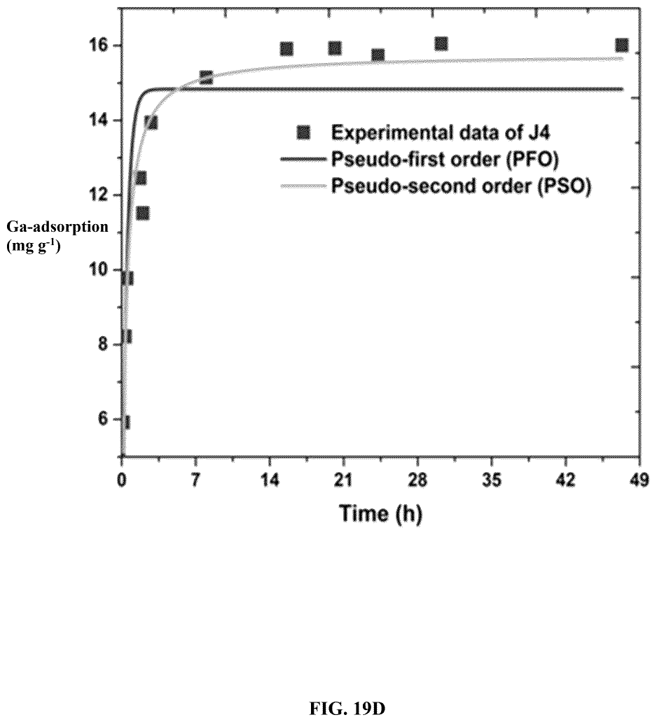

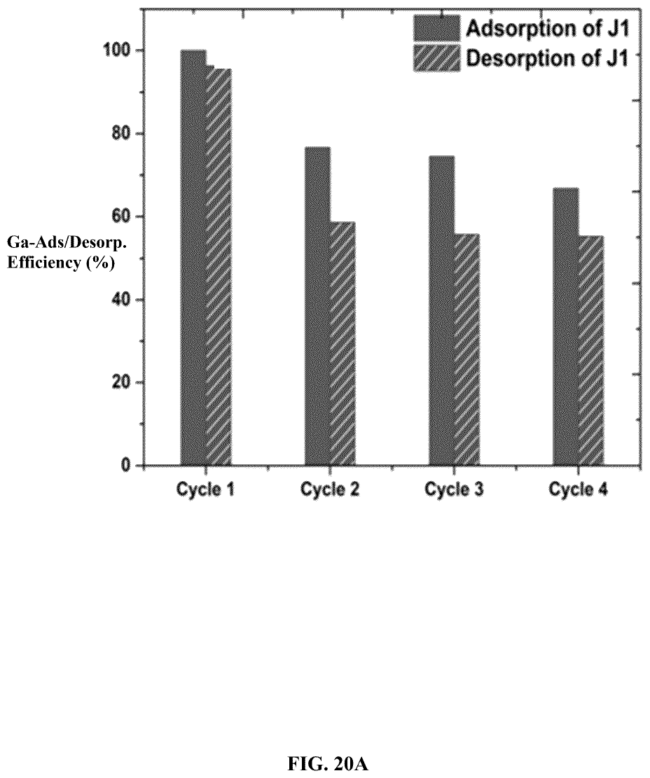

Adsorption kinetics experiments were performed to determine the adsorption rate and equilibrium time (FIGS. 19A, 19B, 19C, 19D). The adsorption increased with increase in contact time until it reached equilibrium at 24 hrs. The steep curve profile at lower time (0-8 hr) indicates that the adsorption rate is fast due to large number of adsorption sites available. The lower adsorption rate at higher time is probably due to saturation of adsorption sites and attainment of equilibrium. The Ga adsorption kinetics were determined by applying pseudo first order (PFO; eqs. 16), pseudo second order (PSO; eqs. 17), and Weber and Morris interparticle diffusion model (eqs. 18) expressed below:

$$\frac{{dq}_{e}}{dt} = {k}_{1} ( {q}_{e} - {q}_{t} ) {⇀}_{⇁} {q}_{t} = {q}_{e} [ 1 - exp ( - {k}_{1} t ) ] \qquad ( 16 )$$

$$\frac{{dq}_{e}}{dt} = {{k}_{2} ( {q}_{e} - {q}_{t} )}^{2} {⇀}_{⇁} {q}_{t} = \frac{{{q}^{2}}_{e} * {k}_{2} t}{( 1 + {q}_{e} * {k}_{2} t )} \qquad ( 17 )$$

$${q}_{t} = {k}_{i} {t}^{0.5} + C \qquad ( 18 )$$

qₜ and qₑ are representing adsorption capacity at time (t) and equilibrium, K¹ (h⁻¹), K² (g mg⁻¹ h⁻¹), and Kᵢ (mg g⁻¹ h^{-0.5}) are rate constants for first order (PFO), pseudo-second order (PSO) and interparticle diffusion, respectively. C (the intercept) is a constant (mg g⁻¹).

TABLE 7
Kinetic parameters of Pseudo-first order, pseudo-second order, and intraparticle
diffusion model for gallium adsorption on adsorbents J1-J4.

| | Pseudo-first order | | | | Pseudo-second order | | | Intraparticle | |
|---|---|---|---|---|---|---|---|---|---|
| | kinetics (PFO) | | | | kinetics (PSO) | | | diffusion | |
| | Exp. | Model | | | Model | | | K_{id}1 | K_{id}2 |
| | qₑ | qₑ | K₁ | | qₑ | K₂ (g | | (mg g⁻¹ | (mg g⁻¹ |
| Adsorbents | (mg g⁻¹) | (mg g⁻¹) | (h⁻¹) | R² | (mg g⁻¹) | mg⁻¹h⁻¹) | R² | h^{-0.5}) | h^{-0.5}) |
| J1 | 16.36 | 15.31 | 2.16 | 0.77 | 16.12 | 0.19 | 0.92 | 2.64 | 0.10 |
| J2 | 28.71 | 27.42 | 0.56 | 0.89 | 29.19 | 0.02 | 0.94 | 6.45 | 0.53 |
| J3 | 11.07 | 11.46 | 4.25 | 0.92 | 11.75 | 0.67 | 0.98 | 1.66 | 0.14 |
| J4 | 16.33 | 14.83 | 2.30 | 0.82 | 15.76 | 0.19 | 0.95 | 3.55 | 0.18 |

The kinetics parameters and correlation coefficient (R²) of Pseudo-first order and Pseudo-second order kinetics model were shown in Table 7. The correlation coefficient (R²>0.92) of Pseudo-second order kinetics model is much higher than the correlation coefficient (R²>0.77) of Pseudo-first order kinetics model. Additionally, the calculated qₑ value of Pseudo-second order model is more in agreement with the experimental qₑ value than first order model. Based on these parameters, it is believed that pseudo-second order model could better explain the Ga-adsorption kinetics by adsorbents, which assumed that the rate limiting step is chemosorption. Consequently, this study indicates that chemical adsorption was the main process for adsorption of gallium by catechol functionalized adsorbents. To examine the effect of intraparticle diffusion on Ga-adsorption the most accepted Weber and Morris model was applied to experimental data. It is found that the Ga-adsorption takes place in two steps: The first linear region represents the film diffusion e.g., diffusion of Ga ions from bulk solution to external surface of adsorbents. The second region represents intraparticle diffusion stage originated due to rough surface and pore present on the adsorbents surface. The film diffusion region is more than intraparticle diffusion in all the adsorbents as represented by larger slope (K_{id}1) (Table 7). Thus, film diffusion affects the Ga-adsorption at initial stage before reaching the external mass transfer equilibrium. The lower value of slope (K_{id}2) (Table 7) in intraparticle diffusion indicate more gradual adsorption process. However, the intercept does not pass through origin which suggest that intraparticle diffusion is not rate limiting step and multiple process control the Ga-adsorption. The intercept (Ci) represents the extent of boundary layer thickness and larger the value of intercept greater is the boundary layer effect. Thus, adsorbent J1 (C_{id}=7.55 mg g⁻¹) and J3 (C_{id}=7.71 mg g⁻¹) have more boundary layer effect than adsorbent J2 (C_{id}=5.11 mg g⁻¹) and J4 (C_{id}=6.46 mg g⁻¹). Based on above parameters, it is assumed that the Ga-adsorption process govern through chemosorption as well as intraparticle diffusion process.

### Thermodynamics of Adsorption

Thermodynamic state function (ΔG^{o}, ΔH^{o}, ΔS^{o}) is important for understanding the nature of adsorption. Thermodynamic parameters were determined by using equations (7-9) and given in Table 8.

$${K}_{d} ( \frac{L}{g} ) = \frac{{q}_{e}}{{C}_{e}} \qquad ( 19 )$$

$$Ln {K}_{d} = \frac{Δ {S}^{0}}{R} - \frac{Δ {H}^{0}}{RT} \qquad ( 20 )$$

$$Δ {G}^{0} = Δ {H}^{0} - T Δ {S}^{0} \qquad ( 21 )$$

K_{d} is thermodynamic equilibrium constant, R is universal gas constant (8.314 J/mol/K), T is temperature (K). ΔG^{o} is standard Gibbs free energy (KJ/mol), ΔH^{o} is standard enthalpy (KJ/mol) and ΔS^{o} is standard entropy (J/mol/K).

TABLE 8
Thermodynamic parameters of Ga-adsorption on adsorbents J1-J4.

| | | ΔG^{o} | ΔH^{o} | ΔS^{o} |
|---|---|---|---|---|
| Adsorbent | T (K) | (KJ/mol) | (KJ/mol) | (J/mol/K) |
| J1 | 298 | −17.61 | 20.52 | 59.19 |
| | 308.15 | −18.22 | | |
| | 318.15 | −18.81 | | |
| J2 | 298 | −17.62 | 19.43 | 59.19 |
| | 308.15 | −18.22 | | |
| | 318.15 | −18.81 | | |
| J3 | 298 | −35.85 | 40.80 | 120.46 |
| | 308.15 | −37.08 | | |
| | 318.15 | −38.28 | | |
| J4 | 298 | −34.30 | 38.56 | 115.25 |
| | 308.15 | −35.47 | | |
| | 318.15 | −36.63 | | |

Ga-adsorption by adsorbents (J1-J4) increase with increased in temperature and follow the order 298K<308.15K<318.15K. The positive enthalpy ΔH^{o} values indicate that the Ga-adsorption is endothermic process whereas, the large negative values of Gibbs free energy suggest that energetically favorable Ga-adsorption process. Also, ΔG^{o} become more negative with increasing higher temperature which suggests that more favorable Ga-adsorption condition. The positive values of Ga-adsorption suggest that adsorption process involves a dissociative mechanism.

### Desorption and Regeneration

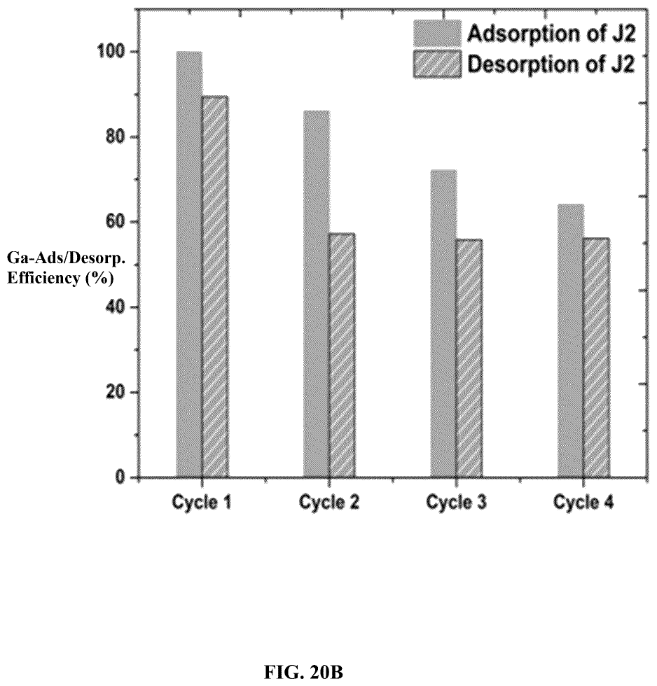

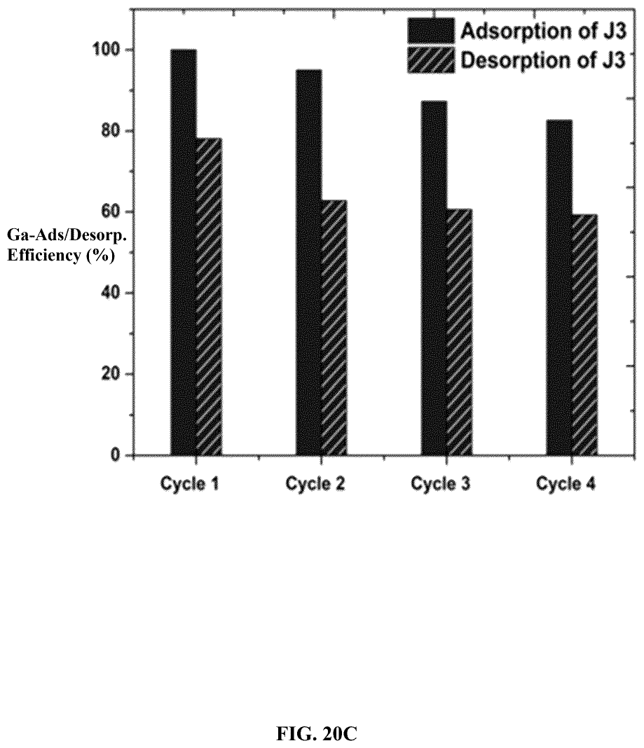

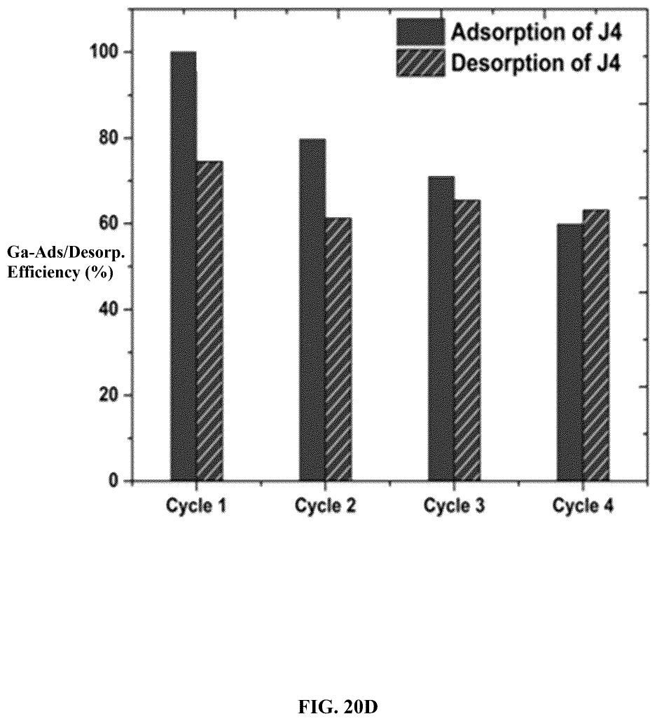

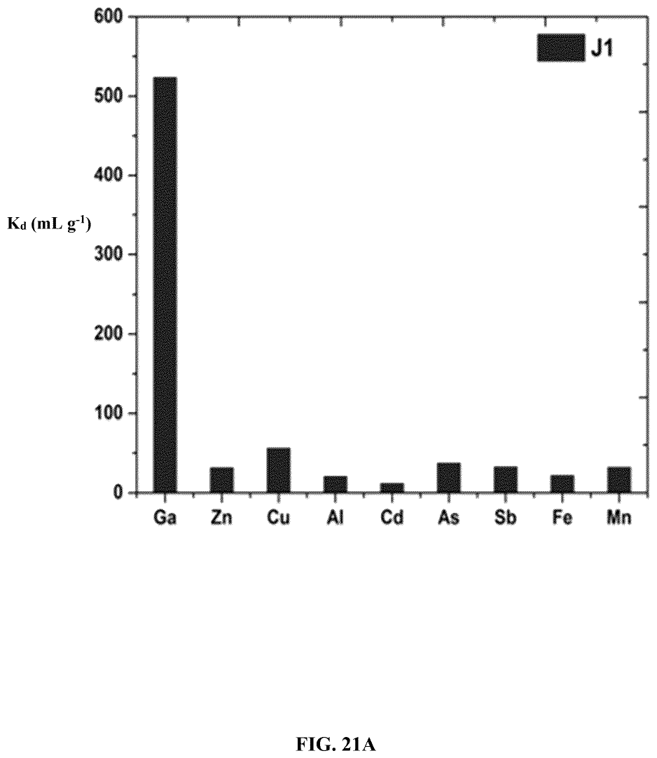

Ga-desorption and regeneration of resin-based adsorbent is important to establishing the commercial and practical feasibility of the extraction process. A well optimized desorption process allows the considerably increasing the concentration of desorbing metal in the eluate which can provides great opportunities for separation of target metal in the mix solution. An acidic solution (1M HCl, 3M HCl, and 5M HCl) was selected for desorption of Ga from adsorbent surface. It is predicted that the acidic proton (H⁺) provides the competition for adsorption sites and displace the equilibrium. The 5M HCl was showed highest Ga-desorption efficiency (>90% for J1 and J2, and >75% for J3 and J4) among different concentration of HCl used. Further, 5M HCl was used for multiple adsorption-desorption cycles. The percentage of Ga-adsorption and desorption efficiency were shown in FIGS. 20A, 20B, 20C, 20D. The Ga-adsorption by all adsorbents showed that the adsorption is linearly decreased with each cycle. In first two desorption cycle, the desorption is linearly decrease and after that it remains constant. This reduction in Ga-adsorption in each cycle is due to successive reduction in adsorption sites in each cycle. The same reason for reduction in Ga-desorption was found for initial two desorption cycle. After 3^{rd} desorption cycle, the regeneration equilibrium was established. It was found that the adsorption efficiency of catechol functionalized resin for Ga reach more than 60% after four adsorption-desorption cycle, indicate that chelating resin has acceptable reusability.

### Selectivity Studies

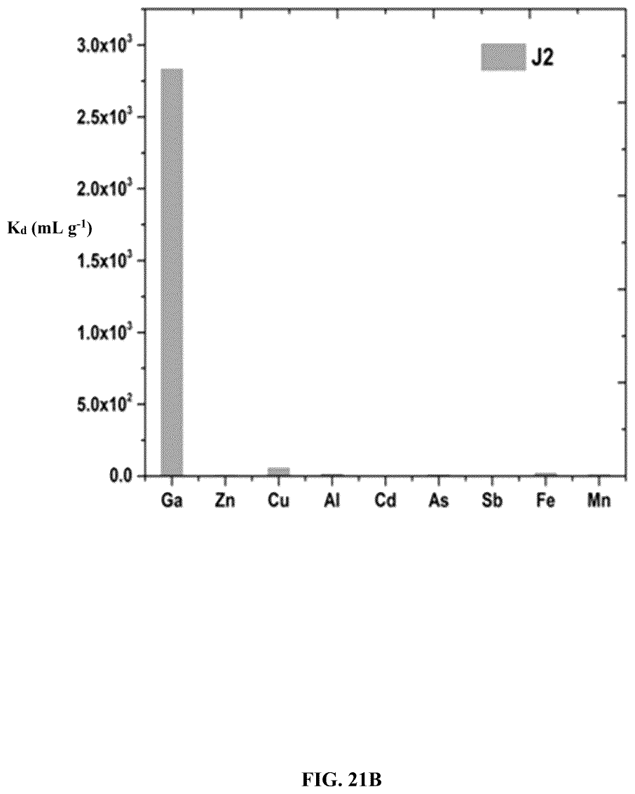

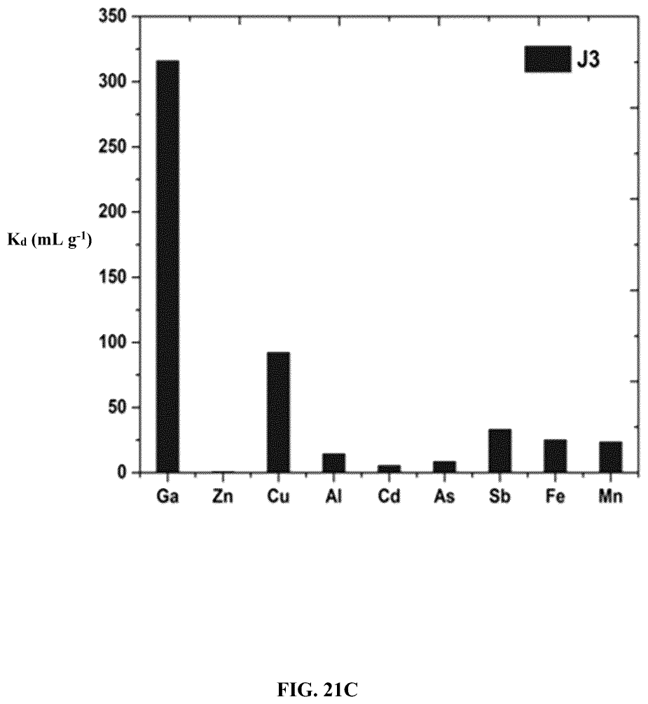

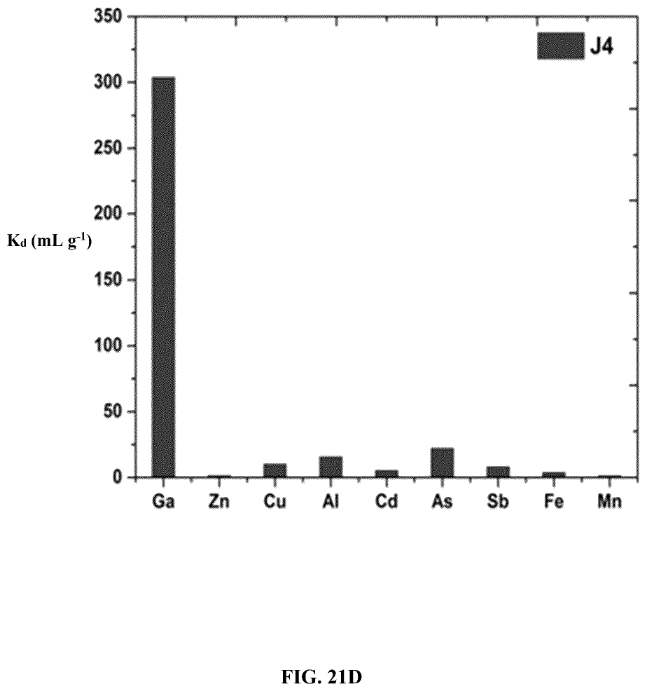

The primary goal of this study was to evaluate the separation and extraction of Ga from waste source such as coal fly ash, zinc refinery and production of Ga/As semiconductor materials. Hence, the adsorption experiment was carried out with the ions found in Zinc refinery residue (e.g., Ga, Zn, Cu, Al, and Fe), Coal fly ash (e.g., Ga, Cu and Fe), Ga/As semiconductor (e.g., Ga, As) and nuclear reactor (Ga, Zn, Ni, Cu). The effect of competitive ions on the Ga-adsorption through catechol functionalized resin were investigated. The selectivity experiments were conducted at pH 3, to avoid the precipitation of the competitive ions. The high selectivity for Ga was observed through all tested adsorbents (FIGS. 21A, 21B, 21C, 21D).

The solid: liquid partition distribution coefficient (K_{d}) is important parameter which determines the adsorption affinity of metal in the solution of the adsorbent. The high value of K_{d} indicates a high metal adsorption by adsorbent through chemical reaction/interactions and low value of K_{d} indicates large amounts of metals remaining in the solution. The highest K_{d} values for Ga was observed through all adsorbents e.g., J1=523.09 mL g⁻¹, J2=2833.03 mL g⁻¹, J3=315.90 mL g⁻¹, J4=303.67 mL g⁻¹ compared to those of (K_{d}<30 mL g⁻¹) Zn, Al, Cd, Sb, Fe, As and Mn. The selectivity factor of adsorbents J1-J4 for Ga against competitive ions was given in Table 8. It is found that the prepared adsorbents were 10 to 4800 times more selective than Zn, Al, Cd, Sb, Fe, As and Mn. Among all tested adsorbents in this study the J2 has highest selectivity for Ga followed by J4>J1>J3. Based on the parameters given in Table 9, it is suggested that the newly prepared adsorbents can be used for the separation and recovery of Ga from zinc refinery residue, coal fly ash and Ga/As waste semiconductor materials.

TABLE 9
Selectivity factors of adsorbents J1-J4 for Ga against competing
ions (higher values indicate that the adsorbent has higher
affinity for Ga against the competing ion).

Selectivity factor (K_{d} Ga/K_{d} Mⁿ⁺) for adsorbents

| Ions | J1 | J2 | J3 | J4 |
|---|---|---|---|---|
| Zn | 16.57 | 641.53 | 468.97 | 229.89 |
| Cu | 9.37 | 50.42 | 3.42 | 30.16 |
| Al | 25.42 | 199.68 | 21.86 | 19.45 |
| Cd | 44.65 | 4781.44 | 57.67 | 57.41 |
| As | 13.99 | 389.32 | 37.04 | 13.73 |
| Sb | 16.06 | 1754.21 | 9.51 | 37.94 |
| Fe | 24.05 | 133.99 | 12.58 | 79.82 |
| Mn | 16.29 | 321.32 | 13.39 | 258.86 |

### Mechanism of Adsorption

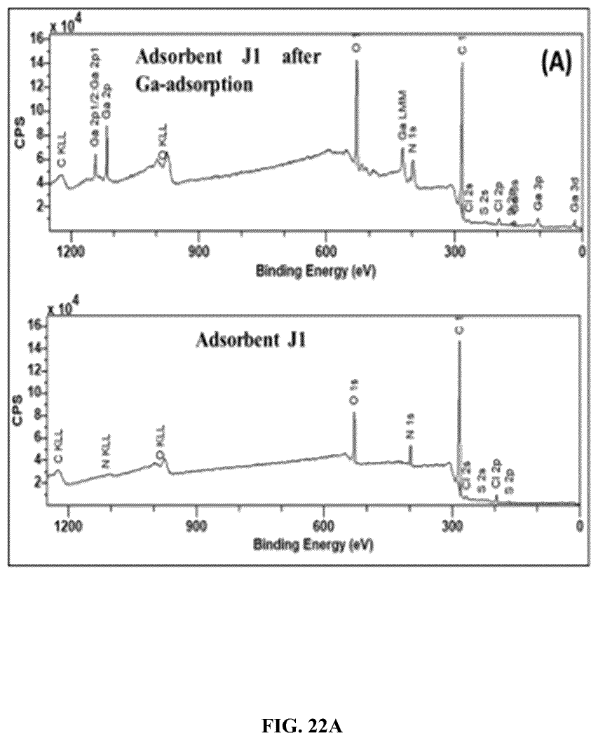

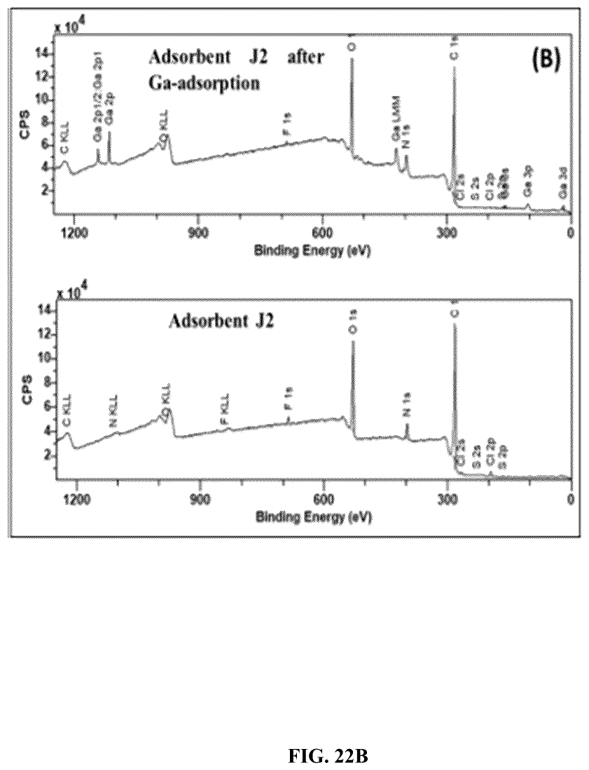

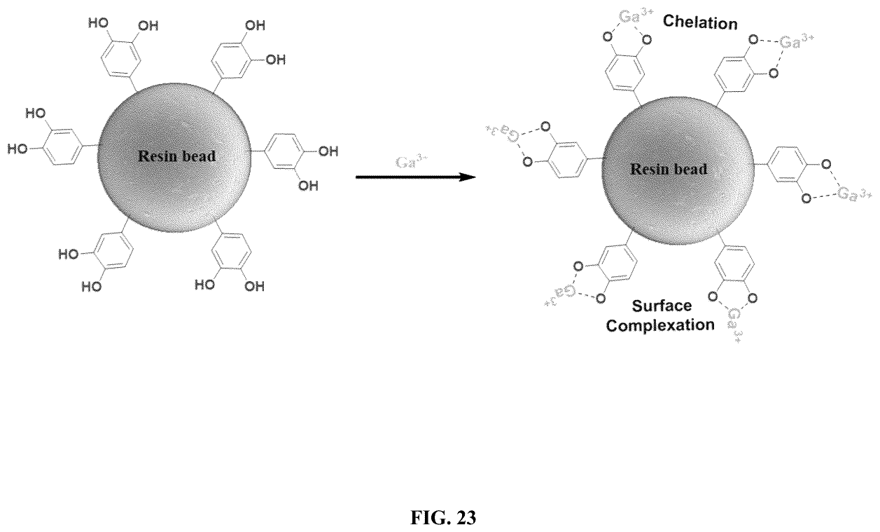

The XPS analysis (full survey scan) were performed to investigate the adsorption mechanism between catechol functionalized adsorbent (J1 and J2) and Ga ions (FIGS. 22A, 22B). The element carbon (C), nitrogen (N) and oxygen (O) was found on the surface of adsorbent J1 and J2. After Ga-adsorption, the new peaks of Ga3d and Ga2p appeared on catechol functionalized adsorbent surface, confirming that the Ga³⁺ ions were successfully adsorbed on adsorbent surface. To further demonstrate the surface functional groups participate in the binding process of gallium ion, the O 1s spectra of adsorbent J1 was curve fitted in two peak components with binding energy (B.E) 531.31 and 532.72 eV, attributed to O—H and C—O surface group respectively. After Ga-adsorption, the O—H peak position shifted from 531.31 to 531.95 eV and C—O peak position shifted from 532.72 to 533.35 eV indicating the hydroxyl group participated in Ga-binding process. A similar change in peak position of adsorbent J2 was observed with gallium ions. These peak shifts clearly demonstrate that the chelation mechanism occurred between gallium and surface hydroxyl group of adsorbents. Further, FTIR spectra of adsorbent (J1 and J2) and after Ga-adsorption were recorded to further confirms the adsorption mechanism. It is observed that the peak position of —OH group of adsorbent J1 is shifted from 3355 cm⁻¹ to 3388 cm⁻¹ after Ga-adsorption. Also, the —OH peak intensity of J1 and J2 decreased after Ga-adsorption, which confirm the participation of —OH in Ga-binding process. Based on these analysis, schematic Ga-adsorption mechanism was shown in FIG. 23.

### Conclusion

Catechol based novel chelating adsorbents were successfully synthesized by grafting of 3,4 dihydroxybenzoic acid, and 3,4,5-trihydroxybenzoic acid on Purolite resin (A110 and A143 Plus) substrate through amide linkage and utilized for selective recovery of gallium in complex metal solution. FTIR and XPS spectroscopy confirms the chemical modification of resin. Ga-adsorption capacity was found of 16.36, 28.71, 11.07, and 16.33 mg g⁻¹ for J1, J2, J3 and J4, respectively at pH 3, which are higher than literature reported and commercialized adsorbents. Adsorption isotherm was better fitted with Langmuir isotherm, indicating that homogeneous sites was presented on adsorbents surface for monolayer Ga-adsorption. Ga-adsorption kinetics was better demonstrated with Pseudo-second order model, suggested that the adsorption mechanism was occurred through chemical reaction between adsorbent and adsorbate. ΔG^{o} is negative for adsorption process, indicated that Ga-adsorption process are spontaneous and increases with increase in temperature. The prepared adsorbents were 10 to 4800 times more selective for Ga than Zn, Al, Cd, Sb, Fe, As and Mn in acidic solution. Ga-desorption study was performed with 5M HCl and the adsorption and desorption properties were well maintained over 4 cycles. The Ga-binding mechanism was studied with experimentally and spectroscopic data, confirmed that the O-dihydroxyl group of catechol formed chelate complex with Ga (III) ions. This study considered that the potential application for these chemically modified chelating resin could be the selective separation of Ga from zinc refinery residue or coal fly ash leachates.

The following references are incorporated herein by reference in their entireties.
1. C. Licht, L. T. Peiró, G. Villalba, Global Substance Flow Analysis of Gallium, Germanium, and Indium: Quantification of Extraction, Uses, and Dissipative Losses within their Anthropogenic Cycles, J. Ind. Ecol. 19 (2015) 890-903.
2. Z. Zhao, X. Li, Y. Chai, Z. Hua, Y. Xiao, Y. Yang, Adsorption Performances and Mechanisms of Amidoxime Resin toward Gallium (III) and Vanadium (V) from Bayer Liquor, ACS Sustain. Chem. Eng. 4 (2016) 53-59.
3. J. Roosen, S. Mullens, K. Binnemans, Chemical immobilization of 8-hydroxyquinoline and 8-hydroxyquinaldine on chitosan-silica adsorbent materials for the selective recovery of gallium from Bayer liquor, Hydrometallurgy. 171 (2017) 275-284.
4. F. Lu, T. Xiao, J. Lin, Z. Ning, Q. Long, L. Xiao, F. Huang, W. Wang, Q. Xiao, X. Lan, Resources and extraction of gallium: A review, Hydrometallurgy. 174 (2017) 105-115.
5. A. Elshkaki, T. E. Graedel, Dynamic analysis of the global metals flows and stocks in electricity generation technologies, J. Clean. Prod. 59 (2013) 260-273.
6. W. Guo, J. Zhang, F. Yang, F. Tan, Z. Zhao, Highly efficient and selective recovery of gallium achieved on an amide-functionalized cellulose, Sep. Purif. Technol. 237 (2020) 116355.
7. S. Raiguel, W. Dehaen, K. Binnemans, Extraction of gallium from simulated Bayer process liquor by Kelex 100 dissolved in ionic liquids, Dalt. Trans. 49 (2020) 3532-3544.
8. Y. Sasaki, T. Oshima, Y. Baba, Mutual separation of indium (III), gallium (III) and zinc (II) with alkylated aminophosphonic acids with different basicities of amine moiety, Sep. Purif. Technol. 173 (2017) 37-43.
9. S. Lu, L. Chen, M. F. Hamza, C. He, X. Wang, Y. Wei, E. Guibal, Amidoxime functionalization of a poly(acrylonitrile)/silica composite for the sorption of Ga (III)—Application to the treatment of Bayer liquor, Chem. Eng. J. 368 (2019) 459-473.
10. B. Xue, B. Wei, L. Ruan, F. Li, Y. Jiang, W. Tian, B. Su, L. Zhou, The influencing factor study on the extraction of gallium from red mud, Hydrometallurgy. 186 (2019) 91-97.
11. T. H. Okabe, Bottlenecks in rare metal supply and the importance of recycling-a Japanese perspective, Miner. Process. Extr. Metall. 126 (2017) 22-32.
12. R. B. K., G. T. E., Challenges in Metal Recycling, Science (80-.). 337 (2012) 690-695.
13. W. J. Rankin, Minerals, metals and sustainability: meeting future material needs, CSIRO publishing, 2011.
14. S. Saikia, A. Sinharoy, P. N. L. Lens, Adsorptive removal of gallium from aqueous solution onto biogenic elemental tellurium nanoparticles, Sep. Purif. Technol. 286 (2022) 120462.
15. J. Meng, C. He, Y. Li, J. Zhou, J. Li, C. Zheng, J. Zhao, T. Fujita, S. Ning, Y. Wei, Enhanced adsorption and separation of gallium using silica-based P507-TBP/SiO2-P adsorbent from sulfuric acid solution, Microporous Mesoporous Mater. 314 (2021) 110859.
16. H. H. Willard, H. C. Fogg, The Precipitation of Basic Gallium Sulfate by Means of Urea. II. The Separation and Determination of Gallium, J. Am. Chem. Soc. 59 (1937) 2422-2424.
17. F. Liu, Z. Liu, Y. Li, B. P. Wilson, Z. Liu, L. Zeng, M. Lundström, Recovery and separation of gallium (III) and germanium (IV) from zinc refinery residues: Part II: Solvent extraction, Hydrometallurgy. 171 (2017) 149-156.
18. X. Zhou, Z. Zhang, S. Kuang, Y. Li, Y. Ma, Y. Li, W. Liao, Recovery of Ga (III) from chloride solutions by solvent extraction with Cextrant 230, Hydrometallurgy. 185 (2019) 76-81.
19. L. Wang, Y. Wang, L. Cui, J. Gao, Y. Guo, F. Cheng, A sustainable approach for advanced removal of iron from CFA sulfuric acid leach liquor by solvent extraction with P507, Sep. Purif. Technol. 251 (2020) 117371.
20. Y.-Y. Shen, S.-W. Wu, C.-H. Hou, Exploring the electrosorption selectivity and recovery of indium ions with capacitive deionization in acidic solution, J. Colloid Interface Sci. 586 (2021) 819-829.
21. K. Zhang, L. Qiu, J. Tao, X. Zhong, Z. Lin, R. Wang, Z. Liu, Recovery of gallium from leach solutions of zinc refinery residues by stepwise solvent extraction with N235 and Cyanex 272, Hydrometallurgy. 205 (2021) 105722.
22. I. Mihaylov, P. A. Distin, Gallium solvent extraction in hydrometallurgy: An overview, Hydrometallurgy. 28 (1992) 13-27.
23. Y. Zhang, X. Liu, Y. Wang, Z. Lou, W. Shan, Y. Xiong, Polyacrylic acid-functionalized graphene oxide for high-performance adsorption of gallium from aqueous solution, J. Colloid Interface Sci. 556 (2019) 102-110.
24. H. Long, Z. Zhao, Y. Chai, X. Li, Z. Hua, Y. Xiao, Y. Yang, Binding Mechanism of the Amidoxime Functional Group on Chelating Resins toward Gallium (III) in Bayer Liquor, Ind. Eng. Chem. Res. 54 (2015) 8025-8030.
25. Z. Zhang, H. Zhang, Y. Hu, X. Yang, S. Yao, Novel surface molecularly imprinted material modified multi-walled carbon nanotubes as solid-phase extraction sorbent for selective extraction gallium ion from fly ash, Talanta. 82 (2010) 304-311.
26. B. N. Segala, D. A. Bertuol, E. H. Tanabe, Production of polyacrylonitrile nanofibres modified with Cyanex 272 for recovery of gallium from solution, Environ. Technol. 43 (2022) 737-750.
27. S. Chegrouche, A. Bensmaili, Removal of Ga (III) from aqueous solution by adsorption on activated bentonite using a factorial design, Water Res. 36 (2002) 2898-2904.
28. E. Díez, J. M. Gómez, A. Rodríguez, I. Bernabé, J. Galán, Recovery of Gallium from Aqueous Solution through Preconcentration by Adsorption/Desorption on Disordered Mesoporous Carbon, J. Sustain. Metall. 7 (2021) 227-242.
29. S. Hokkanen, A. Bhatnagar, M. Sillanpää, A review on modification methods to cellulose-based adsorbents to improve adsorption capacity, Water Res. 91 (2016) 156-173.
30. A. G. Varghese, S. A. Paul, M. S. Latha, Remediation of heavy metals and dyes from wastewater using cellulose-based adsorbents, Environ. Chem. Lett. 17 (2019) 867-877.
31. J. Kaur, P. Sengupta, S. MukhopaAHyay, Critical Review of Bioadsorption on Modified Cellulose and Removal of Divalent Heavy Metals (Cd, Pb, and Cu), Ind. Eng. Chem. Res. 61 (2022) 1921-1954.
32. Y. Liu, K. Ai, L. Lu, Polydopamine and Its Derivative Materials: Synthesis and Promising Applications in Energy, Environmental, and Biomedical Fields, Chem. Rev. 114 (2014) 5057-5115.
33. A. K. L. Yuen, G. A. Hutton, A. F. Masters, T. Maschmeyer, The interplay of catechol ligands with nanoparticulate iron oxides, Dalt. Trans. 41 (2012) 2545-2559.
34. P. Kord Forooshani, B. P. Lee, Recent approaches in designing bioaΔHesive materials inspired by mussel aΔHesive protein, J. Polym. Sci. A. Polym. Chem. 55 (2017) 9-33.
35. A. Evers, R. D. Hancock, A. E. Martell, R. J. Motekaitis, Metal ion recognition in ligands with negatively charged oxygen donor groups. Complexation of iron (III), gallium (III), indium (III), aluminum (III), and other highly charged metal ions, Inorg. Chem. 28 (1989) 2189-2195.
36. D. L. J. Broere, R. Plessius, J. I. van der Vlugt, New avenues for ligand-mediated processes—expanding metal reactivity by the use of redox-active catechol, o-aminophenol and o-phenylenediamine ligands, Chem. Soc. Rev. 44 (2015) 6886-6915.
37. A. Nematollahzadeh, S. Seraj, B. Mirzayi, Catecholamine coated maghemite nanoparticles for the environmental remediation: Hexavalent chromium ions removal, Chem. Eng. J. 277 (2015) 21-29.
38. B. Li, L. Ma, Y. Tian, X. Yang, J. Li, C. Bai, X. Yang, S. Zhang, S. Li, Y. Jin, A catechol-like phenolic ligand-functionalized hydrothermal carbon: One-pot synthesis, characterization and sorption behavior toward uranium, J. Hazard. Mater. 271 (2014) 41-49.
39. M. Patel, A. K. Karamalidis, Germanium: A review of its US demand, uses, resources, chemistry, and separation technologies, Sep. Purif. Technol. 275 (2021) 118981.
40. A. D. Dwivedi, N. D. Sanandiya, J. P. Singh, S. M. Husnain, K. H. Chae, D. S. Hwang, Y.-S. Chang, Tuning and Characterizing Nanocellulose Interface for Enhanced Removal of Dual-Sorbate (AsV and CrVI) from Water Matrices, ACS Sustain. Chem. Eng. 5 (2017) 518-528.
41. W. Cui, S. Wang, J. Peng, L. Zhang, G. Zhang, Catechol-functionalized nanosilica for adsorption of germanium ions from aqueous media, J. Sol-Gel Sci. Technol. 77 (2016) 666-674.
42. J. Du, M. Zhang, Z. Dong, X. Yang, L. Zhao, Facile fabrication of tannic acid functionalized microcrystalline cellulose for selective recovery of Ga (III) and In (III) from potential leaching solution, Sep. Purif. Technol. 286 (2022) 120442.
43. Y. Xiong, X. Cui, M. Zhang, Y. Wang, Z. Lou, W. Shan, Microwave hydrothermal synthesis of gallotannin/carbon nanotube composites for the recovery of gallium ion, Appl. Surf. Sci. 510 (2020) 145414.
44. Y. Xiong, X. Cui, D. Wang, Y. Wang, Z. Lou, W. Shan, Y. Fan, Diethanolamine functionalized rice husk for highly efficient recovery of gallium (III) from solution and a mechanism study, Mater. Sci. Eng. C. 99 (2019) 1115-1122. Y. Wang, L. Zhu, Y. Song, Z. Lou, W. Shan, Y. Xiong, Novel chitosan-based ions imprinted bio-adsorbent for enhanced adsorption of gallium (III) in acidic solution, J. Mol. Liq. 320 (2020) 114413.
45. H. Xiang, F. Zhao, T. Wu, X. Zhang, F. Chai, Q. Wang, E. Repo, X. Min, Z. Lin, Unraveling the steric hindrance roles of the phenolic hydroxyl position on the selective Ge (IV) recovery from zinc residue leachate, Sep. Purif. Technol. 311 (2023) 123338.
46. J. Schönherr, J. R. Buchheim, P. Scholz, P. Adelhelm, Boehm titration revisited (part i): Practical aspects for achieving a high precision in quantifying oxygen-containing surface groups on carbon materials, C. 4 (2018) 21.
47. N. Atykyan, V. Revin, V. Shutova, Raman and FT-IR Spectroscopy investigation the cellulose structural differences from bacteria Gluconacetobacter sucrofermentans during the different regimes of cultivation on a molasses media, AMB Express. 10 (2020) 1-11.
48. V. Ribitsch, K. Stana-Kleinschek, T. Kreze, S. Strnad, The significance of surface charge and structure on the accessibility of cellulose fibres, Macromol. Mater. Eng. 286 (2001) 648-654.
49. T. Ristić, S. Hribernik, L. Fras-Zemljič, Electrokinetic properties of fibres functionalised by chitosan and chitosan nanoparticles, Cellulose. 22 (2015) 3811-3823.
50. L. A. Pothan, C. Bellman, L. Kailas, S. Thomas, Influence of chemical treatments on the electrokinetic properties of cellulose fibres, J. AΔHes. Sci. Technol. 16 (2002) 157-178.
51. K. Stana-Kleinschek, V. Ribitsch, Electrokinetic properties of processed cellulose fibers, Colloids Surfaces A Physicochem. Eng. Asp. 140 (1998) 127-138.
52. Z. Yu, X. Gao, Y. Yao, X. Zhang, G.-Q. Bian, W. D. Wu, X. D. Chen, W. Li, C. Selomulya, Z. Wu, Scalable synthesis of wrinkled mesoporous titania microspheres with uniform large micron sizes for efficient removal of Cr (VI), J. Mater. Chem. A. 6 (2018) 3954-3966.
53. S. A. Wood, I. M. Samson, The aqueous geochemistry of gallium, germanium, indium and scandium, Ore Geol. Rev. 28 (2006) 57-102.
54. H. V. T. Luong, J. C. Liu, Flotation separation of gallium from aqueous solution-Effects of chemical speciation and solubility, Sep. Purif. Technol. 132 (2014) 115-119.
55. T.-N. Kwon, C. Jeon, Selective adsorption for indium (III) from industrial wastewater using chemically modified sawdust, Korean J. Chem. Eng. 29 (2012) 1730-1734.
56. R.-S. Juang, H.-J. Shao, A simplified equilibrium model for sorption of heavy metal ions from aqueous solutions on chitosan, Water Res. 36 (2002) 2999-3008.
57. Y. Zhang, L. Zhu, Y. Wang, Z. Lou, W. Shan, Y. Xiong, Y. Fan, Preparation of a biomass adsorbent for gallium (III) based on corn stalk modified by iminodiacetic acid, J. Taiwan Inst. Chem. Eng. 91 (2018) 291-298.
58. F.-C. Wu, R.-L. Tseng, R.-S. Juang, Initial behavior of intraparticle diffusion model used in the description of adsorption kinetics, Chem. Eng. J. 153 (2009) 1-8.
59. M. Manjuladevi, R. Anitha, S. Manonmani, Kinetic study on adsorption of Cr (VI), Ni (II), Cd (II) and Pb (II) ions from aqueous solutions using activated carbon prepared from Cucumis melo peel, Appl. Water Sci. 8 (2018) 36.
60. F. Liu, S. Wang, B. Hu, Electrostatic self-assembly of nanoscale FeS onto MXenes with enhanced reductive immobilization capability for U (VI) and Cr (VI), Chem. Eng. J. 456 (2023) 141100.
61. F. Liu, Y. Lou, F. Xia, B. Hu, Immobilizing nZVI particles on MBenes to enhance the removal of U (VI) and Cr (VI) by adsorption-reduction synergistic effect, Chem. Eng. J. 454 (2023) 140318.
62. J. C. Callura, K. M. Perkins, J. P. Baltrus, N. R. Washburn, D. A. Dzombak, A. K. Karamalidis, Adsorption kinetics, thermodynamics, and isotherm studies for functionalized lanthanide-chelating resins, J. Colloid Interface Sci. 557 (2019) 465-477.
63. Y. R. Smith, D. Bhattacharyya, T. Willhard, M. Misra, Adsorption of aqueous rare earth elements using carbon black derived from recycled tires, Chem. Eng. J. 296 (2016) 102-111.
64. M. Patel, A. K. Karamalidis, Catechol-Functionalized Chitosan Synthesis and Selective Extraction of Germanium (IV) from Acidic Solutions, Ind. Eng. Chem. Res. (2023).
65. J. C. Callura, K. M. Perkins, C. W. Noack, N. R. Washburn, D. A. Dzombak, A. K. Karamalidis, Selective adsorption of rare earth elements onto functionalized silica particles, Green Chem. 20 (2018) 1515-1526.
66. S. Lata, P. K. Singh, S. R. Samadder, Regeneration of adsorbents and recovery of heavy metals: a review, Int. J. Environ. Sci. Technol. 12 (2015) 1461-1478.
67. A. Chatterjee, J. Abraham, Desorption of heavy metals from metal loaded sorbents and e-wastes: A review, Biotechnol. Lett. 41 (2019) 319-333.
68. P. Yang, Q. Liu, J. Liu, R. Chen, R. Li, X. Bai, J. Wang, Highly efficient immobilization of uranium (VI) from aqueous solution by phosphonate-functionalized dendritic fibrous nanosilica (DFNS), J. Hazard. Mater. 363 (2019) 248-257.
69. Z. Wei, K. Liang, Y. Wu, Y. Zou, J. Zuo, D.C. Arriagada, Z. Pan, G. Hu, The effect of pH on the adsorption of arsenic (III) and arsenic (V) at the TiO2 anatase [101] surface, J. Colloid Interface Sci. 462 (2016) 252-259.
70. S. C. Gondhalekar, S. R. Shukla, Recovery of Ga (III) by Raw and Alkali Treated Citrus limetta Peels, Int. Sch. Res. Not. 2014 (2014).
71. C. J. Macdonald, The complexation reaction of gallium (III) with 4-nitrocatechol: evidence for a dissociative-interchange mechanism on (H2O)5Ga(OH)2+, Inorganica Chim. Acta. 311 (2000) 33-39.
72. P. Mohanty, A. C. Dash, Kinetics and mechanism of the complex formation between oxalatopentaamminecobalt (III) and aluminium (III) and gallium (III); a comparative study, Transit. Met. Chem. 20 (1995) 153-156.
73. S. Fang, T. Tao, H. Cao, X. Zheng, Y. Hu, Y. Zhang, Z. Sun, Selective Recovery of Gallium (Indium) from Metal Organic Chemical Vapor Deposition Dust—A Sustainable Process, ACS Sustain. Chem. Eng. 7 (2019) 9646-9654.
74. C. Licht, L. T. Peiró, G. Villalba, Global Substance Flow Analysis of Gallium, Germanium, and Indium: Quantification of Extraction, Uses, and Dissipative Losses within their Anthropogenic Cycles, J. Ind. Ecol. 19 (2015) 890-903. https://doi.org/https://doi.org/10.1111/jiec.12287.
75. T. Kinoshita, Y. Ishigaki, N. Shibata, K. Yamaguchi, S. Akita, S. Kitagawa, H. Kondou, S. Nii, Selective recovery of gallium with continuous counter-current foam separation and its application to leaching solution of zinc refinery residues, Sep. Purif. Technol. 78 (2011) 181-188.
76. D. Hu, B. Ma, X. Li, Y. Lv, W. Zhang, Y. Chen, C. Wang, Efficient separation and recovery of gallium and indium in spent CIGS materials, Sep. Purif. Technol. 282 (2022) 120087.
77. B. Gupta, N. Mudhar, Z. Begum, I. Singh, Extraction and recovery of Ga (III) from waste material using Cyanex 923, Hydrometallurgy. 87 (2007) 18-26.
78. E. Alonso, A. M. Sherman, T. J. Wallington, M. P. Everson, F. R. Field, R. Roth, R. E. Kirchain, Evaluating rare earth element availability: A case with revolutionary demand from clean technologies, Environ. Sci. Technol. 46 (2012) 3406-3414.
79. W.-S. Chen, L.-L. Hsu, L.-P. Wang, Recycling the GaN waste from LED industry by pressurized leaching method, Metals (Basel). 8 (2018) 861.
80. Y. Zhang, L. Zhan, B. Xie, Z. Xu, C. Chen, Decomposition of packaging materials and recycling GaAs from waste ICs by hydrothermal treatment, ACS Sustain. Chem. Eng. 7 (2019) 14111-14118.
81. X. Wu, M. Yuan, X. Guo, L. Zhang, Fast coadsorption and selective separation of gallium (III) and germanium (IV) from aqueous solutions by 3D hierarchical porous hoya-like α-FeOOH, ACS Sustain. Chem. Eng. 7 (2019) 15939-15947.
82. M. Chen, T. E. Graedel, The potential for mining trace elements from phosphate rock, J. Clean. Prod. 91 (2015) 337-346.
83. Z. Zhao, Y. Yang, Y. Xiao, Y. Fan, Recovery of gallium from Bayer liquor: A review, Hydrometallurgy. 125-126 (2012) 115-124. https://doi.org/https://doi.org/10.1016/j.hydromet.2012.06.002.
84. H. Long, Z. Zhao, Y. Chai, X. Li, Z. Hua, Y. Xiao, Y. Yang, Binding Mechanism of the Amidoxime Functional Group on Chelating Resins toward Gallium (III) in Bayer Liquor, Ind. Eng. Chem. Res. 54 (2015) 8025-8030. https://doi.org/10.1021/acs.iecr.5b01835.
85. S. Virolainen, Hydrometallurgical recovery of valuable metals from secondary raw materials, (2013).
86. Z. Zhao, X. Li, Y. Chai, Z. Hua, Y. Xiao, Y. Yang, Adsorption Performances and Mechanisms of Amidoxime Resin toward Gallium (III) and Vanadium (V) from Bayer Liquor, ACS Sustain. Chem. Eng. 4 (2016) 53-59. https://doi.org/10.1021/acssuschemeng.5b00307.
87. M. Y. Yang, J. Cai, Study of the chelated resin in the gallium recovery processby the ion exchange method [J], Light Met. 35 (2007) 14-16.
88. S. Lu, L. Chen, M. F. Hamza, C. He, X. Wang, Y. Wei, E. Guibal, Amidoxime functionalization of a poly(acrylonitrile)/silica composite for the sorption of Ga (III)-Application to the treatment of Bayer liquor, Chem. Eng. J. 368 (2019) 459-473.
89. K. Kondo, Y. Yamamoto, M. Matsumoto, Separation of indium (III) and gallium (III) by a supported liquid membrane containing diisostearylphosphoric acid as a carrier, J. Memb. Sci. 137 (1997) 9-15.
90. T. N. de Castro Dantas, M. H. de Lucena Neto, A. A. D. Neto, Gallium extraction by microemulsions, Talanta. 56 (2002) 1089-1097.
91. B. Pesic, T. Zhou, Recovering gallium with Kelex 100, Jom. 40 (1988) 24-26.
92. G. V. K. Puvvada, Liquid-liquid extraction of gallium from Bayer process liquor using Kelex 100 in the presence of surfactants, Hydrometallurgy. 52 (1999) 9-19. https://doi.org/https://doi.org/10.1016/S0304-386X(98)00086-3.
93. J. M. Loureiro, A. E. Rodrigues, Sorption of metals by an amidoxime chelating resin. Part I: Equilibrium, Sep. Sci. Technol. 33 (1998) 1585-1604.
94. P. A. Riveros, Recovery of gallium from Bayer liquors with an amidoxime resin, Hydrometallurgy. 25 (1990) 1-18.
95. J. Roosen, S. Mullens, K. Binnemans, Chemical immobilization of 8-hydroxyquinoline and 8-hydroxyquinaldine on chitosan-silica adsorbent materials for the selective recovery of gallium from Bayer liquor, Hydrometallurgy. 171 (2017) 275-284. https://doi.org/https://doi.org/10.1016/j.hydromet.2017.05.026.
96. J.-M. Lamerant, Process for extracting gallium from bayer liquors using an impregnated adsorbent resin, (1995).
97. A. Brewer, J. Florek, F. Kleitz, A perspective on developing solid-phase extraction technologies for industrial-scale critical materials recovery, Green Chem. 24 (2022) 2752-2765.
98. G. S. Shyam Sunder, S. AAHikari, A. Rohanifar, A. Poudel, J. R. Kirchhoff, Evolution of environmentally friendly strategies for metal extraction, Separations. 7 (2020) 4.
99. X. Zhang, Z. Liu, D. Qu, Proof-of-Concept study of ion-exchange method for the recycling of LiFePO4 cathode, Waste Manag. 157 (2023) 1-7. https://doi.org/https://doi.org/10.1016/j.wasman.2022.12.003.
100. D. Kołodyńska, D. Fila, Z. Hubicki, Evaluation of possible use of the macroporous ion exchanger in the adsorption process of rare earth elements and heavy metal ions from spent batteries solutions, Chem. Eng. Process. Intensif. 147 (2020) 107767.
101. L. Tofan, R. Wenkert, Chelating polymers with valuable sorption potential for development of precious metal recycling technologies, 38 (2022) 167-183. https://doi.org/doi:10.1515/revce-2019-0075.
102. S. D. Alexandratos, From ion exchange resins to polymer-supported reagents: an evolution of critical variables, J. Chem. Technol. Biotechnol. 93 (2018) 20-27.
103. R. A. Silva, K. Hawboldt, Y. Zhang, Application of resins with functional groups in the separation of metal ions/species-a review, Miner. Process. Extr. Metall. Rev. 39 (2018) 395-413.
104. C. Teodosiu, R. Wenkert, L. Tofan, C. Paduraru, Advances in preconcentration/removal of environmentally relevant heavy metal ions from water and wastewater by sorbents based on polyurethane foam, Rev. Chem. Eng. 30 (2014) 403-420.
105. Y. Wang, X. Ma, Y. Li, X. Li, L. Yang, L. Ji, Y. He, Preparation of a novel chelating resin containing amidoxime guanidine group and its recovery properties for silver ions in aqueous solution, Chem. Eng. J. 209 (2012) 394-400.
106. Y. Kataoka, M. Matsuda, H. Yoshitake, Y. Hirose, Method for recovery of gallium, (1984).
107. A. Xie, J. Dai, X. Chen, J. He, Z. Chang, Y. Yan, C. Li, Hierarchical porous carbon materials derived from a waste paper towel with ultrafast and ultrahigh performance for adsorption of tetracycline, RSC Adv. 6 (2016) 72985-72998.
108. Z. Zhao, Y. Baba, W. Yoshida, F. Kubota, M. Goto, Development of novel adsorbent bearing aminocarbonylmethylglycine and its application to scandium separation, J. Chem. Technol. Biotechnol. 91 (2016) 2779-2784.
109. J. Liu, H.-T. Wu, J. Lu, X. Wen, J. Kan, C. Jin, Preparation and characterization of novel phenolic acid (hydroxybenzoic and hydroxycinnamic acid derivatives) grafted chitosan microspheres with enhanced adsorption properties for Fe (II), Chem. Eng. J. 262 (2015) 803-812.
110. S. M. Abegunde, K. S. Idowu, O. M. Adejuwon, T. Adeyemi-Adejolu, A review on the influence of chemical modification on the performance of adsorbents, Resour. Environ. Sustain. 1 (2020) 100001. https://doi.org/https://doi.org/10.1016/j.resenv.2020.100001.
111. J. Schönherr, J. R. Buchheim, P. Scholz, P. Adelhelm, Boehm titration revisited (part i): Practical aspects for achieving a high precision in quantifying oxygen-containing surface groups on carbon materials, C. 4 (2018) 21
112. Y. Zhang, L. Zhu, Y. Wang, Z. Lou, W. Shan, Y. Xiong, Y. Fan, Preparation of a biomass adsorbent for gallium (III) based on corn stalk modified by iminodiacetic acid, J. Taiwan Inst. Chem. Eng. 91 (2018) 291-298.
113. P. Benézeth, I. I. Diakonov, G. S. Pokrovski, J.-L. Dandurand, J. Schott, I. L. Khodakovsky, Gallium speciation in aqueous solution. Experimental study and modelling: Part 2. Solubility of α-GaOOH in acidic solutions from 150 to 250° C. and hydrolysis constants of gallium (III) to 300° C., Geochim. Cosmochim. Acta. 61 (1997) 1345-1357.
114. S. A. Wood, I. M. Samson, The aqueous geochemistry of gallium, germanium, indium and scandium, Ore Geol. Rev. 28 (2006) 57-102.
115. H. V. T. Luong, J. C. Liu, Flotation separation of gallium from aqueous solution-Effects of chemical speciation and solubility, Sep. Purif. Technol. 132 (2014) 115-119. https://doi.org/https://doi.org/10.1016/j.seppur.2014.04.054.
116. T.-N. Kwon, C. Jeon, Selective adsorption for indium (III) from industrial wastewater using chemically modified sawdust, Korean J. Chem. Eng. 29 (2012) 1730-1734. https://doi.org/10.1007/s11814-012-0069-1
117. R.-S. Juang, H.-J. Shao, A simplified equilibrium model for sorption of heavy metal ions from aqueous solutions on chitosan, Water Res. 36 (2002) 2999-3008. https://doi.org/https://doi.org/10.1016/S0043-1354(01)00537-1.
118. Y. Wang, L. Zhu, Y. Song, Z. Lou, W. Shan, Y. Xiong, Novel chitosan-based ions imprinted bio-adsorbent for enhanced adsorption of gallium (III) in acidic solution, J. Mol. Liq. 320 (2020) 114413.
119. J. B. Neris, F. H. M. Luzardo, E. G. P. da Silva, F. G. Velasco, Evaluation of adsorption processes of metal ions in multi-element aqueous systems by lignocellulosic adsorbents applying different isotherms: A critical review, Chem. Eng. J. 357 (2019) 404-420. https://doi.org/https://doi.org/10.1016/j.cej.2018.09.125.
120. Y. R. Smith, D. Bhattacharyya, T. Willhard, M. Misra, Adsorption of aqueous rare earth elements using carbon black derived from recycled tires, Chem. Eng. J. 296 (2016) 102-111. https://doi.org/https://doi org/10.1016/j.cej.2016.03.082.
121. M. Patel, A. K. Karamalidis, Catechol-Functionalized Chitosan Synthesis and Selective Extraction of Germanium (IV) from Acidic Solutions, Ind. Eng. Chem. Res. (2023). https://doi.org/10.1021/acs.iecr.2c03720.
122. L. Chen, B. Bai, Equilibrium, kinetic, thermodynamic, and in situ regeneration studies about methylene blue adsorption by the raspberry-like TiO2@ yeast microspheres, Ind. Eng. Chem. Res. 52 (2013) 15568-15577.
123. J. Fu, Z. Chen, M. Wang, S. Liu, J. Zhang, J. Zhang, R. Han, Q. Xu, Adsorption of methylene blue by a high-efficiency adsorbent (polydopamine microspheres): kinetics, isotherm, thermodynamics and mechanism analysis, Chem. Eng. J. 259 (2015) 53-61.
124. J. C. Callura, K. M. Perkins, C. W. Noack, N. R. Washburn, D. A. Dzombak, A. K. Karamalidis, Selective adsorption of rare earth elements onto functionalized silica particles, Green Chem. 20 (2018) 1515-1526.
125. S. Lata, P. K. Singh, S. R. Samadder, Regeneration of adsorbents and recovery of heavy metals: a review, Int. J. Environ. Sci. Technol. 12 (2015) 1461-1478. https://doi.org/10.1007/s13762-014-0714-9
126. A. Chatterjee, J. Abraham, Desorption of heavy metals from metal loaded sorbents and e-wastes: A review, Biotechnol. Lett. 41 (2019) 319-333. https://doi.org/10.1007/s10529-019-02650-0
127. W.-S. Chen, K.-W. Tien, L.-P. Wang, C.-H. Lee, Y.-F. Chung, Recovery of gallium from simulated GaAs waste etching solutions by solvent extraction, Sustainability. 12 (2020) 1765.
128. A. Li, J. Luo, W. Xu, T. Pan, Arsenic removal of high-arsenic wastewater from gallium arsenide semiconductor production by enhanced two-stage treatment, Desalin. Water Treat. 55 (2015) 1285-1292.
129. A. Massaoud, H. Hanafi, T. Siyam, Z. Saleh, F. Ali, Separation of Ga (III) from Cu (II), Ni (II) and Zn (II) in aqueous solution using synthetic polymeric resins, Open Chem. 6 (2008) 39-45.
130. J. Du, M. Zhang, Z. Dong, X. Yang, L. Zhao, Facile fabrication of tannic acid functionalized microcrystalline cellulose for selective recovery of Ga (III) and In (III) from potential leaching solution, Sep. Purif. Technol. 286 (2022) 120442.
131. C. D. Seidou, T. Wang, M. M. R. B. Espoire, Y. Dai, Y. Zuo, A Review of the Distribution Coefficient (Kd) of Some Selected Heavy Metals over the Last Decade (2012-2021), J. Geosci. Environ. Prot. 10 (2022) 199-242.
132. A. R. A. Usman, The relative adsorption selectivities of Pb, Cu, Zn, Cd and Ni by soils developed on shale in New Valley, Egypt, Geoderma. 144 (2008) 334-343.
133. Y. Xiong, X. Cui, M. Zhang, Y. Wang, Z. Lou, W. Shan, Microwave hydrothermal synthesis of gallotannin/carbon nanotube composites for the recovery of gallium ion, Appl. Surf. Sci. 510 (2020) 145414.
134. Y. Xiong, X. Cui, M. Zhang, Y. Wang, Z. Lou, W. Shan, bayer, Appl. Surf. Sci. 510 (2020) 145414.
135. C.-H. Lee, H.-Y. Lin, E. I. Cadogan, S. R. Popuri, C.-Y. Chang, Biosorption performance of biodegradable polymer powders for the removal of gallium (III) ions from aqueous solution, Polish J. Chem. Technol. 17 (2015) 124-132.
136. W.-L. Chou, C.-T. Wang, Y.-H. Huang, Removal of gallium ions from aqueous solutions using tea waste by adsorption, Fresen. Environ. Bull. 19 (2010) 2848-2856.
137. Z. Zhang, H. Zhang, Y. Hu, X. Yang, S. Yao, Novel surface molecularly imprinted material modified multi-walled carbon nanotubes as solid-phase extraction sorbent for selective extraction gallium ion from fly ash, Talanta. 82 (2010) 304-311.
138. Z. Zhao, X. Li, Y. Chai, Z. Hua, Y. Xiao, Y. Yang, Adsorption Performances and Mechanisms of Amidoxime Resin toward Gallium (III) and Vanadium (V) from Bayer Liquor, ACS Sustain. Chem. Eng. 4 (2016) 53-59.
139. J. Du, M. Zhang, Z. Dong, X. Yang, L. Zhao, Facile fabrication of tannic acid functionalized microcrystalline cellulose for selective recovery of Ga (III) and In (III) from potential leaching solution, Sep. Purif. Technol. 286 (2022) 120442.
140. P. Selvi, M. Ramasami, M. H. P. Samuel, P. Adaikkalam, G. N. Srinivasan, Recovery of gallium from Bayer liquor using chelating resins in fixed-bed columns, Ind. Eng. Chem. Res. 43 (2004) 2216-2221.
141. T. Yang, L. Wang, M. Liang, Y. Chen, H. Zou, Cross-linked polyvinyl amidoxime fiber: a highly selective and recyclable adsorbent of gallium from Bayer liquor, Iran. Polym. J. 27 (2018) 589-597.
142. H. Zhang, X. Peng, G. Shi, W. Yan, M. Liang, Y. Chen, Z. Heng, H. Zou, Uniform macroporous amidoximated polyacrylonitrile monoliths for gallium recovery from Bayer liquor, J. Appl. Polym. Sci. 138 (2021) 49764.
143. Y. Zhang, X. Liu, Y. Wang, Z. Lou, W. Shan, Y. Xiong, Polyacrylic acid-functionalized graphene oxide for high-performance adsorption of gallium from aqueous solution, J. Colloid Interface Sci. 556 (2019) 102-110.
144. Y. Xiong, X. Cui, M. Zhang, Y. Wang, Z. Lou, W. Shan, Microwave hydrothermal synthesis of gallotannin/carbon nanotube composites for the recovery of gallium ion, Appl. Surf. Sci. 510 (2020) 145414.
145. Y. Wang, L. Zhu, Y. Song, Z. Lou, W. Shan, Y. Xiong, Novel chitosan-based ions imprinted bio-adsorbent for enhanced adsorption of gallium (III) in acidic solution, J. Mol. Liq. 320 (2020) 114413.
146. Y. Xiong, X. Cui, D. Wang, Y. Wang, Z. Lou, W. Shan, Y. Fan, Diethanolamine functionalized rice husk for highly efficient recovery of gallium (III) from solution and a mechanism study, Mater. Sci. Eng. C. 99 (2019) 1115-1122.
147. W. Guo, J. Zhang, F. Yang, F. Tan, Z. Zhao, Highly efficient and selective recovery of gallium achieved on an amide-functionalized cellulose, Sep. Purif. Technol. 237 (2020) 116355.

It will be apparent to those skilled in the art that numerous modifications and variations of the described examples and embodiments are possible in light of the above teachings of the disclosure. The disclosed examples and embodiments are presented for purposes of illustration only. Other alternative embodiments may include some or all of the features of the various embodiments disclosed herein. For instance, it is contemplated that a particular feature described, either individually or as part of an embodiment, can be combined with other individually described features, or parts of other embodiments. The elements and acts of the various embodiments described herein can therefore be combined to provide further embodiments.

It is the intent to cover all such modifications and alternative embodiments as may come within the true scope of this invention, which is to be given the full breadth thereof. Additionally, the disclosure of a range of values is a disclosure of every numerical value within that range, including the end points. Thus, while certain exemplary embodiments of the device and methods of making and using the same have been discussed and illustrated herein, it is to be distinctly understood that the invention is not limited thereto but may be otherwise variously embodied and practiced within the scope of the following claims.

What is claimed is:

1. An adsorbent, comprising:
a support comprising a gel, a polymeric resin, a cellulose, and/or a carbon-based material; and
a catecholic ligand derivative of a catecholic ligand, the catecholic ligand comprising 3,4 dihydroxybenzoic acid, 3,4,5-trihydroxybenzoic acid, and/or 3,4-dihydroxyhydrocinnamic acid;
wherein the catecholic ligand derivative includes:
a carbonyl group for covalent bonding with the support; and
an O-dihydroxyl group to provide an active adsorption site.

2. The adsorbent of claim 1, wherein:
the support forms a matrix for the catecholic ligand derivative.

3. The adsorbent of claim 1, wherein:
the O-dihydroxyl group facilitates metal complexation.

4. The adsorbent of claim 1, comprising:
plural supports comprising a first support and a second support; and
wherein the first support is the same as or different from the second support.

5. The adsorbent of claim 1, comprising:
plural catecholic ligand derivatives comprising a first catecholic ligand derivative and a second catecholic ligand derivative; and
wherein the first catecholic ligand derivative is the same as or different from the second catecholic ligand derivative.

6. The adsorbent of claim 1, comprising:
plural carbonyl groups comprising a first carbonyl group and a second carbonyl group; and
wherein the first carbonyl group is the same as or different from the second carbonyl group.

7. The adsorbent of claim 1, comprising:
plural O-dihydroxyl groups comprising a first O-dihydroxyl group and a second O-dihydroxyl group; and
wherein the first O-dihydroxyl group is the same as or different from the second O-dihydroxyl group.

8. The adsorbent of claim 1, wherein:
the support is a cellulose; and
the catecholic ligand comprises 3,4 dihydroxybenzoic acid, 3,4,5-trihydroxybenzoic acid, and/or 3,4-dihydroxyhydrocinnamic acid.

9. The adsorbent of claim 1, wherein:
the support is a polymeric resin; and
the catecholic ligand comprises 3,4 dihydroxybenzoic acid and/or 3,4,5-trihydroxybenzoic acid.

10. The adsorbent of claim 9, wherein:
the polymeric resin comprises A110 resin bead or A143 resin bead.

11. A method of synthesizing an adsorbent, the method comprising:
dissolving an acid in thionyl chloride to form a catecholic ligand derivative, the acid comprising 3,4 dihydroxybenzoic acid, 3,4,5-trihydroxybenzoic acid, and/or 3,4-dihydroxyhydrocinnamic acid; and
grafting the catecholic ligand derivative onto a support, the support comprising a gel, a polymeric resin, a cellulose, and/or a carbon-based material.

12. The method of claim 11, wherein:
the support is a cellulose, and the grafting occurs via an esterification reaction; and
the support is a polymeric resin, and the grafting occurs via an amide formation reaction.

13. The method of claim 11, wherein:
the grafting functionalizes the support by a carbonyl group covalently bonding the catecholic ligand derivative to the support.

14. The method of claim 11, wherein:
the catecholic ligand derivative includes an O-dihydroxyl group to provide an active adsorption site.

15. The method of claim 14, wherein:
the O-dihydroxyl group facilitates metal complexation.

16. A method of extracting a metal from a solution, the method comprising:
introducing or exposing an adsorbent to a solution, the solution comprising a metal, the adsorbent comprising:
a support comprising a gel, a polymeric resin, a cellulose, and/or a carbon-based material; and
a catecholic ligand derivative of a catecholic ligand, the catecholic ligand comprising 3,4 dihydroxybenzoic acid, 3,4,5-trihydroxybenzoic acid, and/or 3,4-dihydroxyhydrocinnamic acid;
wherein the catecholic ligand derivative includes:
a carbonyl group for covalent bonding with the support; and
an O-dihydroxyl group to provide an active adsorption site.

17. The method of claim 16, further comprising:
allowing the metal to adsorb to the adsorbent via metal complexation.

18. The method of claim 16, further comprising:
adjusting pH of the solution to influence adsorption capacity of the adsorbent.

19. The method of claim 16, wherein:
the metal is gallium.
